(19) United States
(12) Patent Application Publication
(10) Pub. No.: US 2023/0228861 A1
(43) Pub. Date: Jul. 20, 2023

(54) RADAR APPARATUS

(71) Applicant: Panasonic Intellectual Property Management Co., Ltd., Osaka (JP)

(72) Inventor: Takaaki KISHIGAMI, Tokyo (JP)

(21) Appl. No.: 18/182,993

(22) Filed: Mar. 13, 2023

Related U.S. Application Data
(63) Continuation of application No. PCT/JP2021/018290, filed on May 13, 2021.

(30) Foreign Application Priority Data
Sep. 24, 2020 (JP) 2020-159858

(51) Int. Cl. G01S 13/32; G01S 7/35

(52) U.S. Cl. CPC G01S 13/325; G01S 7/35; G01S 13/343

(57) ABSTRACT

Provided is a radar apparatus whose performance is enhanced. The radar apparatus, includes: signal generation circuitry, which, in operation, generates a plurality of chirp signals; and a transmission antenna, which, in operation, transmits the plurality of chirp signals. The signal generation circuitry configures a transmission delay for the plurality of chirp signals for each of a predetermined number of transmission periods, where the predetermined number is greater than or equal to two. The signal generation circuitry changes a center frequency of the plurality of chirp signals for each of the predetermined number of transmission periods.

### TECHNICAL FIELD

The present disclosure relates to a radar apparatus.

### BACKGROUND ART

In recent years, a study of radar apparatuses using a short-wavelength radar transmission signal including a microwave or a millimeter wave that allows high resolution has been carried out. Further, it has been required to develop a highly-accurate radar apparatus which detects not only vehicles but also small objects such as pedestrians in order to enhance the outdoor safety.

### CITATION LIST

### Patent Literature

### Patent Literature 1

US Patent Application Publication No. 2015/0331096

### Patent Literature 2

U.S. Pat. No. 8,026,843

### Patent Literature 3

US Patent Application Publication No. 2017-0248685

### Non-Patent Literature

### Non-Patent Literature 1

M. Kronauge, H. Rohling, “Fast two-dimensional CFAR procedure”, IEEE Trans. Aerosp. Electron. Syst., 2013, 49, (3), pp. 1817-1823

### Non-Patent Literature 2

J. A. Cadzow, “Direction-of-arrival estimation using signal subspace modeling”, IEEE Transactions on Aerospace and Electronic Systems, Volume: 28, Issue: 1, Publication Year: 1992, Page(s): 64-79

### Non-Patent Literature 3

J. Li, and P. Stoica, “MIMO Radar with Colocated Antennas”, Signal Processing Magazine, IEEE Vol. 24, Issue: 5, pp. 106-114, 2007

### SUMMARY OF INVENTION

However, there is room for study on methods of enhancing the performance of a radar apparatus.

One non-limiting and exemplary embodiment facilitates providing a radar apparatus capable of enhancing the performance of a radar apparatus.

A radar apparatus according to an exemplary embodiment of the present disclosure includes: signal generation circuitry, which, in operation, generates a plurality of chirp signals; and a transmission antenna, which, in operation, transmits the plurality of chirp signals. The signal generation circuitry configures a transmission delay for the plurality of chirp signals for each of a predetermined number of transmission periods, where the predetermined number is greater than or equal to two, and the signal generation circuitry changes a center frequency of the plurality of chirp signals for each of the predetermined number of transmission periods.

It should be noted that general or specific embodiments may be implemented as a system, a method, an integrated circuit, a computer program, a storage medium, or any selective combination thereof.

According to an exemplary embodiment of the present disclosure, the performance of a radar apparatus can be enhanced

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating a configuration example of a radar apparatus according to Embodiment 1;

FIG. 2 illustrates examples of a radar transmission signal according to Embodiment 1;

FIG. 3 illustrates examples of the radar transmission signal according to Embodiment 1;

FIG. 4 illustrates examples of the radar transmission signal according to Embodiment 1;

FIG. 5 illustrates examples of the radar transmission signal according to Embodiment 1;

FIG. 6 illustrates examples of a transmission signal and a reflected wave signal in a case where a chirp pulse is used;

FIG. 7 is a block diagram illustrating a configuration example of a radar apparatus according to Embodiment 2;

FIG. 8 illustrates examples of a Doppler range in a Doppler analyzer;

FIG. 9 illustrates examples of a radar transmission signal according to Embodiment 3;

FIG. 10 illustrates examples of the radar transmission signal according to Embodiment 3;

FIG. 11 illustrates examples of the radar transmission signal according to Embodiment 3;

FIG. 12 illustrates examples of the radar transmission signal according to Embodiment 3; and

FIG. 13 is a block diagram illustrating a configuration example of the radar apparatus according to Embodiment 4.

### DESCRIPTION OF EMBODIMENTS

For example, there is a scheme of repeatedly transmitting frequency-modulated waves (hereinafter each referred to as “chirp signal”) as radar transmission waves. This scheme may also be referred to as, for example, a fast chirp modulation (FCM) scheme.

For example, Patent Literature (hereinafter referred to as “PTL”) 1 discloses a transmission method of repeatedly transmitting the same chirp signal. In this case, distance resolution ΔR₁ may be determined in accordance with following equation 1 based on chirp frequency sweep bandwidth BW_{chirp}, for example. Note that, C₀ represents the velocity of light.

$$\begin{matrix}( Equation 1 ) & \\ Δ {R}_{1} = \frac{{c}_{0}}{2 B {W}_{chirp}} & [ 1 ]\end{matrix}$$

Further, maximum Doppler velocity f_{dmax} may be determined in accordance with following equation 2 based on transmission period T_{chirp} of a chirp signal, for example.

$$\begin{matrix}( Equation 2 ) & \\ {f}_{dmax} = \frac{1}{2 {T}_{c h i r p}} & [ 2 ]\end{matrix}$$

Further, for example, PTL 2 discloses a transmission method in which the center frequency of chirp signals is varied by Δf each time the chirp signals are repeatedly transmitted. In this case, for example, in a case where frequency change width BW_{fcval} for the center frequency of chirp signals, which is varied each time the chirp signals are repeatedly transmitted, is greater than each individual chirp frequency sweep bandwidth BW_{chirp} (for example, in the case of BW_{fcval}>BW_{chirp}), distance resolution ΔR₂ may be determined in accordance with following equation 3. C₀ represents the velocity of light.

$$\begin{matrix}( Equation 3 ) & \\ Δ {R}_{2} = \frac{{c}_{0}}{2 B {W}_{fcval}} & [ 3 ]\end{matrix}$$

Note that, frequency change width BW_{fcval} for a center frequency may be calculated, for example, by (the maximum chirp signal center frequency)−(the minimum chirp signal center frequency).

Thus, for example, as BW_{fcval} is greater, the distance resolution (for example, ΔR₂) can be enhanced and transmission period T_{chirp} of a chirp signal can be shortened regardless of each individual chirp frequency sweep bandwidth BW_{chirp} (for example, even in a case where BW_{chirp} is small). Further, for example, maximum Doppler velocity f_{dmax} can be enhanced by shortening transmission period T_{chirp} of a chirp signal by equation 2.

In the transmission method of PTL 2, however, chirp signals with different center frequencies are transmitted for each transmission period, and thus, the number of times of control for varying chirp signals may increase. For example, as the number of times of control for varying chirp signals increases, the amount of memory for storing parameters related to chirp signal generation for each transmission period may also increase. Further, for example, when the number of times of control for varying chirp signals increases, frequency errors or phase errors when the chirp signals are varied are likely to occur, and the performance of a radar apparatus, such as distance accuracy or Doppler accuracy, are likely to deteriorate.

PTL 3, on the other hand, discloses a transmission method in which chirp signals with the same center frequency are repeatedly transmitted N times and then the center frequency is varied by Δf, for example. This transmission method makes it possible, for example, to reduce the number of times of control for varying chirp signals and to reduce the amount of memory for storing parameters related to chirp signal generation more than in PTL 2.

In PTL 3, however, chirp signals with the same center frequency are repeatedly transmitted N times, and thus, frequency change width BW_{fcval} for a center frequency may decrease. For example, in a case where the center frequency of chirp signals is varied by Δf each time the chirp signals are transmitted Nc times in PTL 2, frequency change width BW_{fcval} for a center frequency is BW_{fcval}=(Nc−1)×Δf. In PTL 3, on the other hand, in a case where chirp signals with the same center frequency are repeatedly transmitted N times at the time of Nc chirp signal transmissions, frequency change width BW_{fcval} for a center frequency is BW_{fcval}=(floor(Nc/N)−1)×Δf. Note that, here N>2 and floor(x) is a function that returns the maximum integer value that does not exceed real number x. As described above, frequency change width BW_{fcval} for a center frequency in PTL 3 may decrease to floor(Nc/N)/(Nc−1) in comparison with that in PTL 2. Accordingly, given equation 3, the distance resolution may be reduced more than that in PTL 2.

Further, for example, the greater |Δf| for variably configuring center frequencies, the more likely phase indeterminacy occurs when distance information or Doppler information is extracted, and thus, an upper limit may be configured on |Δf|. For example, a configuration in which variable value Δf in the center frequencies of chirp signals used in PTL 2 is simply multiplied N times by the variable value in the center frequencies of chirp signals in PTL 3 and variation by (N×Δf) is performed may not be allowed. Given the above, the distance resolution in PTL 3 may be reduced more than that in PTL 2.

Accordingly, in an exemplary embodiment according to the present disclosure, a method of reducing the number of times of control for varying chirp signals (the amount of memory for storing parameters related to chirp signal generation) and enhancing distance resolution in a transmission method of repeatedly transmitting chirp signals will be described.

Hereinafter, embodiments according to exemplary embodiments of the present disclosure will be described in detail with reference to the accompanying drawings. Note that, in the embodiments, the same constituent elements will be denoted with the same reference signs, and descriptions thereof will be omitted because of redundancy.

### Embodiment 1

[Configuration of Radar Apparatus]

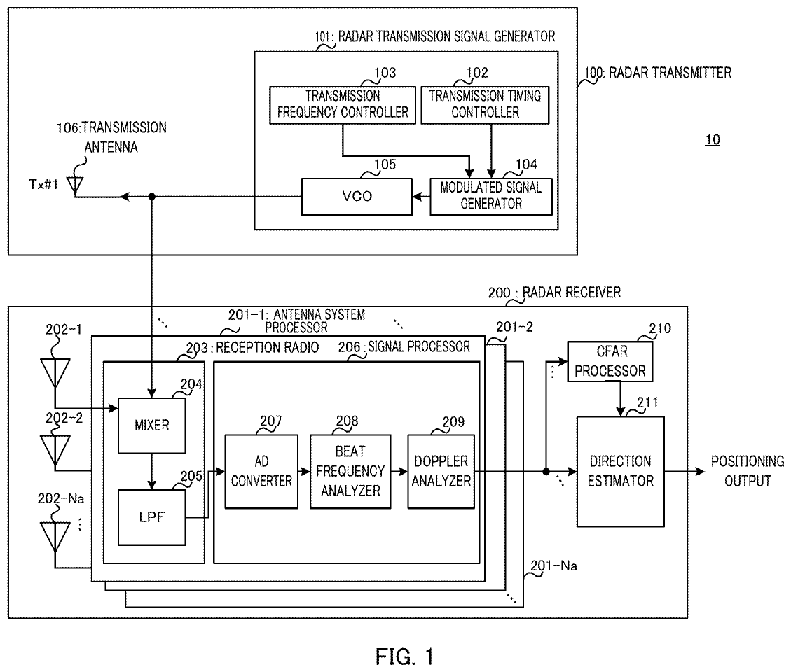

FIG. 1 is a block diagram illustrating a configuration example of radar apparatus 10 according to the present embodiment.

Radar apparatus 10 includes radar transmitter (transmission branch) 100 and radar receiver (reception branch) 200.

Radar transmitter 100 generates a radar signal (radar transmission signal) and transmits the radar transmission signal in a defined transmission period by using transmission antenna 106.

Radar receiver 200 receives a reflected wave signal, which is a radar transmission signal reflected by a target (target object (not illustrated)), by using a reception array antenna including a plurality of (for example, Na) reception antennas 202. Radar receiver 200 performs signal processing on the reflected wave signal received by each reception antenna 202, for example, detects the presence or absence of the target or estimates the distance of arrival, Doppler frequency (in other words, relative velocity), and direction of arrival of the reflected wave signal, and outputs (performs positioning output of) information on an estimated result (in other words, positioning information).

Note that, radar apparatus 10 may be mounted in, for example, a moving body such as a vehicle and the positioning output (information on an estimated result) of radar receiver 200 may be connected to a control apparatus ECU (electronic control unit) (not illustrated) such as an advanced driver assistance system (ADAS), which enhances crash safety, and an autonomous driving system, and may be utilized for vehicle driving control or alarm calling control.

Further, radar apparatus 10 may be attached to, for example, a structure at a relative elevation (not illustrated), such as a roadside utility pole or traffic light. Radar apparatus 10 may be utilized as, for example, a sensor in an assistance system that enhances the safety of a passing vehicle or pedestrian or a suspicious individual intrusion prevention system (not illustrated). The positioning output of radar receiver 200 may be connected to, for example, a control apparatus (not illustrated) in an assistance system that enhances safety or a suspicious individual intrusion prevention system, and may be utilized for alarm calling control or abnormality detection control. Note that, the uses of radar apparatus 10 are not limited thereto and may be utilized for other uses.

Note that, the target is an object to be detected by radar apparatus 10. Examples of the target include a vehicle (including a four-wheel vehicle and a two-wheel vehicle), a person, a block, and a curb.

[Configuration of Radar Transmitter 100]

Radar transmitter 100 may include, for example, radar transmission signal generator 101 (corresponding to the signal generation circuitry, for example) and transmission antenna 106.

Radar transmission signal generator 101 may generate, for example, a radar transmission signal (in other words, chirp signal). Radar transmission signal generator 101 may include, for example, transmission timing controller 102, transmission frequency controller 103, modulated signal generator 104, and voltage controlled oscillator (VCO) 105.

Hereinafter, the components in radar transmission signal generator 101 will be described.

Transmission timing controller 102 may control, for example, a transmission timing for a chirp signal. Transmission timing controller 102 may output, for example, a control signal related to the transmission timing to modulated signal generator 104.

Transmission frequency controller 103 may control, for example, a sweep frequency of a chirp signal. Transmission frequency controller 103 may output, for example, a control signal related to the sweep frequency to modulated signal generator 104.

Modulated signal generator 104 generates, for example, a modulated signal for VCO control based on the control signals inputted from transmission timing controller 102 and transmission frequency controller 103.

VCO 105 outputs a frequency-modulated signal (hereinafter referred to as a frequency chirp signal or a chirp signal, for example) to transmission antenna 106 and radar receiver 200 (mixer 204 to be described later) based on the modulated signal (or voltage output) outputted from modulated signal generator 104.

The output from VCO 105 is amplified to a predetermined transmission power, for example, and then is radiated (or transmitted) into space from transmission antenna 106.

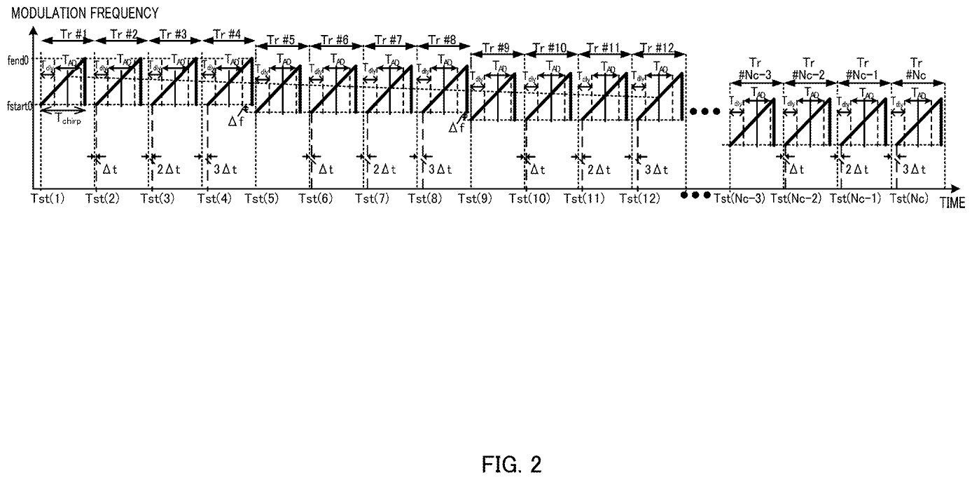

FIG. 2 illustrates examples of the radar transmission signal generated by radar transmission signal generator 101. In FIG. 2, as an example, the radar transmission signal outputted from radar transmission signal generator 101 indicates a case where the modulation frequency of a chirp signal gradually increases (which will be referred to as “up-chirp”, for example), but the present disclosure is not limited thereto. For example, the radar transmission signal outputted from radar transmission signal generator 101 may be that in a case where the modulation frequency of a chirp signal gradually decreases (which will be referred to as “down-chirp”, for example), in which case the same effect as with the up-chirp can be obtained.

For example, transmission timing controller 102 may perform the following operation in chirp signal transmission timing control.

For example, transmission timing controller 102 may control modulated signal generator 104 such that chirp transmission signal start timing Tst(1) in first transmission period Tr #1 is configured to Tst(1)=T0. Accordingly, a delay time for a chirp signal in transmission period Tr #1 is 0.

Further, transmission timing controller 102 may cause, for example, chirp transmission signal start timing Tst(2) in second transmission period Tr #2 to be configured to Tst(2)=T0+Tr+Δt and may cause chirp transmission signal start timing Tst(3) in third transmission period Tr #3 to be configured to Tst(3)=T0+2Tr+2Δt. Thereafter, transmission timing controller 102 may cause the transmission signal start timing to be changed by Δt for each time interval of average transmission period Tr in the same manner until the Ncf-th (Ncf=4 in FIG. 2) transmission period, for example. For example, transmission timing controller 102 causes Tst (Ncf)=T0+(Ncf−1)Tr+(Ncf−1)×Δt to be configured in Ncf-th transmission period Tr #Ncf. Accordingly, a delay time for a chirp signal in transmission period Tr #2 is Δt, a delay time for a chirp signal in transmission period Tr #3 is 2Δt, and a delay time for a chirp signal in transmission period Tr #4 is 3Δt.

Further, transmission timing controller 102 may cause, for example, Tst(Ncf+1)=T0+Ncf×Tr to be configured in Ncf+1-th transmission period Tr #Ncf+1. In other words, transmission timing controller 102 may cause the transmission signal start timing in the Ncf+1-th transmission period to match the timing of the time interval in average transmission period Tr (alternatively, the transmission signal start timing in the first transmission period). For example, transmission timing controller 102 may cause the chirp transmission signal start timing in the m-th transmission period to be configured to Tst(m)=T0+(m−1)×Tr+mod(m−1, Ncf)×Δt. Here, m=1, . . . , Nc. Further, mod(x,y) is a modulus operator and is a function that outputs a remainder after x is divided by y.

As described above, transmission timing controller 102 controls modulated signal generator 104, for example, such that the transmission period for the first to the Ncf−1-th chirp signals is configured to “Tr+Δt”, the transmission period for the Ncf-th chirp signal is configured to “Tr−(Ncf−1)×Δt”, and the chirp signals are transmitted. Accordingly, the average transmission period of Ncf chirp signals is “Tr”. Thereafter, in the same manner, transmission timing controller 102 may cause the transmission period for the m-th chirp signal to be configured to “Tr+Δt” in a case where m is not an integer multiple of Ncf and to “Tr−(Ncf−1)×Δt” in a case where m is an integer multiple of Ncf.

In other words, transmission timing controller 102 causes a transmission delay for a chirp signal is configured for each of a predetermined number (for example, Ncf) of transmission periods. In the present embodiment, a change in a transmission delay for a chirp signal within Ncf transmission periods may vary for each of the transmission periods. Further, for example, a transmission delay for a chirp signal may change in a round in Ncf transmission periods.

Transmission timing controller 102 may repeat the chirp signal transmission timing control as described above Nc times, for example. Here, m=1, . . . , Nc.

Further, for example, transmission frequency controller 103 may perform the following operation in chirp signal sweep frequency control.

For example, transmission frequency controller 103 controls modulated signal generator 104 such that the chirp signal sweep start frequency in first transmission period Tr #1 is configured to fstart(1)=fstart0, the sweep end frequency within chirp sweep time T_{chirp} is configured to fend(1)=fend0, and sweep center frequency fc(1) is configured to fc(1)=f0=|fend0−fstart0|/2. In the same manner, for example, transmission frequency controller 103 controls modulated signal generator 104 such that the chirp signal sweep start frequency in second transmission period Tr #2 is configured to fstart(2)=fstart0, the sweep end frequency is configured to fend(2)=fend0, and frequency sweep center frequency fc(2) is configured to fc(2)=f0. Thereafter, transmission frequency controller 103 causes the chirp signal sweep start frequencies, sweep end frequencies, and frequency sweep center frequencies to be configured to constant values in the same manner until the Ncf-th (Ncf=4 in FIG. 2) transmission period, for example.

Further, in Ncf+1-th transmission period Tr #Nc+1, for example, transmission frequency controller 103 causes the chirp signal sweep start frequency, sweep end frequency, and frequency sweep center frequency to be changed by Δf, respectively. For example, in the Ncf+1-th transmission period (Tr #5 in FIG. 2), transmission frequency controller 103 may cause the chirp signal sweep start frequency, sweep end frequency, and frequency sweep center frequency fc(Ncf+1) to be configured to fstart(Ncf+1)=fstart0+Δf, fend(Ncf+1)=fend0+Δf, and fc(Ncf+1)=f0+Δf, respectively. Note that, the example in FIG. 2 illustrates the case of Δf<0. Thereafter, transmission frequency controller 103 causes the chirp signal sweep start frequencies, sweep end frequencies, and frequency sweep center frequencies to be configured to constant values in the same manner until the 2×Ncf-th transmission period (Tr #8 in FIG. 2), for example.

Further, for example, in the 2×Ncf+1-th transmission period (Tr #9 in FIG. 2), transmission frequency controller 103 causes the chirp signal sweep start frequency, sweep end frequency, and frequency sweep center frequency to be changed by Δf, respectively. For example, transmission frequency controller 103 causes the center frequency of the chirp signal in the 2×Ncf+1-th transmission period to be configured to fc(2×Ncf+1)=f0+2Δf. Thereafter, transmission frequency controller 103 causes the center frequencies of chirp signals to be configured to be constant (f0+2Δf) in the same manner until the 3×Ncf-th transmission period.

Further, for example, in the 3×Ncf+1-th transmission period, transmission frequency controller 103 causes the chirp signal sweep start frequency, sweep end frequency, and frequency sweep center frequency to be changed by Δf, respectively. For example, in the 3×Ncf+1 transmission period, transmission frequency controller 103 causes the chirp signal sweep start frequency, sweep end frequency, and frequency sweep center frequency fc(3×Ncf+1) to be configured to fstart(3×Ncf+1)=fstart0+3Δf, fend(3×Ncf+1)=fend0+3Δf, and fc(3×Ncf+1)=f0+3Δf, respectively.

Thereafter, in the m-th transmission period, transmission frequency controller 103 may cause the chirp signal sweep start frequency, sweep end frequency, and frequency sweep center frequency to be configured to fstart(m)=fstart0+floor((m−1)/Ncf)×Δf, fend(m)=fend0+floor((m−1)/Ncf)×Δf, and fc(m)=f0+floor((m−1)/Ncf×Δf in the same manner, respectively, for example.

As described above, transmission frequency controller 103 controls modulated signal generator 104 such that frequency sweep bandwidth Bs=|fend0−fstart0| is constant, sweep frequency change rate (frequency sweep time change rate) fvr=|fend0−fstart0|/Tchirp is constant, and the center frequency of a chirp signal is changed with a step of Δf for each (Ncf×Tr) period. In other words, transmission frequency controller 103 causes the center frequency of a chirp signal to be changed for each of a predetermined number (for example, Ncf) of transmission periods.

For example, transmission frequency controller 103 may repeat the chirp signal transmission frequency control as described above Nc times. Here, m=1, . . . , Nc. Further, floor(x) is an operator for outputting the maximum integer that does not exceed real number x.

Operation examples of transmission timing controller 102 and transmission frequency controller 103 have been described above.

Note that, Δt and Δf may be configured, for example, based on the relationship as follows (the reason will be described later).

|Δf|=|Δt×fstep×Ncf|

Here, fstep is, for example, a chirp signal sweep frequency time change rate [Hz/s].

Further, Δt may be configured to an integer multiple of AD sampling interval Ts (Δt=Ndts×Ts). This is preferable since digital time control is facilitated thereby. For example, in a case where Δt is configured to an integer multiple of AD sampling interval Ts, |Δf|=|Fstep×Δt×Ncf|=|f_{A}×Ndts×Ncf| may be configured. Here, f_{A} is a chirp signal sweep frequency change rate at AD sampling interval Ts, and f_{A}=fstep×Ts. Note that, although an example will be described later, an upper limit may be configured on the configuration of |Δt×fstep|.

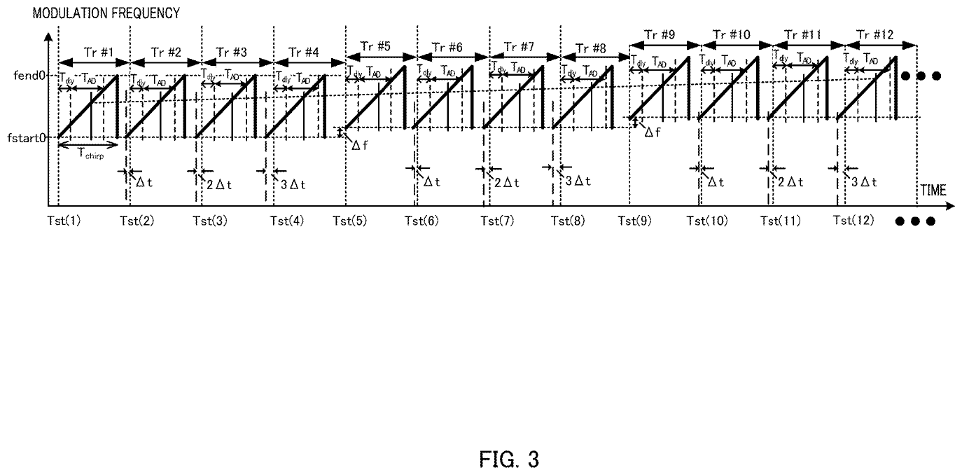

Further, for example, when the chirp signal frequency sweep is fstart0<fend0 (up-chirp), Δf<0 may be configured in a case where Δt>0 (corresponding to a case where the chirp signal transmission time is delayed) (for example, FIG. 2). Further, for example, when the chirp signal frequency sweep is fstart0<fend0 (up-chirp), Δf>0 may be configured in a case where Δt<0 (corresponding to a case where the chirp signal transmission time is accelerated) (the example illustrated in FIG. 3; Ncf=4 in FIG. 3).

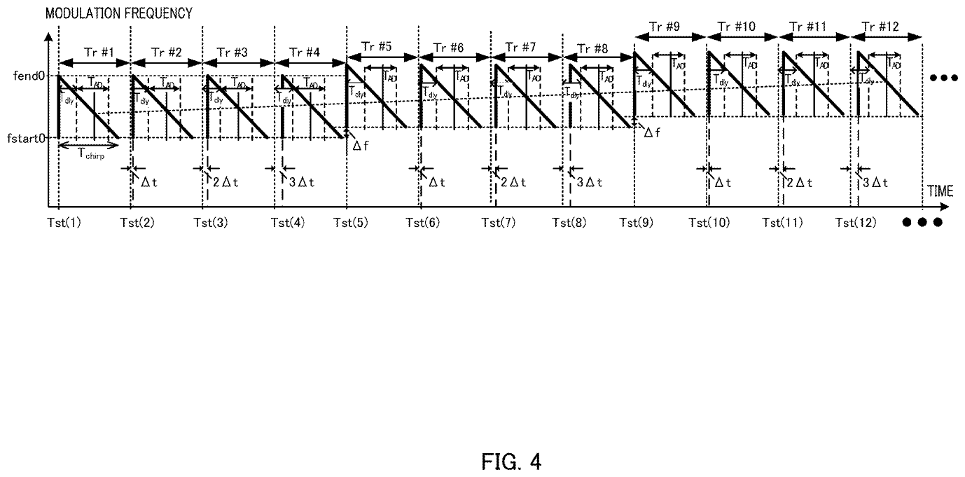

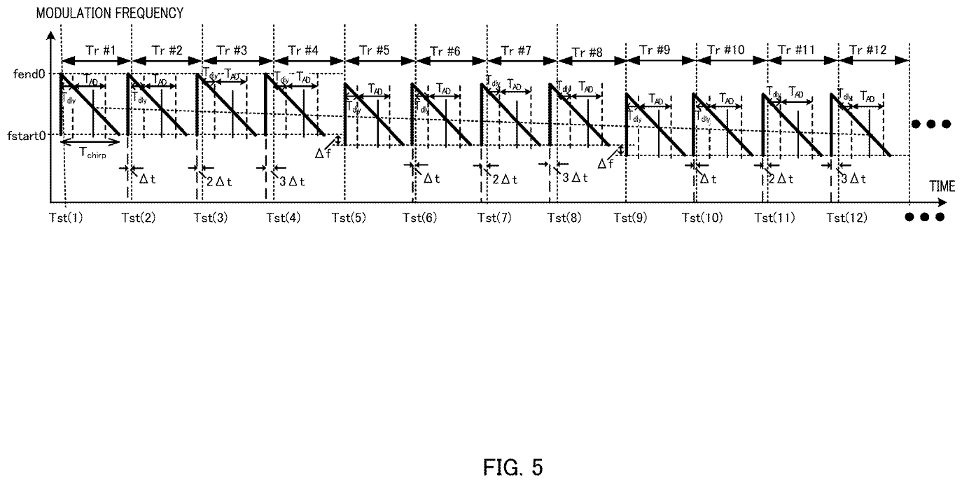

Further, for example, when the chirp signal frequency sweep is fstart0>fend0 (down-chirp), Δf>0 may be configured in a case where Δt>0 (the example illustrated in FIG. 4; Ncf=4 in FIG. 4). Further, for example, when the chirp signal frequency sweep is fstart0>fend0 (down-chirp), Δf<0 may be configured in a case where Δt<0 (the example illustrated in FIG. 5; Ncf=4 in FIG. 5).

As described above, change Δf in a center frequency may be configured based on amount Δt of a transmission delay. Note that, change Δf in a center frequency may not be configured based on amount Δt of a transmission delay, but can be arbitrarily configured.

For example, VCO 105 may output a chirp signal based on the voltage output of modulated signal generator 104. For example, VCO 105 may output a chirp signal, in which frequency sweep bandwidth Bw=|fend0−fstart0|, frequency sweep time change rate fstep, and frequency sweep center frequency f0 are configured, by varying the transmission signal start timing by Δt for each time interval of average transmission period Tr from the first to the Ncf-th transmission periods.

Further, for example, VCO 105 may output, from the Ncf+1 to the 2×Ncf-th transmission periods, chirp signals, in which frequency sweep bandwidth Bw=fend0−fstart0|, frequency sweep time change rate fstep, and frequency sweep center frequency f0+Δf are configured, at transmission signal start timings with respect to periods for each time interval of average transmission period Tr, which are the same as in the first to the Ncf-th transmission periods, respectively.

Thereafter, in the m-th transmission period, the chirp signal sweep start frequency, sweep end frequency, and frequency sweep center frequency may be configured to fstart(m)=fstart0+floor((m−1)/Ncf)×Δf, fend(m)=fend0+floor((m−1)/Ncf)×Δf, and fc(m)=f0+floor((m−1)/Ncf)×Δf in the same manner, respectively. Further, the transmission period for the m-th chirp signal may be configured to Tr+Δt in a case where m is not an integer multiple of Ncf and to Tr−(Ncf−1)×Δt in a case where m is an integer multiple of Ncf.

Radar transmitter 100 may repeat the chirp signal transmission as described above Nc times. Here, m=1, . . . , Nc.

A configuration example of radar transmitter 100 has been described above.

[Configuration of Radar Receiver 200]

In FIG. 1, radar receiver 200 may include, for example, Na reception antennas 202 (for example, also represented by Rx #1 to Rx #Na) to form an array antenna. Further, radar receiver 200 may include, for example, Na antenna system processors 201-1 to 201-Na, constant false alarm rate (CFAR) processor 210, and direction estimator 211.

Each reception antenna 202 receives a reflected wave signal that is a radar transmission signal reflected by a target, and outputs, as a reception signal, the received reflected wave signal to corresponding antenna system processor 201.

Each antenna system processor 201 includes reception radio 203 and signal processor 206.

Reception radio 203 includes mixer 204 and low pass filter (LPF) 205. Mixer 204 mixes a received reflected wave signal with a chirp signal that is a transmission signal inputted from radar transmission signal generator 101. LPF 205 outputs a beat signal that is a frequency in accordance with a delay time for a reflected wave signal by performing LPF processing on an output signal of mixer 204.

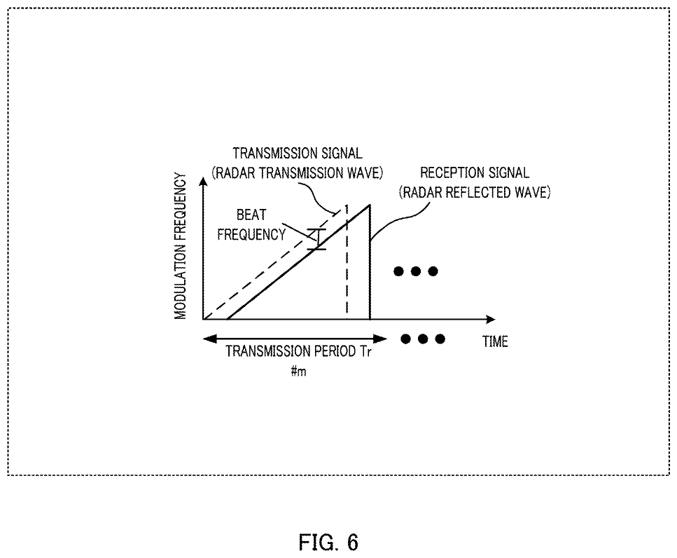

For example, as illustrated in FIG. 6, the beat signal is obtained as a signal (or beat frequency) formed of the difference frequency between the frequency of a transmission chirp signal (transmission frequency-modulated wave) and the frequency of a reception chirp signal (reception frequency-modulated wave).

Signal processor 206 of each antenna system processor 201-z (where z=any one of 1 to Na) includes AD converter 207, beat frequency analyzer 208, and Doppler analyzer 209.

In signal processor 206, AD converter 207 converts a signal (for example, a beat signal) outputted from LPF 205 into discretely sampled data. AD converter 207 may configure duration (hereinafter referred to as “range gate”) T_{AD}, in which AD sampling is performed for each average transmission period Tr, for Nc chirp signals to be transmitted, for example.

Hereinafter, a chirp signal within a range gate in AD converter 207 will be described.

For example, the start time of the range gate in the m-th transmission period is configured to TstAD(m)=T0+(m−1)×Tr+Tdly and the end time of the range gate is configured to TendAD(m)=T0+(m−1)×Tr+Tdly+Ts×Ndata. Here, Ndata represents the number of AD samples within the range gate. Note that, in a case where respective modulation frequency time change rates fstep of Nc chirp signals to be transmitted are the same, frequency-modulated bandwidths Bw=fstep×T_{AD} within respective range gates T_{AD} are the same. Further, in each transmission period, a section in which AD conversion is performed (for example, T_{AD}) and a timing at which AD conversion is started (for example, after Tdly from the start timing of the transmission period) are constant in AD converter 207.

Here, for example, radar transmitter 100 outputs the same chirp signal by varying the transmission signal start timing by Δt for each time interval of average transmission period Tr from the first to the Ncf-th transmission periods. For this reason, in data to be subjected to AD sampling within a range gate, the sweep frequency of a transmission chirp signal changes by Δt×fstep for each time interval of Tr in radar receiver 200. Accordingly, within the range gate, the center frequency of a transmission chirp signal also changes by Δt×fstep for each time interval of Tr.

For example, with respect to the center frequency of the transmission chirp signal within the range gate in the first transmission period, the center frequency of the transmission chirp signal within the range gate in the second transmission period changes by Δt×fstep and the center frequency of the transmission chirp signal within the range gate in the third transmission period changes by 2Δt×fstep. In the same manner, with respect to the center frequency of the transmission chirp signal within the range gate in the first transmission period, the center frequency of the transmission chirp signal within the range gate in the Ncf-th transmission period changes by (Ncf−1)×Δt×fstep.

Further, for example, radar transmitter 100 outputs chirp signals with frequency sweep center frequency f0+Δf at transmission signal start timings with respect to periods for each time interval of average transmission period Tr, which are the same as in the first to the Ncf-th transmission periods, respectively, from the Ncf+1 to the 2×Ncf-th transmission periods. For this reason, with respect to the center frequency of the transmission chirp signal within the range gate in the first transmission period, the center frequency of the transmission chirp signal within the range gate in the Ncf+1-th transmission period changes by Δf in radar receiver 200.

For example, in radar transmitter 100, Δt and Δf may be configured by using the relationship of |Δf|=|Δt×fstep×Ncf| as described above. For example, Δf=Ncf×Δt×fstep may be configured in the case of up-chirp. Further, for example, Δf=+Ncf×Δt×fstep may be configured in the case of down-chirp.

Thereafter, for example, radar transmitter 100 outputs the Ncf+2-th to the 2×Ncf-th chirp signals by varying the transmission signal start timing by Δt for each time interval of average transmission period Tr. For this reason, in data to be subjected to AD sampling within a range gate, the sweep frequency of a transmission chirp signal changes by Δt×fstep in radar receiver 200. Accordingly, within the range gate, the center frequency of a transmission chirp signal also changes by Δt×fstep.

For example, with respect to the center frequency of the transmission chirp signal within the range gate in the first transmission period, the center frequency of the transmission chirp signal within the range gate in the Ncf+2-th transmission period changes by (Ncf+1)×Δt×fstep and the center frequency of the transmission chirp signal within the range gate in the Ncf+3-th transmission period changes by (Ncf+2)×Δt×fstep. In the same manner, with respect to the center frequency of the transmission chirp signal within the range gate in the first transmission period, the center frequency of the transmission chirp signal within the range gate in the 2Ncf-th transmission period changes by (2Ncf−1)×Δt×fstep.

Thereafter, in the same manner, the center frequency of the transmission chirp signal within the range gate in the m-th transmission period changes by (m−1)×Δt×fstep with respect to the center frequency of the transmission chirp signal within the range gate in the first transmission period.

As described above, in radar transmitter 100, the same chirp signal is transmitted in Ncf transmission periods, and the chirp signal is outputted by varying the transmission signal start timing by Δt for each time interval of average transmission period Tr. In other words, a transmission delay for a chirp signal changes for each time interval of average transmission period Tr within Ncf transmission periods. Thus, for example, radar receiver 200 can obtain, as reception data to be subjected to AD sampling within a range gate, the same reception signal as in a case where the center frequency of a chirp signal is changed by Δt×fstep for each transmission period and the transmission is performed.

Accordingly, for example, the present embodiment makes it possible to reduce the number of times of control for varying chirp signals and to reduce the amount of memory for storing parameters when generating a chirp signal for each transmission period in comparison with a case where chirp signals with different center frequencies are transmitted for each transmission period.

Further, for example, by reducing the number of times of control for varying chirp signals, the present embodiment makes it possible to reduce the generation of frequency errors or phase errors when varying chirp signals and to reduce the influence of deterioration on distance accuracy or Doppler accuracy.

Further, for example, the present embodiment makes it possible to obtain the same reception signal as in a case where the center frequency of a chirp signal is changed by Δt×fstep for each transmission period and the transmission is performed, and therefore makes it possible to extend the frequency change width for a center frequency and to achieve a higher distance resolution.

A chirp signal within a range gate in AD converter 207 has been described above.

In FIG. 1, for example, beat frequency analyzer 208 performs FFT processing on N_{data} pieces of discretely sampled data obtained in a defined time range (range gate) for each average transmission period Tr. Thus, signal processor 206 outputs a frequency spectrum in which a peak appears at a beat frequency in accordance with a delay time for a reflected wave signal (radar reflected wave). Note that, as the FFT processing, beat frequency analyzer 208 may perform multiplication by a window function coefficient such as a Han window or a Hamming window, for example. Note that, radar apparatus 10 can suppress side lobes that appear around a beat frequency peak by using a window function coefficient, for example. Further, in a case where the number of N_{data} pieces of discretely sampled data is not a power of two, beat frequency analyzer 208 may include, for example, zero-padded data to obtain the FFT size of a power of two to perform FFT processing.

Here, a beat frequency response outputted from beat frequency analyzer 208 in z-th signal processor 206, obtained through the m-th chirp pulse transmission, is represented by RFT_{z}(f_{b}, m). Here, f_{b} represents the beat frequency index and corresponds to the index (bin number) of FFT. For example, f_{b}=0, . . . , N_{data}/2, z=1, . . . , Na, and m=1, . . . , N_{C}. As beat frequency index f_{b} is smaller, beat frequency index f_{b} indicates a beat frequency of which a delay time for a reflected wave signal is smaller (in other words, a distance to a target object is closer).

Further, beat frequency index f_{b} may be converted into distance information R(f_{b}) by using following equation 4.

$$\begin{matrix}( Equation 4 ) & \\ R ( {f}_{b} ) = \frac{{c}_{0}}{2 {B}_{w}} {f}_{b} & [ 4 ]\end{matrix}$$

Accordingly, hereinafter, beat frequency index f_{b} is also referred to as “distance index f_{b}”.

Here, B_{w} represents a frequency-modulated bandwidth within a range gate in a chirp signal, and C₀ represents the velocity of light.

Doppler analyzer 209 in z-th signal processor 206 performs Doppler analysis for each distance index f_{b} by using, for example, data of Nc transmission periods (for example, beat frequency response RFT_{z}(f_{b}, m) outputted from beat frequency analyzer 208). Here, Here, z=1, . . . , Na.

For example, in a case where Nc is the value of a power of two, FFT processing may be applied in Doppler analysis. In this case, the FFT size is Nc, and the maximum Doppler frequency at which no aliasing occurs and which is derived from the sampling theorem is ±1/(2×Tr). Further, the Doppler frequency interval of Doppler frequency index fs is 1/(Nc×Tr), and the range of Doppler frequency index fₛ is fₛ=Nc/2, . . . , 0, . . . , Nc/2−1.

For example, output VFT_{z}(f_{b}, fₛ) of Doppler analyzer 209 in z-th signal processor 206 is indicated by following equation 5.

[5]

$$V F {T}_{z} ( {f}_{b} , {f}_{s} ) = {\sum }_{s = 0}^{{N}_{c} - 1} R F {T}_{z} ( {f}_{b} , s ) exp ( - \frac{j 2 π s {f}_{s}}{{N}_{c}} ) \qquad ( Equation 5 )$$

where j is an imaginary unit, and z=1 to Na.

Further, in a case where Nc is not a power of two, for example, zero-padded data may be included to obtain power-of-two pieces of data size (FFT size) to perform FFT processing. For example, in a case where the FFT size in Doppler analyzer 209 when zero-padded data is included is N_{cwzero}, output VFT_{z}(f_{b}, fₛ) of Doppler analyzer 209 in z-th signal processor 206 is indicated by following equation 6.

[6]

$$V F {T}_{z} ( {f}_{b} , {f}_{s} ) = {\sum }_{s = 0}^{{N}_{c w z e r o} - 1} R F {T}_{z} ( {f}_{b} , s ) exp ( - \frac{j 2 π s {f}_{s}}{{N}_{c w z e r o}} ) \qquad ( Equation 6 )$$

Here, the FFT size is N_{cwzero}, and the maximum Doppler frequency at which no aliasing occurs and which is derived from the sampling theorem is ±1/(2×Tr). Further, the Doppler frequency interval of Doppler frequency index fₛ is 1/(N_{cwzero}×Tr), and the range of Doppler frequency index fₛ is fₛ=N_{cwzero}/2, . . . , 0, . . . , N_{cwzero}/2−1.

Hereinafter, a case where Nc is the value of a power of two will be described as an example. Note that, in a case where zero padding is used in Doppler analyzer 209, the same applies and the same effect can be obtained by replacing Nc with N_{cwzero} in the following description.

Further, at the time of FFT processing, Doppler analyzer 209 may perform multiplication by a window function coefficient such as a Han window or a Hamming window, for example. Radar apparatus 10 can suppress side lobes that appear around a beat frequency peak by applying a window function.

The processing in each component of signal processor 206 has been described above.

In FIG. 1, CFAR processor 210 performs CFAR processing (in other words, adaptive threshold determination) by using, for example, the output of Doppler analyzer 209 in signal processor 206 in each of first to Na-th antenna system processors 201 and extracts distance index f_{b_cfar} and Doppler frequency index f_{s_cfar} that give a peak signal.

For example, CFAR processor 210 performs power addition of outputs VFT_{z}(f_{b}, fₛ) of Doppler analyzers 209 of signal processors 206 in first to Na-th antenna system processors 201 as indicated by following equation 7 and performs two-dimensional CFAR processing with the distance axis and the Doppler frequency axis (which corresponds to the relative velocity) or CFAR processing combined with one-dimensional CFAR processing.

[7]

PowerFT(f_{b},fₛ)=Σ_{z=1}^{N}^{ₐ}|VFT_{z}(f_{b},fₛ)|² (Equation 7)

Processing disclosed in, for example, Non-Patent Literature (hereinafter referred to as “NPL”) 1 may be applied as the two-dimensional CFAR processing or the CFAR processing combined with the one-dimensional CFAR processing.

CFAR processor 210 adaptively configures a threshold value, and outputs distance indexes f_{b_cfar}, Doppler frequency indexes f_{s_cfar}, and received power information PowerFT(f_{b_cfar}, f_{s_cfar}), which provide received power greater than the threshold value, to direction estimator 211.

In FIG. 1, direction estimator 211 performs target direction estimation processing based on output VFT_{z}(f_{b_cfar}, f_{s_cfar}) of Doppler analyzer 209 corresponding to distance indexes f_{b_cfar} and Doppler frequency indexes f_{s_cfar} inputted from CFAR processor 210, for example.

For example, direction estimator 211 may generate reception array correlation vector h(f_{b_cfar}, f_{s_cfar}) indicated by equation 8 and perform direction estimation processing.

Reception array correlation vector h(f_{b_cfar}, f_{s_cfar}) is a column vector including Na elements where Na represents the number of reception antennas. Further, reception array correlation vector h(f_{b_cfar}, f_{s_cfar}) is used for processing of performing direction estimation based on the phase difference between reception antennas 202 on a reflected wave signal from a target. Here, z=1, . . . , Na.

$$\begin{matrix}( Equation 8 ) & \\ h ( {f}_{b \_ cfar} , {f}_{s \_ cfar} ) = [ \begin{matrix}\begin{matrix}\begin{matrix}{VFT}_{1} ( {f}_{b \_ cfar} , {f}_{s \_ cfar} ) \\ {VFT}_{2} ( {f}_{b \_ cfar} , {f}_{s \_ cfar} )\end{matrix} \\ ⋮\end{matrix} \\ {VFT}_{{N}_{a}} ( {f}_{b \_ cfar} , {f}_{s \_ cfar} )\end{matrix} ] & [ 8 ]\end{matrix}$$

For example, direction estimator 211 calculates a spatial profile, with azimuth direction θ in direction estimation evaluation function value P_{H}(θ, f_{b_cfar}, f_{s_cfar}) being variable within a defined angular range. Direction estimator 211 extracts a predetermined number of local maximum peaks in the calculated spatial profile in descending order and outputs the azimuth direction of each local maximum peak as a direction-of-arrival estimation value (for example, positioning output).

Note that, there are various methods for direction estimation evaluation function value P_{H}(θ, f_{b_cfar}, f_{s_cfar}) depending on direction-of-arrival estimation algorithms. For example, an estimation method using an array antenna disclosed in NPL 2 may be used.

For example, in a case where Na reception antennas are linearly disposed at equal intervals d_{H}, a beamformer method can be indicated as in following equations 9 and 10.

$$\begin{matrix}( Equation 9 ) & \\ {P}_{H} ( {f}_{b \_ cfar} , {f}_{s \_ cfar} ) = {\vert {a}^{H} ( {θ}_{u} ) {D}_{c a l} h ( {f}_{b \_ cfar} , {f}_{s \_ char} ) \vert}^{2} ; & [ 9 ]\end{matrix}$$

$$\begin{matrix}( Equation 10 ) & \\ a ( {f}_{b \_ cfar} , {f}_{s \_ char} ) = [ \begin{matrix}\begin{matrix}\begin{matrix}1 \\ exp ( - j 2 π {d}_{h} sin {θ}_{u} / λ )\end{matrix} \\ ⋮\end{matrix} \\ exp ( - j 2 π {d}_{h} ( {N}_{a} - 1 ) sin {θ}_{u} / λ )\end{matrix} ] . & [ 10 ]\end{matrix}$$

In addition, techniques such as Capon and MUSIC are also applicable in the same manner.

Here, character superscript H is a Hermitian transpose operator. Further, a(θᵤ) represents the direction vector of a reception array with respect to an arrival wave in azimuth direction θᵤ. Here, direction vector a(θᵤ) is an Na-dimensional column vector including, as elements, complex responses of the reception array in a case where a radar reflected wave arrives in azimuth direction θ. Further, the complex responses of the reception array represent phase differences resulting from path differences geometrically optically calculated based on the disposition of reception antennas and the directions of radar reflected waves.

Further, azimuth direction θᵤ is a vector obtained by changing θₘᵢₙ to θₘₐₓ within the azimuth range, in which the direction-of-arrival estimation is performed, at azimuth interval DStep. For example, θᵤ is configured as follows.

θᵤ=θₘᵢₙ+DStep×u,u=0, . . . ,NU

NU=floor[(θₘₐₓ−θₘᵢₙ)/DStep].

Here, floor(x) is a function that returns the maximum integer value that does not exceed real number x.

Further, in equation 9, D_{cal} is an Na-dimensional square matrix including an array correction coefficient for correcting phase deviations and amplitude deviations between reception array antennas and a coefficient for reducing the influence of inter-element coupling between antennas. In a case where the coupling between antennas in the reception array can be ignored, D_{cal} becomes a diagonal matrix and includes, as diagonal components, the array correction coefficient for correcting phase deviations and amplitude deviations between reception array antennas.

Further, λ is the wavelength of a carrier frequency of a radio signal outputted from radar transmitter 100. Further, for example, in a case where a chirp signal is outputted as a radio signal, λ may be the wavelength of the center frequency.

For example, direction estimator 211 may output a direction estimation result. Further, for example, direction estimator 211 may output, as a positioning result, distance information of a target, which is based on distance index f_{b_cfar}, and Doppler velocity information of the target, which is based on Doppler frequency index f_{b_cfar} of the target.

For example, direction estimator 211 may calculate and output Doppler velocity information of a target as follows.

For example, in radar receiver 200, a reception signal of a signal equivalent to a transmission signal for which center frequency fc of a chirp signal is changed by Δt×fstep for each average transmission period Tr is obtained as described above. Accordingly, for example, even in a case where the relative velocity of a target is zero, the output of Doppler analyzer 209 includes phase rotation associated with a change in the center frequency of a chirp signal for each average transmission period Tr.

For example, center frequency fc of the chirp signal in the m-th transmission period with respect to target distance R_{target} changes by (m−1)Δt×fstep when the center frequency of the first chirp signal is used as a reference. Accordingly, phase rotation amount Δη(m, R_{target}) associated with the change in the center frequency is indicated by following equation 11 in view of reflected-wave arrival time (2R_{target}/C₀) from target distance R_{target}.

$$\begin{matrix}( Equation 11 ) & \\ Δ η ( m , {R}_{target} ) = 2 π ( m - 1 ) Δ t \times {f}_{step} \times ( \frac{2 {R}_{target}}{{C}_{0}} ) & [ 11 ]\end{matrix}$$

Note that, equation 11 represents the relative phase rotation amount in a case where the reception phase of the chirp signal in the first transmission period is used as a reference. C₀ indicates the velocity of light.

Here, in equation 11 representing phase rotation amount Δη(m, R_{target}), phase indeterminacy may occur in a case where

$$Δ t \times {f}_{step} \times ( \frac{2 {R}_{target}}{{C}_{0}} ) \qquad [ 12 ]$$

is greater than 1. Thus, for example, Δt×fstep may be configured such that

$$Δ t \times {f}_{step} \times ( \frac{2 {R}_{t a r g e t}}{{C}_{0}} ) \leq 1 . \qquad [ 13 ]$$

For example,

$$Δ t \times {f}_{step} \times ( \frac{2 {R}_{t a r g e t}}{{C}_{0}} ) = \frac{Δ {tf}_{b}}{{T}_{A D}} \leq 1 \qquad [ 14 ]$$

results from frequency-modulated bandwidth Bw=fstep×T_{AD} and equation 4, and

$$Δ t \leq \frac{2 {T}_{A D}}{N d a t a} = 2 T s \qquad [ 15 ]$$

results from f_{b}=0, . . . , N_{data}/2.

Thus, for example, |Δt| may be configured to 2 Ts or less (or 2 Ts as an upper limit). In the same manner, an upper limit may be configured on Δt×fstep.

Further, for example, as indicated by following equation 12, direction estimator 211 calculates Doppler velocity information v_{d}(f_{b_cfar}, f_{s_cfar}) of a target based on a conversion equation in view of Δt×fstep that is the amount of a change in center frequency fc of a chirp signal for each average transmission period Tr.

$$\begin{matrix}( Equation 12 ) & \\ {v}_{d} ( {f}_{b \_ cfar} , {f}_{s \_ cfar} ) = \frac{{C}_{o}}{2 {f}_{0}} ( \frac{{f}_{s \_ cfar}}{{N}_{c} \times {T}_{r}} - Δ t \times {f}_{step} \times \frac{2 R ( {f}_{b \_ cfar} )}{{T}_{r} \times {C}_{o}} ) & [ 16 ]\end{matrix}$$

The first term in equation 12 is a relative Doppler velocity component represented by Doppler frequency f_{s_cfar}. The second term in equation 12 is a Doppler velocity component that is generated by changing center frequency fc of a chirp signal by Δt×fstep for each average transmission period Tr. For example, as indicated by equation 12, direction estimator 211 can calculate true relative Doppler velocity v_{d}(f_{b_cfar}, f_{s_cfar}) of a target by removing the Doppler component in the second term from the first term. Here, R(f_{b_cfar}) is distance information R(f_{b_cfar}) using beat frequency index f_{b_cfar}, and may be calculated by using equation 4.

Note that, the Doppler range of a target is assumed to be up to ±1/(2×Tr). Thus, in a case where v_{d}(f_{b_cfar}, f_{s_cfar}) is v_{d}(f_{b_cfar}, f_{s_cfar})<−C₀/(4f₀ Tr), direction estimator 211 may output detected Doppler velocity information v_{d}(f_{b_cfar}, f_{s_cfar}) of a target in accordance with following equation 13, for example.

$$\begin{matrix}( Equation 13 ) & \\ {v}_{d} ( {f}_{b \_ cfar} , {f}_{s \_ cfar} ) = \frac{{C}_{o}}{2 {f}_{0}} ( \frac{{f}_{s \_ cfar} + {N}_{c}}{{N}_{c} \times {T}_{r}} - Δ t \times {f}_{step} \times \frac{2 R ( {f}_{b \_ cfar} )}{{T}_{r} \times {C}_{o}} ) & [ 17 ]\end{matrix}$$

Further, in the same manner, the Doppler range of a target is assumed to be up to ±1/(2×Tr). Thus, in a case where v_{d}(f_{b_cfar}, f_{s_cfar}) is v_{d}(f_{b_cfar}, f_{s_cfar})>C₀/(4f₀ Tr), direction estimator 211 may output detected Doppler velocity information v_{d}(f_{b_cfar}, f_{s_cfar}) of a target in accordance with following equation 14.

$$\begin{matrix}( Equation 14 ) & \\ {v}_{d} ( {f}_{b \_ cfar} , {f}_{s \_ cfar} ) = \frac{{C}_{o}}{2 {f}_{0}} ( \frac{{f}_{s \_ cfar} - {N}_{c}}{{N}_{c} \times {T}_{r}} - Δ t \times {f}_{step} \times \frac{2 R ( {f}_{b \_ cfar} )}{{T}_{r} \times {C}_{o}} ) & [ 18 ]\end{matrix}$$

As described above, in the present embodiment, radar transmitter 100 transmits the same chirp signal in Ncf transmission periods, and performs the transmission by changing the transmission signal start timing by Δt for each time interval of average transmission period Tr. Further, in Ncf transmission periods following the Ncf transmission periods described above, radar transmitter 100 transmits a chirp signal for which the center frequency is changed by Δf=Δt×fstep×Nfc.

Thus, for example, radar receiver 200 can obtain, with respect to reception data to be subjected to AD sampling within a range gate, the same reception signal as in a case where the center frequency of a chirp signal is changed by Δt×fstep for each transmission period and the transmission is performed.

Accordingly, for example, the present embodiment makes it possible to reduce the number of times of control for variably configuring chirp signals for transmission of chirp signals with different center frequencies and to reduce the amount of memory for storing parameters when generating a chirp signal for each transmission period. Further, for example, the section and timing for AD sampling in radar receiver 200 may be constant regardless of transmission periods of chirp signals. Thus, processing in radar receiver 200 can be simplified.

Further, for example, by reducing the number of times of control for varying chirp signals, the present embodiment makes it possible to reduce the generation of frequency errors or phase errors when varying chirp signals and to reduce the influence of deterioration on distance accuracy or Doppler accuracy.

Further, in the present embodiment, radar receiver 200 can obtain the same reception signal as in a case where the center frequency of a chirp signal is changed by Δt×fstep for each transmission period and the transmission is performed in radar transmitter 100. Accordingly, it is possible to extend the frequency change width for a center frequency and to achieve a higher distance resolution.

Further, in the present embodiment, in a case where frequency change width BW_{fcval} (=(the maximum chirp signal center frequency)−(the minimum chirp signal center frequency)) for the center frequency of chirp signals, which is varied each time the chirp signals are repeatedly transmitted, is greater than individual chirp frequency sweep bandwidth BW_{chirp} (for example, BW_{fcval}>BW_{chirp}), distance resolution ΔR2 is given by equation 3. Thus, for example, as BW_{fcval} is greater, the distance resolution can be enhanced without depending on individual chirp frequency sweep bandwidth BW_{chirp} (for example, even when BW_{chirp} is reduced), and thus, it is possible to shorten average transmission period Tr for chirp signals. Further, given the relationship in equation 2, for example, shortening average transmission period Tr for chirp signals makes it possible to increase maximum Doppler velocity f_{dmax} and to extend the Doppler detection range.

Here, for example, the more the number Ncf of transmission periods for transmitting the same chirp signal, the longer the transmission time for the chirp signal. Accordingly, for example, Ncf may be configured to approximately 10 or less as the configuration value of Ncf. This Ncf configuration makes it possible to prevent, for example, a significant increase in a chirp transmission time. Note that, the configuration value 10 of Ncf described above is an example and may be any other value.

Alternatively, Ncf may be configured based on, for example, a length of the section in which AD sampling (or AD conversion) is performed. For example, Δt×Ncf≤0.1×T_{AD} may be configured for duration (for example, range gate) T_{AD} in which AD sampling is performed for each average transmission period Tr. This configuration is preferable since an increase in the length of a chirp signal becomes less than or equal to approximately 10% thereby, for example. Alternatively, for example, Δt×Ncf≤0.1×Ndata×Ts may be configured for number Ndata of samples within range gate T_{AD}. This configuration is preferable since an increase in the length of a chirp signal becomes less than or equal to approximately 10% thereby, for example. Note that, the coefficient 0.1 in the configurations described above is an example and may be any other value.

### Embodiment 2

In Embodiment 1, a configuration in which radar transmission signals are outputted from one transmission antenna has been described. The radar apparatus is not limited to this configuration, but may be configured to output radar transmission signals by using a plurality of transmission antennas (for example, a MIMO radar configuration) (for example, see NPL 3).

Hereinafter, a configuration of a radar apparatus in which a transmission branch transmits different multiplexed transmission signals simultaneously from a plurality of transmission antennas and a reception branch performs reception processing by demultiplexing each of the transmission signals (in other words, a MIMO radar configuration) will be described.

A MIMO radar transmits, for example, signals (radar transmission waves) multiplexed by using time division, frequency division, or code division from a plurality of transmission antennas (or referred to as a transmission array antenna). Then, the MIMO radar receives, for example, signals (radar reflected waves) reflected by surrounding objects by using a plurality of reception antennas (or referred to as a reception array antenna) to demultiplex and receive a multiplexed transmission signal from each reception signal. With such processing, the MIMO radar is capable of extracting a propagation path response indicated by the product of the number of transmission antennas and the number of reception antennas and performs, as a virtual reception array, array signal processing by using these reception signals.

Further, in the MIMO radar, it is possible to achieve a virtually extended antenna aperture and an enhanced angular resolution by appropriately arranging element spacings in transmission and reception array antennas.

Hereinafter, as an example, attention will be paid to a MIMO radar using code multiplex transmission which is one method of simultaneously multiplexing and transmitting transmission signals from a plurality of transmission antennas.

[Configuration of Radar Apparatus]

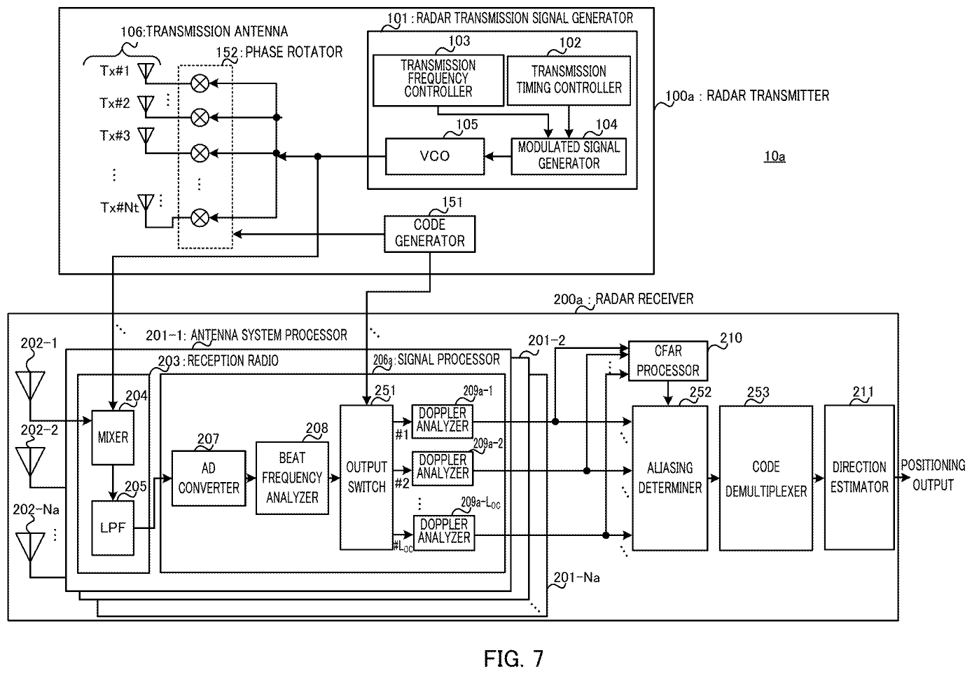

FIG. 7 is a block diagram illustrating a configuration example of radar apparatus 10a according to the present embodiment. Note that, in FIG. 7, the same configurations as those in Embodiment 1 (FIG. 1) will be denoted with the same reference signs, and descriptions thereof will be omitted.

Radar apparatus 10a includes radar transmitter (transmission branch) 100a and radar receiver (reception branch) 200a.

Radar transmitter 100a generates a radar signal (radar transmission signal) and transmits the radar transmission signal in a defined transmission period by using a transmission array antenna formed of a plurality of (for example, Nt) transmission antennas 106.

Radar receiver 200a receives a reflected wave signal, which is a radar transmission signal reflected by a target (target object (not illustrated)), by using a reception array antenna including a plurality of (for example, Na) reception antennas 202. Radar receiver 200a performs signal processing on the reflected wave signal received by each reception antenna 202, for example, detects the presence or absence of the target or estimates the distance of arrival, Doppler frequency (in other words, relative velocity), and direction of arrival of the reflected wave signal, and outputs information on an estimated result (in other words, positioning information).

Note that, the target is an object to be detected by radar apparatus 10a. Examples of the target include a vehicle (including a four-wheel vehicle and a two-wheel vehicle), a person, a block, and a curb.

[Configuration of Radar Transmitter 100a]

Radar transmitter 100a includes radar transmission signal generator 101, code generator 151, phase rotator 152, and transmission antenna 106.

The operation of radar transmission signal generator 101 may be the same as, for example, that in Embodiment 1. For example, radar transmitter 100a may transmit the same chirp signal in Ncf transmission periods, and may perform the transmission by changing the transmission signal start timing by Δt for each time interval of average transmission period Tr. Further, for example, in Ncf transmission periods following the Ncf transmission periods described above, radar transmitter 100a may transmit a chirp signal for which the center frequency is changed by Δf=Δt×fstep×Nfc. Thus, radar receiver 200a can obtain the same reception signal as in a case where the center frequency of a chirp signal is changed by Δt×fstep for each transmission period and the transmission is performed.

Code generator 151 generates a code different for each of transmission antennas 106 that perform code multiplex transmission. Code generator 151 outputs a phase rotation amount corresponding to the generated code to phase rotator 152. Further, code generator 151 outputs information on the generated code to radar receiver 200a (output switch 251 to be described later).

Phase rotator 152 applies the phase rotation amount inputted from code generator 151 to a chirp signal inputted from, for example, radar transmission signal generator 101, and outputs a signal after phase rotation to transmission antenna 106. For example, phase rotator 152 may include a phase shifter and a phase modulator, and the like (not illustrated). An output signal of phase rotator 152 is amplified to a defined transmission power and is radiated from each of transmission antennas 106 into space. In other words, radar transmission signals are code-multiplexed and transmitted from a plurality of transmission antennas 106 by application of the phase rotation amounts corresponding to the codes.

Next, an example of codes (for example, orthogonal codes) configured in radar apparatus 10a will be described.

Code generator 151 generates, for example, a code different for each of transmission antennas 106 that perform code multiplex transmission.

Hereinafter, for example, the number of transmission antennas 106 that perform code multiplex transmission is “Nt”. Here, Nt≥2.

Further, hereinafter, a code multiplexing number is “N_{CM}”. Although a case where N_{CM}=Nt will be described as an example in FIG. 7, the present disclosure is not limited thereto. For example, the same code may be transmitted (for example, array transmission or beamforming transmission) in a set of a plurality of transmission antennas 106. In this case, N_{CM}<Nt.

For example, code generator 151 configures, as codes for code multiplex transmission, N_{CM} orthogonal codes among N_{allcode} (hereinafter may also be referred to as N_{allcode}(Loc)) orthogonal codes included in code sequences (for example, orthogonal code sequences (or simply referred to as codes or orthogonal codes) in a mutually orthogonal relationship) with code length (in other words, the number of code elements) Loc.

For example, code multiplexing number N_{CM} is less than number N_{allcode} of orthogonal codes, and N_{CM}<N_{allcode}. In other words, code length Loc of an orthogonal code is greater than code multiplexing number N_{CM}. For example, N_{CM} orthogonal codes with code length Loc are represented by Code_{ncm}=[OC_{ncm}(1), OC_{ncm}(2), . . . , OC_{ncm}(Loc)]. Here, “OC_{ncm}(noc)” represents the noc-th code element in ncm-th orthogonal code Code_{ncm}. Further, “ncm” represents the index of an orthogonal code used for code multiplexing, and ncm=1, . . . , N_{CM}. Further, “noc” is the index of a code element, and noc=1, . . . , Loc.

Here, (N_{allcode}−N_{CM}) orthogonal codes among N_{allcode} orthogonal codes with code length Loc are not used by code generator 151 (in other words, not used for code multiplex transmission). Hereinafter, (N_{allcode}−N_{CM}) orthogonal codes not used in code generator 151 are referred to as “unused orthogonal codes”. At least one of the unused orthogonal codes is, for example, used for Doppler frequency aliasing determination in aliasing determiner 252 of radar receiver 200a to be described later (an example will be described later).

By using unused orthogonal codes, radar apparatus 10a is capable of, for example, receiving signals code-multiplexed and transmitted from a plurality of transmission antennas 106, while inter-code interference is being suppressed and such that the signals are demultiplexed individually, and of extending the range where Doppler frequencies are detectable (an example will be described later).

As described above, N_{CM} orthogonal codes generated by code generator 151 are, for example, mutually orthogonal codes (in other words, uncorrelated codes). For example, a Walsh-Hadamard code may be used for an orthogonal code sequence. The code length of a Walsh-Hadamard code is a power of two, and orthogonal codes with each code length include orthogonal codes equal in number to the code length. For example, a Walsh-Hadamard code with a code length of two, four, eight, or 16 includes two, four, eight, or 16 orthogonal codes.

Hereinafter, as an example, code length Loc of each of N_{CM} orthogonal code sequences may be configured so as to satisfy following equation 15.

[19]

Loc≥2^{ceil[log}^{₂}^{(N}^{_{CM}}^{+1)]} (Equation 15)

Here, ceil[x] is an operator (ceiling function) that outputs the minimum integer greater than or equal to real number x. In the case of a Walsh-Hadamard code with code length Loc, the relationship N_{allcode}(Loc)=Loc holds. For example, since a Walsh-Hadamard code with code length Loc=2, 4, 8, or 16 includes two, four, eight, or 16 orthogonal codes, N_{allcode}(2)=2, N_{allcode}(4)=4, N_{allcode}(8)=8, and N_{allcode}(16)=16 hold. Code generator 151 may use, for example, N_{CM} orthogonal codes among N_{allcode}(Loc) orthogonal codes included in a Walsh-Hadamard code with code length Loc.

Here, the code length will be described. For example, in a case where acceleration is included in the moving velocity of a target or radar apparatus 10a, the longer the code length is, the more susceptible to inter-code interference the codes are. Further, the longer the code length is, candidates for a Doppler aliasing range at the time of Doppler aliasing determination to be described later increase. For this reason, in a case where there are targets of a plurality of Doppler frequencies over different aliasing ranges in the same distance index, the probability that Doppler frequency indexes detected in the different aliasing ranges will overlap increases, and the probability that it will be difficult for radar apparatus 10a to appropriately determine aliasing may increase.

For this reason, radar apparatus 10a may use codes with a shorter code length from the viewpoint of the performance and arithmetic amount of aliasing determination in aliasing determiner 252 of radar receiver 200a to be described later. As an example, radar apparatus 10a may use an orthogonal code sequence with the shortest code length among code lengths Loc that satisfy equation 15.

Note that, in a case where Walsh-Hadamard codes with code length Loc include, for example, codes [OC_{ncm}(1), OC_{ncm}(2), . . . , OC_{ncm}(Loc−1), OC_{ncm}(Loc)] with code length Loc, the Walsh-Hadamard codes with code length Loc also include codes [OC_{ncm}(1), −OC_{ncm}(2), . . . , OC_{ncm}(Loc−1), −OC_{ncm}(Loc)] with identical odd-numbered code elements and code-inverted even-numbered code elements.

Further, in a case where Walsh-Hadamard codes with code length Loc include, for example, codes [OC_{ncm}(1), OC_{ncm}(2), . . . , OC_{ncm}(Loc−1), and OC_{ncm}(Loc)] with code length Loc, which are other codes different from the Walsh-Hadamard codes with code length Loc, the codes with code length Loc may be codes [OC_{ncm}(1), OC_{ncm}(2), . . . , OC_{ncm}(Loc−1), and OC_{ncm}(Loc)] with identical odd-numbered code elements and code-inverted even-numbered code elements or may be codes [−OC_{ncm}(1), OC_{ncm}(2), . . . , OC_{ncm}(Loc−1), and OC_{ncm}(Loc)] with identical even-numbered code elements and code-inverted odd-numbered code elements.

In a case where the number (N_{allcode}−N_{CM}) of unused orthogonal codes is greater than or equal to two, radar apparatus 10a may select, for example, codes such that a set of codes in the above-described relationship is not included in the unused orthogonal codes. For example, one code of a set of codes in the above-described relationship may be used for code multiplex transmission, and the other code thereof may be included in unused orthogonal codes. By this unused orthogonal code selection, Doppler frequency aliasing determination accuracy in aliasing determiner 252 of radar receiver 200a to be described later can be enhanced (an example will be described later).

Hereinafter, an example of orthogonal codes in each code multiplexing number N_{CM} will be described.

<Case of N_{CM}=2 or 3>

In a case where N_{CM}=2 or 3, for example, Walsh-Hadamard codes with code length Loc=4, 8, 16, 32, . . . may be applied. In the case of these code lengths Loc, N_{CM}<N_{allcode}(Loc). Further, in a case where the code multiplexing number is N_{CM}=2 or 3, Walsh-Hadamard codes with a shorter code length (for example, Loc=4) among these code lengths Loc may also be used.

For example, a Walsh-Hadamard code with code length Loc is represented by WH_{Loc}(nwhc). Note that, nwhc represents a code index included in the Walsh-Hadamard code with code length Loc, and nwhc=1, . . . , Loc. For example, Walsh-Hadamard codes with code length Loc=4 include orthogonal codes WH₄(1)=[1, 1, 1, 1], WH₄(2)=[1, −1, 1, −1], WH₄(3)=[1, 1, −1, −1], and WH₄(4)=[1, −1, −1, 1].

Here, among the Walsh-Hadamard codes with code length Loc=4, WH₄(1)=[1, 1, 1, 1] and WH₄(2)=[1, −1, 1, −1] are a set of codes in which the odd−numbered code elements are identical between the codes and the even-numbered code elements are code-inverted between the codes. Further, WH₄(3)=[1, 1, −1, −1] and WH₄(4)=[1, −1, −1, 1] are also a set of codes in the same relationship to the set of WH₄(1) and WH₄(2).

For example, in a case where the number (N_{allcode}−N_{CM}) of unused orthogonal codes is greater than or equal to two, radar apparatus 10a may select codes such that a set of codes in such a relationship is not included in the unused orthogonal codes.

For example, in a case where code multiplexing number N_{CM} is two, code generator 151 determines, as codes for code multiplex transmission, two orthogonal codes among Walsh-Hadamard codes with code length Loc=4. In this case, the number (N_{allcode}−N_{CM}) of unused orthogonal codes is two.

For example, code generator 151 may select codes for code multiplex transmission such that a set of codes WH₄(1) and WH₄(2) or a set of codes WH₄(3) and WH₄(4) is not included in unused orthogonal codes. For example, a combination of codes for code multiplex transmission (Code₁ and Code₂) may be a combination of Code₁=WH₄(1) (=[1, 1, 1, 1]) and Code₂=WH₄(3) (=[1, 1, −1, −1]), a combination of Code₁=WH₄(1) and Code₂=WH₄(4), a combination of Code₁=WH₄(2) and Code₂=WH₄(3), or a combination of Code₁=WH₄(2) and Code₂=WH₄(4).

Further, for example, in a case where code multiplexing number N_{CM} is two, aliasing determiner 252 of radar receiver 200a may use, among N_{allcode}=4 Walsh-Hadamard codes with code length Loc=4, at least one of two (=N_{allcode}−N_{CM}) unused orthogonal codes, which are not used by code generator 151 (in other words, not used for code multiplex transmission), for aliasing determination (an example will be described later).

Hereinafter, among N_{allcode} orthogonal codes with code length Loc, unused orthogonal codes are represented by “UnCode_{nuc}=[UOC_{nuc}(1), UOC_{nuc}(2), UOC_{nuc}(Loc)]”. Note that, UnCode_{nuc} represents the nuc-th unused orthogonal code. Further, nuc represents the index of an unused orthogonal code, and nuc=1, . . . , (N_{allcode}−N_{CM}). Further, UOC_{nuc}(noc) represents the noc-th code element in the nuc-th unused orthogonal code UnCode_{nuc}. Further, noc represents the index of a code element, and noc=1, . . . , Loc.

For example, in a case where the code multiplexing number is N_{CM}=2 and codes for code multiplex transmission, determined by code generator 151, are Code₁=WH₄(1) (=[1, 1, 1, 1]) and Code₂=WH₄(3) (=[1, 1, −1, −1]), the unused orthogonal codes are UnCode₁=WH₄(2) (=[1, −1, 1, −1]) and UnCode₂=WH₄(4) (=[1, −1, −1, 1]). Note that, a combination of unused orthogonal codes (UnCode₁ and UnCode₂) is not limited to a combination of WH₄(2) and WH₄(4) and may be a combination of other codes.

In the same manner, for example, in a case where code multiplexing number N_{CM}=3, code generator 151 determines, as codes for code multiplex transmission, three orthogonal codes among Walsh-Hadamard codes with code length Loc=4. In this case, the number (N_{allcode}−N_{CM}) of unused orthogonal codes is one.

For example, code generator 151 may select Code₁=WH₄(3)=[1, 1, −1, −1], Code₂=WH₄(4)=[1, −1, −1, 1], and Code₃=WH₄(2)=[1, −1, 1, −1].

Further, aliasing determiner 252 of radar receiver 200a may use, among N_{allcode}=4 Walsh-Hadamard codes with code length Loc=4, one (=N_{allcode}−N_{CM}) unused orthogonal code for aliasing determination (an example will be described later). For example, in a case where the code multiplexing number is N_{CM}=3 and codes for code multiplex transmission, determined by code generator 151, are Code₁=WH₄(3)=[1, 1, −1, −1], Code₂=WH₄(4)=[1, −1, −1, 1], and Code₃=WH₄(2)=[1, −1, 1, −1], the unused orthogonal code is UnCode₁=WH₄(1)=[1, 1, 1, 1]. Note that, a combination of codes for code multiplex transmission (Code₁, Code₂, and Code₃) and an unused orthogonal code (UnCode₁) is not limited thereto and may be a combination of other codes.

<Case of N_{CM}=4, 5, 6, or 7>

In a case where N_{CM}=4, 5, 6, or 7, for example, Walsh-Hadamard codes with code length Loc=8, 16, 32, . . . may be applied. In the case of these code lengths Loc, N_{CM}<N_{allcode}(Loc). Further, in a case where the code multiplexing number is N_{CM}=4, 5, 6, or 7, Walsh-Hadamard codes with a shorter code length (for example, Loc=8) among these code lengths Loc may also be used.

For example, Walsh-Hadamard codes with code length Loc=8 include following eight orthogonal codes.

$${WH}_{8} ( 1 ) = [ \begin{matrix}\begin{matrix}\begin{matrix}\begin{matrix}\begin{matrix}\begin{matrix}\begin{matrix}1 & 1\end{matrix} & 1\end{matrix} & 1\end{matrix} & 1\end{matrix} & 1\end{matrix} & 1\end{matrix} & 1 ] ,\end{matrix}$$

$${WH}_{8} ( 2 ) = [ \begin{matrix}\begin{matrix}\begin{matrix}\begin{matrix}\begin{matrix}\begin{matrix}\begin{matrix}1 & - 1\end{matrix} & 1\end{matrix} & - 1\end{matrix} & 1\end{matrix} & - 1\end{matrix} & 1\end{matrix} & - 1 ] ,\end{matrix}$$

$${WH}_{8} ( 3 ) = [ \begin{matrix}\begin{matrix}\begin{matrix}\begin{matrix}\begin{matrix}\begin{matrix}\begin{matrix}1 & 1\end{matrix} & - 1\end{matrix} & - 1\end{matrix} & 1\end{matrix} & 1\end{matrix} & - 1\end{matrix} & - 1 ] ,\end{matrix}$$

$${WH}_{8} ( 4 ) = [ \begin{matrix}\begin{matrix}\begin{matrix}\begin{matrix}\begin{matrix}\begin{matrix}\begin{matrix}1 & - 1\end{matrix} & - 1\end{matrix} & 1\end{matrix} & 1\end{matrix} & - 1\end{matrix} & - 1\end{matrix} & 1 ] ,\end{matrix}$$

$${WH}_{8} ( 5 ) = [ \begin{matrix}\begin{matrix}\begin{matrix}\begin{matrix}\begin{matrix}\begin{matrix}\begin{matrix}1 & 1\end{matrix} & 1\end{matrix} & 1\end{matrix} & - 1\end{matrix} & - 1\end{matrix} & - 1\end{matrix} & - 1 ] ,\end{matrix}$$

$${WH}_{8} ( 6 ) = [ \begin{matrix}\begin{matrix}\begin{matrix}\begin{matrix}\begin{matrix}\begin{matrix}\begin{matrix}1 & - 1\end{matrix} & 1\end{matrix} & - 1\end{matrix} & - 1\end{matrix} & 1\end{matrix} & - 1\end{matrix} & 1 ] ,\end{matrix}$$

$${WH}_{8} ( 7 ) = [ \begin{matrix}\begin{matrix}\begin{matrix}\begin{matrix}\begin{matrix}\begin{matrix}\begin{matrix}1 & 1\end{matrix} & - 1\end{matrix} & - 1\end{matrix} & - 1\end{matrix} & - 1\end{matrix} & 1\end{matrix} & 1 ] ,\end{matrix}$$

$${WH}_{8} ( 8 ) = [ \begin{matrix}\begin{matrix}\begin{matrix}\begin{matrix}\begin{matrix}\begin{matrix}\begin{matrix}1 & - 1\end{matrix} & - 1\end{matrix} & 1\end{matrix} & - 1\end{matrix} & 1\end{matrix} & 1\end{matrix} & - 1 ] .\end{matrix}$$

Here, among the Walsh-Hadamard codes with code length Loc=8, WH₈(1) and WH₈(2) are a set of codes in which the odd-numbered code elements are identical between the codes and the even-numbered code elements are code-inverted between the codes. Further, in the same manner, each of a set of WH₈(3) and WH₈(4), a set of WH₈(5) and WH₈(6), and a set of WH₈(7) and WH₈(8) is also a set of codes in the same relationship to the set of WH₈(1) and WH₈(2).

For example, in a case where the number (N_{allcode}−N_{CM}) of unused orthogonal codes is greater than or equal to two, code generator 151 may select, as an example of selecting codes such that a set of codes in such a relationship is not included in the unused orthogonal codes, codes for code multiplex transmission such that a set of codes WH₈(1) and WH₈(2), a set of codes WH₈(3) and WH₈(4), a set of codes WH₈(5) and WH₈(6), or a set of codes WH₈(7) and WH₈(8) is not included in the unused orthogonal codes.

For example, in a case where code multiplexing number N_{CM}=4, code generator 151 determines, as codes for code multiplex transmission, four orthogonal codes among Walsh-Hadamard codes with code length Loc=8. In this case, the number (N_{allcode}−N_{CM}) of unused orthogonal codes is four.

For example, in code generator 151, the combination of codes for code multiplex transmission (Code₁, Code₂, Code₃, and Code₄) may be a combination of Code₁=WH₈(1), Code₂=WH₈(3), Code₃=WH₈(5), and Code₄=WH₈(7), or a combination of Code₁=WH₈(1), Code₂=WH₈(4), Code₃=WH₈(5), and Code₄=WH₈(8). Note that, the combination of codes for code multiplex transmission (Code₁, Code₂, Code₃, and Code₄) is not limited thereto.

Further, in a case where code multiplexing number N_{CM}=4, for example, aliasing determiner 252 of radar receiver 200a may use, among N_{allcode}=8 Walsh-Hadamard codes with code length Loc=8, one, some or all of four (=N_{allcode}−N_{CM}) unused orthogonal codes, which is/are not used by code generator 151, for aliasing determination (an example will be described later).

For example, in a case where code multiplexing number N_{CM}=4 and codes for code multiplex transmission, determined by code generator 151, are Code₁=WH₈(1), Code₂=WH₈(3), Code₃=WH₈(5), and Code₄=WH₈(7), unused orthogonal codes are UnCode₁=WH₈(2), UnCode₂=WH₈(4), UnCode₃=WH₈(6), and UnCode₄=WH₈(8). Alternatively, for example, in a case where code multiplexing number N_{CM}=4 and codes for code multiplex transmission, determined by code generator 151, are Code₁=WH₈(1), Code₂=WH₈(4), Code₃=WH₈(5), and Code₄=WH₈(8), unused orthogonal codes are UnCode₁=WH₈(2), UnCode₂=WH₈(3), UnCode₃=WH₈(6), and UnCode₄=WH₈(7).

In the same manner, for example, in a case where code multiplexing number N_{CM}=5, code generator 151 determines, as codes for code multiplex transmission, five orthogonal codes among Walsh-Hadamard codes with code length Loc=8. In this case, the number (N_{allcode}−N_{CM}) of unused orthogonal codes is three.

For example, in code generator 151, the combination of codes for code multiplex transmission (Code₁, Code₂, Code₃, Code₄, and Code₅) may be a combination of Code₁=WH₈(1), Code₂=WH₈(3), Code₃=WH₈(5), Code₄=WH₈(7), and Code₅=WH₈(8), or a combination of Code₁=WH₈(1), Code₂=WH₈(4), Code₃=WH₈(5), Code₄=WH₈(7), and Code₅=WH₈(8). Note that, the combination of codes for code multiplex transmission (Code₁, Code₂, Code₃, Code₄, and Code₅) is not limited thereto.

In a case where code multiplexing number N_{CM}=5, for example, aliasing determiner 252 of radar receiver 200a uses, among N_{allcode}=8 Walsh-Hadamard codes with code length Loc=8, one, some or all of three (=N_{allcode}−N_{CM}) unused orthogonal codes, which is/are not used by code generator 151, for aliasing determination (an example will be described later).

For example, in a case where code multiplexing number N_{CM}=5 and codes for code multiplex transmission, determined by code generator 151, are Code₁=WH₈(1), Code₂=WH₈(3), Code₃=WH₈(5), Code₄=WH₈(7), and Code₅=WH₈(8), unused orthogonal codes are UnCode₁=WH₈(2), UnCode₂=WH₈(4), and UnCode₃=WH₈(6). Alternatively, for example, in a case where code multiplexing number N_{CM}=5 and codes for code multiplex transmission, determined by code generator 151, are Code₁=WH₈(1), Code₂=WH₈(4), Code₃=WH₈(5), Code₄=WH₈(7), and Code₅=WH₈(8), unused orthogonal codes are UnCode₁=WH₈(2), UnCode₂=WH₈(3), and UnCode₃=WH₈(6).

In the same manner, for example, in a case where code multiplexing number N_{CM}=6, code generator 151 determines, as codes for code multiplex transmission, six orthogonal codes among Walsh-Hadamard codes with code length Loc=8. In this case, the number (N_{allcode}−N_{CM}) of unused orthogonal codes is two.

For example, in code generator 151, the combination of codes for code multiplex transmission (Code₁, Code₂, Code₃, Code₄, Code₅, and Code₆) may be Code₁=WH₈(1), Code₂=WH₈(2), Code₃=WH₈(3), Code₄=WH₈(4), Code₅=WH₈(5), and Code₆=WH₈(8). Note that, the combination of codes for code multiplex transmission (Code₁, Code₂, Code₃, Code₄, Code₅, and Code₆) is not limited thereto.

Further, in a case where code multiplexing number N_{CM}=6, for example, aliasing determiner 252 of radar receiver 200a may use, among N_{allcode}=8 Walsh-Hadamard codes with code length Loc=8, one or all of two (=N_{allcode}−N_{CM}) unused orthogonal codes, which is/are not used by code generator 151, for aliasing determination (an example will be described later).

For example, in a case where the code multiplexing number is N_{CM}=6 and codes for code multiplex transmission, determined by code generator 151, are Code₁=WH₈(1), Code₂=WH₈(2), Code₃=WH₈(3), Code₄=WH₈(4), Code₅=WH₈(5), and Code₆=WH₈(8), unused orthogonal codes are UnCode₁=WH₈(6) and UnCode₂=WH₈(7).

In the same manner, for example, in a case where code multiplexing number N_{CM}=7, code generator 151 determines, as codes for code multiplex transmission, seven orthogonal codes among Walsh-Hadamard codes with code length Loc=8. In this case, the number (N_{allcode}−N_{CM}) of unused orthogonal codes is one.

For example, code generator 151 may select Code₁=WH₈(1), Code₂=WH₈(2), Code₃=WH₈(3), Code₄=WH₈(4), Code₅=WH₈(5), Code₆=WH₈(6), and Code₇=WH₈(7) as codes for code multiplex transmission. Note that, the combination of codes for code multiplex transmission is not limited thereto.

Further, aliasing determiner 252 of radar receiver 200a may use, among N_{allcode}=8 Walsh-Hadamard codes with code length Loc=8, one (=N_{allcode}−N_{CM}) unused orthogonal code, which is not used by code generator 151, for aliasing determination (an example will be described later).

For example, in a case where code multiplexing number N_{CM}=7 and codes for code multiplex transmission, determined by code generator 151, are Code₁=WH₈(1), Code₂=WH₈(2), Code₃=WH₈(3), Code₄=WH₈(4), Code₅=WH₈(5), Code₆=WH₈(6), and Code₇=WH₈(7), an unused orthogonal code is UnCode₁=WH(8).

The cases of code multiplexing number N_{CM}=4, 5, 6, or 7 have been described above.

Note that, also in a case where code multiplexing number N_{CM}=8 or more, radar apparatus 10a may determine codes for code multiplex transmission and unused orthogonal codes in the same manner as in the cases of code multiplexing number N_{CM}=2 to 7.

For example, code generator 151 may select, as codes for code multiplex transmission, N_{CM} orthogonal codes among Walsh-Hadamard codes with code length Loc indicated by equation 16.

[20]

Loc=2^{ceil[log}^{₂}^{(N}^{_{CM}}^{+1)]} (Equation 16)

In this case, N_{CM}<Loc=N_{allcode}(Loc).

Further, aliasing determiner 252 of radar receiver 200a may use (N_{allcode}−N_{CM}) unused orthogonal codes among N_{allcode}=Loc Walsh-Hadamard codes with code length Loc for aliasing determination (an example will be described later). Further, in a case where the number (N_{allcode}−N_{CM}) of unused orthogonal codes is greater than or equal to two, code generator 151 may select, for example, codes for code multiplex transmission among Walsh-Hadamard codes with code length Loc such that a set of codes, in which either the odd-numbered code elements are identical between the codes and even-numbered code elements are code-inverted between the codes, or the even-numbered code elements are identical between the codes and the odd-numbered code elements are code-inverted between the codes, is not included in the unused orthogonal codes.

In other words, among Walsh-Hadamard codes with code length Loc, one of a set of codes, in which either the odd-numbered code elements are identical between the codes and even-numbered code elements are code-inverted between the codes, or the even-numbered code elements are identical between the codes and the odd-numbered code elements are code-inverted between the codes, may be included in the unused orthogonal codes, and the other of the set of codes may be included in the unused orthogonal codes.

Note that, the elements forming the orthogonal code sequence are not limited to real numbers, but complex values may also be included.

Further, the code may also be another orthogonal code different from the Walsh-Hadamard code. For example, the code may be an orthogonal M-sequence code or a pseudo-orthogonal code.

An example of orthogonal codes in each code multiplexing number N_{CM} has been described above.

Next, an example of a phase rotation amount based on a code for code multiplex transmission generated by code generator 151 will be described.

Radar apparatus 10a performs, for example, code multiplex transmission using orthogonal codes different from each other, for transmission antennas Tx #1 to Tx #N_{T} that perform code multiplex transmission. Then, for example, code generator 151 configures phase rotation amount ψ_{ncm}(m) based on orthogonal code Code_{ncm} to be applied to ncm-th transmission antenna Tx #ncm in m-th average transmission period Tr and outputs phase rotation amount ψ_{ncm}(m) to phase rotator 152. Here, ncm=1, . . . , N_{CM}.

For example, as phase rotation amount ψ_{ncm}(m), phase amounts corresponding to Loc code elements OC_{ncm}(1), . . . , OC_{ncm}(Loc) of orthogonal code Code_{ncm} are cyclically applied for each duration of Loc transmission periods, the number of which corresponds to code length Loc, as indicated by following equation 17.

[21]

ψ_{ncm}(m)=angle[OC_{ncm}(OC_INDEX)] (Equation 17)

Here, angle(x) is an operator that outputs the radian phase of real number x, and angle(1)=0, angle(−1)=π, angle(j)=π/2, and angle(−j)=π/2. j is an imaginary unit. Further, OC_INDEX is an orthogonal code element index that designates an element of orthogonal code sequence Code_{ncm} and cyclically varies in the range from one to Loc as in following equation 18 for each average transmission period (Tr).

[22]

OC_INDEX=mod(m−1,Loc)+1 (Equation 18)

Here, mod(x, y) is a modulus operator and is a function that outputs a remainder after x is divided by y, and m=1, . . . , Nc. Nc is a predetermined number of transmission periods that radar apparatus 10a uses for radar positioning (hereinafter referred to as “radar transmission signal transmission number”). Further, radar apparatus 10a may perform, for example, transmission in radar transmission signal transmission number Nc that is an integer multiple (for example, Ncode times) of Loc. For example, Nc=Loc×Ncode.

Further, code generator 151 outputs orthogonal code element index OC_INDEX to output switch 251 of radar receiver 200a for each average transmission period (Tr).

Phase rotator 152 includes, for example, phase shifters or phase modulators corresponding to N_{T} transmission antennas 106, respectively. Phase rotator 152 applies, for example, phase rotation amount ψ_{ncm}(m) inputted from code generator 151 to each chirp signal inputted from radar transmission signal generator 101 for each average transmission period Tr.

For example, phase rotator 152 applies phase rotation amount ψ_{ncm}(m) based on orthogonal code Code_{ncm} to be applied to ncm-th transmission antenna Tx #ncm, to each chirp signal inputted from radar transmission signal generator 101 for each average transmission period Tr. Here, ncm=1, . . . , N_{CM}, and m=1, . . . , Nc.

The output from phase rotator 152 to N_{T} transmission antennas 106 is amplified to a predetermined transmission power, for example, and then is radiated into space from N_{T} transmission antennas 106 (for example, transmission array antenna).

As an example, a case where code multiplex transmission is performed with number N_{T}=3 of transmission antennas and code multiplexing number N_{CM}=3 will be described. Note that, number N_{T} of transmission antennas and code multiplexing number N_{CM} are not limited these values.

For example, phase rotation amounts ψ₁(m), ψ₂(m), and ψ₃(m) are outputted from code generator 151 to phase rotator 152 for each m-th average transmission period Tr.

First (ncm=1) phase rotator 152 (in other words, a phase shifter corresponding to first transmission antenna 106 (for example, Tx #1)) applies phase rotation to each chirp signal, which is generated by radar transmission signal generator 101 for each average transmission period Tr, for each average transmission period Tr as indicated by following equation 19.

[23]

exp[jψ₁(1)]cp(t),exp[jψ₁(2)]cp(t),exp[jψ₁(3)]cp(t), . . . ,exp[j vi(Nc)]cp(t) (Equation 19)

The output of first phase rotator 152 is transmitted from transmission antenna Tx #1. Here, cp(t) represents the chirp signal for each m-th average transmission period Tr.

In the same manner, second (ncm=2) phase rotator 152 applies phase rotation to each chirp signal, which is generated by radar transmission signal generator 101 for each average transmission period Tr, for each average transmission period Tr as indicated by following equation 20.

[21]

exp[jψ₂(1)]cp(t),exp[jψ₂(2)]cp(t),exp[jψ₂(3)]cp(t), . . . ,exp[jψ₂(Nc)]cp(t) (Equation 20)

The output of second phase rotator 152 is transmitted from transmission antenna Tx #2.

In the same manner, third (ncm=3) phase rotator 152 applies phase rotation to each chirp signal, which is generated by radar transmission signal generator 101 for each average transmission period Tr, for each average transmission period Tr as indicated by following equation 21.

[21]

exp[jψ₃(1)]cp(t),exp[jψ₃(2)]cp(t),exp[jψ₃(3)]cp(t), . . . ,exp[jψ₃(Nc)]cp(t) (Equation 21)

The output of third phase rotator 152 is transmitted from transmission antenna Tx #3.

Note that, in a case where radar apparatus 10a continuously performs radar positioning, radar apparatus 10a may variably configure a code used for orthogonal code Code_{ncm} for each radar positioning (for example, for each of Nc transmission periods (Nc×Tr)).

Further, for example, radar apparatus 10a may variably configure transmission antenna 106 that transmits the outputs of Nt phase rotators 152 (in other words, transmission antennas 106 corresponding to each output of phase rotators 152). For example, association of a plurality of transmission antennas 106 with code sequences for code multiplex transmission may vary for each radar positioning by radar apparatus 10a. In a case where radar apparatus 10a receives, for example, a signal under the influence of interference from another radar, which differs for each transmission antenna 106, the code-multiplexed signal outputted from transmission antennas 106 varies for each radar positioning, and the effect of randomizing the influence of interference can be obtained.

A configuration example of radar transmitter 100a has been described above.

[Configuration of Radar Receiver 200a]

In FIG. 7, radar receiver 200a includes Na reception antennas 202 (for example, also represented by Rx #1 to Rx #Na) to form an array antenna. Further, radar receiver 200a includes Na antenna system processors 201-1 to 201-Na, CFAR processor 210, aliasing determiner 252, code demultiplexer 253, and direction estimator 211.

Each reception antenna 202 receives a reflected wave signal that is a radar transmission signal reflected by a target, and outputs, as a reception signal, the received reflected wave signal to corresponding antenna system processor 201.

Each antenna system processor 201 includes reception radio 203 and signal processor 206a.

The operation of reception radio 203 may be the same as, for example, that in Embodiment 1.

Signal processor 206a of each antenna system processor 201-z (where z=any one of 1 to Na) includes AD converter 207, beat frequency analyzer 208, output switch 251, and Doppler analyzer 209a.

The operations of AD converter 207 and beat frequency analyzer 208 are the same as, for example, those in Embodiment 1.

Output switch 251 selectively switches and outputs the output of beat frequency analyzer 208 for each transmission period to OC_INDEX-th Doppler analyzer 209a among Loc Doppler analyzers 209a based on orthogonal code element index OC_INDEX outputted from code generator 151. In other words, output switch 251 selects OC_INDEX-th Doppler analyzer 209a in m-th average transmission period Tr.

Signal processor 206a includes, for example, Loc Doppler analyzers 209a-1 to 209a-Loc. For example, data is inputted into noc-th Doppler analyzer 209a by output switch 251 for each of Loc average transmission periods (Loc×Tr). For this reason, noc-th Doppler analyzer 209a performs Doppler analysis for each distance index f_{b} by using data of Ncode transmission periods (for example, beat frequency response RFT_{z}(f_{b}, m) outputted from beat frequency analyzer 208) among Nc average transmission periods. Here, noc is the index of a code element, and noc=1, . . . , Loc.

For example, in a case where Ncode is the value of a power of two, FFT processing may be applied in Doppler analysis. In this case, the FFT size is Ncode, and the maximum Doppler frequency at which no aliasing occurs and which is derived from the sampling theorem is ±1/(2Loc×Tr). Further, the Doppler frequency interval of Doppler frequency index fₛ is 1/(Ncode×Loc×Tr), and the range of Doppler frequency index fₛ is fₛ=−Ncode/2, . . . , 0, . . . , Ncode/2−1.

For example, output VFT_{z}^{noc}(f_{b}, fₛ) of Doppler analyzer 209a in z-th signal processor 206a is indicated by following equation 22.

[26]

$$V F {T}_{z}^{n o c} ( {f}_{b} , {f}_{s} ) = {\sum }_{s = 0}^{{N}_{code} - 1} R F {T}_{z} ( {f}_{b} , {L}_{OC} \times s + n o c ) exp [ - j \frac{2 π {sf}_{s}}{{N}_{code}} ] \qquad ( Equation 22 )$$

where j is an imaginary unit, and z=1 to Na.

Further, in a case where Ncode is not a power of two, for example, zero-padded data may be included to obtain power-of-two pieces of data size (FFT size) to perform FFT processing. For example, in a case where the FFT size in Doppler analyzer 209a when zero-padded data is included is N_{codewzero}, output VFT_{z}^{noc}(f_{b}, fₛ) of Doppler analyzer 209a in z-th signal processor 206a is indicated by following equation 23.

[27]

$$V F {T}_{z}^{n o c} ( {f}_{b} , {f}_{s} ) = {\sum }_{s = 0}^{{N}_{codewzero} - 1} R F {T}_{z} ( {f}_{b} , {L}_{OC} \times s + n o c ) exp [ - j \frac{2 π s {f}_{s}}{{N}_{codewzero}} ] \qquad ( Equation 23 )$$

Here, noc is the index of a code element, and noc=1, . . . , Loc. The FFT size is N_{codewzero}, and the maximum Doppler frequency at which no aliasing occurs and which is derived from the sampling theorem is ±1/(2Loc×Tr). Further, the Doppler frequency interval of Doppler frequency index fₛ is 1/(N_{codewzero}×Loc×Tr), and the range of Doppler frequency index fₛ is fₛ=N_{codewzero}/2, . . . , 0, . . . , N_{codewzero}/2−1.

Hereinafter, a case where Ncode is the value of a power of two will be described as an example. Note that, in a case where zero padding is used in Doppler analyzer 209a, the same applies and the same effect can be obtained by replacing Ncode with N_{codewzero} in the following description.

Further, at the time of FFT processing, Doppler analyzer 209a may perform multiplication by a window function coefficient such as a Han window or a Hamming window, for example. Radar apparatus 10a can suppress side lobes that appear around a beat frequency peak by applying a window function.

The processing in each component of signal processor 206a has been described above.

In FIG. 7, CFAR processor 210 performs CFAR processing (in other words, adaptive threshold determination) by using the outputs of Loc Doppler analyzers 209a of each of first to Na-th signal processors 206a and extracts distance indexes f_{b_cfar} and Doppler frequency indexes f_{s_cfar} that give a peak signal.

For example, CFAR processor 210 performs power addition of outputs VFT_{z}^{noc}(f_{b}, fₛ) of Doppler analyzers 209a of first to Na-th signal processors 206a as indicated by following equation 24 and performs two-dimensional CFAR processing with the distance axis and the Doppler frequency axis (which corresponds to the relative velocity) or CFAR processing combined with one-dimensional CFAR processing.

$$\begin{matrix}( Equation 24 ) & \\ PowerFT ( {f}_{b} , {f}_{s} ) = {\sum }_{z = 1}^{{N}_{a}} {\sum }_{n o c = 1}^{{L}_{o c}} {\vert VF {T}_{z}^{n o c} ( {f}_{b} , {f}_{s} ) \vert}^{2} & [ 28 ]\end{matrix}$$

Processing disclosed in, for example, NPL 1 may be applied as the two-dimensional CFAR processing or the CFAR processing combined with the one-dimensional CFAR processing.

CFAR processor 210 adaptively configures a threshold value, and outputs distance indexes f_{b_cfar}, Doppler frequency indexes f_{s_cfar}, and received power information PowerFT(f_{b_cfar}, f_{s_cfar}), which provide received power greater than the threshold value, to aliasing determiner 252.

Next, an operation example of aliasing determiner 252 illustrated in FIG. 7 will be described.

Aliasing determiner 252 performs, for example, aliasing determination on Doppler components VFT_{z}^{noc}(f_{b_cfar}, f_{s_cfar}), which are the outputs of Doppler analyzer 209a, based on distance indexes f_{b_cfar} and Doppler frequency indexes f_{s_cfar} extracted by CFAR processor 210. Here, z=1, . . . , Na, and noc=1, . . . , Loc.

Aliasing determiner 252 may perform, for example, Doppler aliasing determination processing on the assumption that the Doppler range of a target is ±1/(2×Tr).

Here, for example, in a case where Ncode is the value of a power of two, Doppler analyzer 209a applies FFT processing to each code element, and thus, Doppler analyzer 209a performs FFT processing by using an output from beat frequency analyzer 208 in a period of (Loc×Tr). For this reason, a Doppler range in which no aliasing occurs by the sampling theorem in Doppler analyzer 209a is ±1/(2Loc×Tr).

Thus, the Doppler range of a target assumed in aliasing determiner 252 is wider than the Doppler range in which no aliasing occurs in Doppler analyzer 209a. For example, aliasing determiner 252 performs aliasing determination processing by assumption up to a Doppler range ±1/(2×Tr) that is Loc times a Doppler range ±1/(2Loc×Tr) in which no aliasing occurs in Doppler analyzer 209a.

Hereinafter, an example of aliasing determination processing in aliasing determiner 252 will be described.

Here, as an example, a case where code multiplexing number N_{CM}=3 and code generator 151 uses three orthogonal codes Code₁=WH₄(3)=[1, 1, −1, −1], Code₂=WH₄(4)=[1, −1, −1, 1], and Code₃=WH₄(2)=[1, −1, 1, −1] among Walsh-Hadamard codes with code length Loc=4 will be described.

For example, aliasing determiner 252 uses, among N_{allcode}=4 Walsh-Hadamard codes with code length Loc=4, one (=N_{allcode}−N_{CM}) unused orthogonal code for aliasing determination. For example, in a case where the code multiplexing number is N_{CM}=3 and codes for code multiplex transmission, determined by code generator 151, are Code₁=WH₄(3)=[1, 1, −1, −1], Code₂=WH₄(4)=[1, −1, −1, 1], and Code₃=WH₄(2)=[1, −1, 1, −1], the unused orthogonal code is UnCode₁=WH₄(1)=[1, 1, 1, 1].

For example, in a case where radar apparatus 10a performs code multiplex transmission by using orthogonal codes with code length Loc=4, Doppler analyzer 209a applies FFT processing to each code element as described above, and thus, Doppler analyzer 209a performs FFT processing by using an output from beat frequency analyzer 208 in a period of (Loc×Tr)=(4×Tr). Thus, a Doppler range in which no aliasing occurs by the sampling theorem in Doppler analyzer 209a is ±1/(2 Loc×Tr)=±1/(8×Tr).

Aliasing determiner 252 performs aliasing determination in a range that is greater by a factor of code length Loc of an orthogonal code sequence than a Doppler analysis range (Doppler range) in Doppler analyzer 209a. For example, aliasing determiner 252 performs aliasing determination processing by assuming a Doppler range=±1/(2×Tr) that is four (=Loc) times a Doppler range ±1/(8×Tr) in which no aliasing occurs in Doppler analyzer 209a.

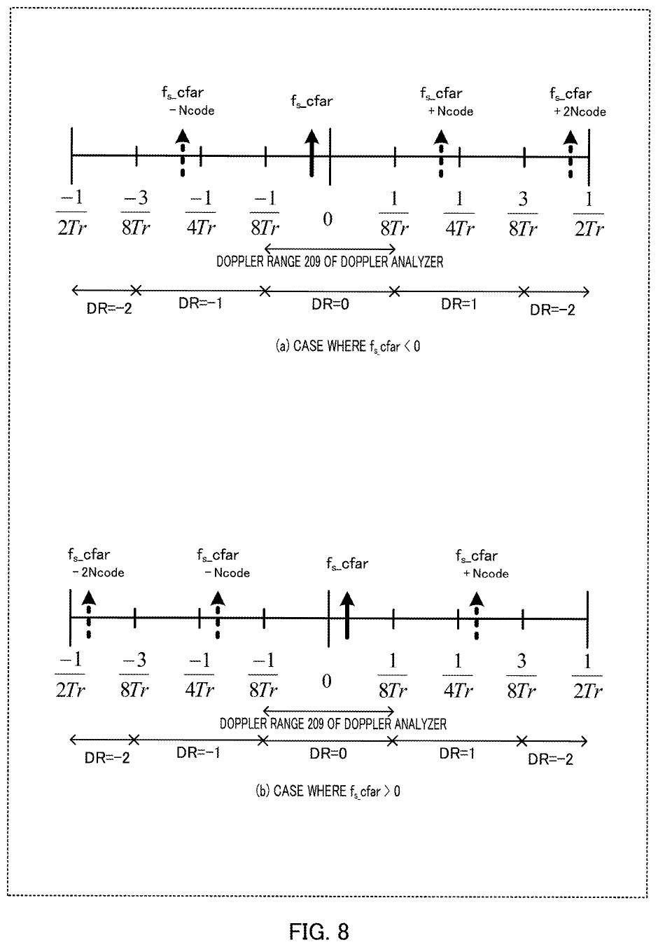

Here, Doppler components VFT_{z}^{noc}(f_{b_cfar}, f_{s_cfar}) that are the outputs of Doppler analyzers 209a corresponding to distance indexes f_{b_cfar} and Doppler frequency indexes f_{s_cfar} extracted by CFAR processor 210 may include, for example, Doppler components including aliasing as illustrated in (a) and (b) of FIG. 8 in a Doppler range of ±1/(2×Tr).

For example, as illustrated in (a) of FIG. 8, in a case where f_{s_cfar}<0, four (=Loc) Doppler components of f_{s_cfar}−Ncode, f_{s_cfar}, f_{s_cfar}+Ncode, and f_{s_cfar}+2Ncode are possible in the Doppler range ±1/(2×Tr).

Further, for example, as illustrated in (b) of FIG. 8, in a case where f_{s_cfar}>0, four (=Loc) Doppler components of f_{s_cfar}−2Ncode, f_{s_cfar}−Ncode, f_{s_cfar}, and f_{s_cfar}+Ncode are possible in the Doppler range ±1/(2×Tr).

Aliasing determiner 252 performs, for example, code demultiplexing processing in the Doppler range ±1/(2×Tr) as illustrated in FIG. 8 by using an unused orthogonal code. For example, aliasing determiner 252 may correct, for the unused orthogonal code, a phase change in four (=Loc) Doppler components including aliasing as illustrated in FIG. 8.

Then, aliasing determiner 252 determines whether each Doppler component is aliasing based on the received power of Doppler components code-demultiplexed based on the unused orthogonal code. For example, aliasing determiner 252 detects, among Doppler components including aliasing, a Doppler component with the minimum received power, and determines the detected Doppler component as a true Doppler component. In other words, aliasing determiner 252 determines, among the Doppler components including aliasing, Doppler components with other received power different from the minimum received power as false Doppler components.

This aliasing determination processing makes it possible to reduce ambiguity of a Doppler range including aliasing. Further, this aliasing determination processing makes it possible to extend a range in which a Doppler frequency can be detected without ambiguity to a range greater than or equal to −1/(2Tr) and less than 1/(2Tr) in comparison with a Doppler range in Doppler analyzer 209a.

As a result, when code demultiplexing is performed based on an unused orthogonal code, for example, a phase change in a true Doppler component is properly corrected, and the orthogonality between the orthogonal codes for code multiplex transmission and the unused orthogonal code is maintained. Thus, the unused orthogonal code and the code multiplex transmission signals are uncorrelated, and the received power becomes approximately a noise level.

On the other hand, for example, a phase change in a false Doppler component is erroneously corrected, and the orthogonality between the orthogonal codes for code multiplex transmission and the unused orthogonal code is not maintained. Thus, a correlation component (interference component) between the unused orthogonal code and the code-multiplexed transmission signals occurs, and, for example, a received power greater than a noise level may be detected.

Thus, as described above, aliasing determiner 252 can determine, among Doppler components code-demultiplexed based on an unused orthogonal code, a Doppler component with the minimum received power as a true Doppler component, and can determine the other Doppler components with received power different from the minimum received power as false Doppler components.

For example, aliasing determiner 252 corrects a phase change in a Doppler component including aliasing based on the output of Doppler analyzer 209a in each antenna system processor 201, and calculates received power DeMulUnCode_{nuc}(f_{b_cfar}, f_{s_cfar}, DR) after code demultiplexing using unused orthogonal code UnCode_{nuc} in accordance with following equation 25.

$$\begin{matrix}( Equation 25 ) & \\ {DeMulUnCode}_{nuc} ( {f}_{b \_ cfar} , {f}_{s \_ cfar} , DR ) = {\sum }_{z = 1}^{Na} \vert {\vert {( {UnCode}_{nuc} )}^{⋆} \cdot {\{ β ( DR ) ⊗ α ( {f}_{s \_ cfar} ) ⊗ {VFTALL}_{z} ( {f}_{b\_cfar} , {f}_{s\_cfar} ) \}}^{T} \vert}^{2} & [ 29 ]\end{matrix}$$

In equation 25, the sum of the received powers after code demultiplexing using unused orthogonal code UnCode_{nuc} is calculated with respect to the outputs of Doppler analyzers 209a in all of antenna system processors 201, which makes it possible to enhance aliasing determination accuracy even in a case where the reception signal level is low. However, instead of equation 25, the received power after code demultiplexing using the unused orthogonal code may be calculated with respect to the outputs of Doppler analyzer(s) 209a in one or some of antenna system processors 201. Even in this case, it is possible to reduce the arithmetic processing amount while maintaining aliasing determination accuracy in a range in which the reception signal level is sufficiently high, for example.

Note that, in equation 25, nuc=1, . . . , N_{allcode}−N_{CM}. Further, DR is the index indicating a Doppler aliasing range and, for example, takes an integer value in ranges of DR=ceil[−Loc/2], ceil[−Loc/2]+1, . . . , 0, . . . , ceil[Loc/2]−1.

Further, in equation 25,

[30]

operator “⊗”

indicates the product between elements of vectors having the same number of elements. For example, for n-dimensional vectors A=[a₁, . . . , aₙ] and B=[b₁, . . . , bₙ], the product between the elements is indicated by following equation 26.

[31]

A⊗B=[a₁, . . . ,aₙ]⊗[b₁, . . . ,bₙ]=[a₁b₁, . . . ,aₙbₙ] (Equation 26)

Further, in equation 25,

operator “●” [32]

indicates a vector inner product operator. Further, in equation 25, character superscript T indicates vector transposition, and character superscript * (asterisk) indicates a complex conjugate operator.

In equation 25, α(f_{s_cfar}) represents a “Doppler phase correction vector”. For example, in a case where Doppler frequency index f_{s_cfar} extracted by CFAR processor 210 falls within an output range (in other words, a Doppler range) of Doppler analyzer 209a, in which no Doppler aliasing is included, Doppler phase correction vector α(f_{s_cfar}) corrects Doppler phase rotation due to a time difference in Doppler analysis among Loc Doppler analyzers 209a.

For example, Doppler phase correction vector α(f_{s_cfar}) is indicated as in following equation 27.

$$α ( {f}_{s \_ cfar} ) = [ 1 , exp [ - j \frac{2 {π f}_{s \_ cfar}}{{N}_{code}} \frac{1}{Loc} , exp [ - j \frac{2 {π f}_{s \_ cfar}}{{N}_{code}} \frac{2}{Loc} , … , exp [ - j \frac{2 {π f}_{s \_ cfar}}{{N}_{code}} \frac{Loc - 1}{Loc} ] \qquad ( Equation 27 )$$

Doppler phase correction vector α(f_{s_cfar}) indicated by equation 27 is, for example, a vector whose element is a Doppler phase correction coefficient for correcting phase rotation in a Doppler component of Doppler frequency index f_{s_cfar}, which occurs due to each time delay of Tr, 2Tr, . . . , (Loc−1)Tr in output VFT_{z}²(f_{b_cfar}, f_{s_cfar}) of second Doppler analyzer 209a to output VFT_{z}^{Loc}(f_{b_cfar}, f_{s_cfar}) of Loc-th Doppler analyzer 209a by using a Doppler analysis time of output VFT_{z}¹(f_{b_cfar}, f_{s_cfar}) of first Doppler analyzer 209a as a reference.

Further, in equation 25, β(DR) represents an “aliasing phase correction vector”. For example, aliasing phase correction vector β(DR) corrects, among Doppler phase rotations due to a time difference in Doppler analysis among Loc Doppler analyzers 209a, Doppler phase rotation of an integer multiple of 2π in view of a case where there is Doppler aliasing.

For example, aliasing phase correction vector β(DR) is indicated by following equation 28.

$$β ( DR ) = [ 1 , exp ( - j 2 π DR \frac{1}{Loc} ) , exp ( - j 2 π DR \frac{2}{Loc} ) , … , exp ( - j 2 π DR \frac{Loc - 1}{Loc} ) ] \qquad ( Equation 28 )$$

For example, in a case where Loc=4, DR takes an integer value of−2, −1, 0, 1, and aliasing phase correction vector β(DR) is indicated as in equations 29, 30, 31, and 32.

$$β ( - 2 ) = [ 1 , - 1 , 1 , - 1 ] \qquad ( Equation 29 )$$

$$β ( - 1 ) = [ 1 , exp ( j \frac{π}{2} ) , exp ( j π ) , exp [ j π \frac{3}{2} ] \qquad ( Equation 30 )$$

$$β ( 0 ) = [ 1 , 1 , 1 , 1 ] \qquad ( Equation 31 )$$

$$β ( 1 ) = [ 1 , exp ( - j \frac{π}{2} ) , exp ( - j π ) , exp [ - j π \frac{3}{2} ] \qquad ( Equation 32 )$$

For example, in a case where Loc=4, a Doppler range (for example, −⅛Tr to +⅛Tr) in which Doppler components of Doppler frequency indexes f_{s_cfar}, which are the outputs of Doppler analyzers 209a, are detected corresponds to DR=0 in (a) and (b) of FIG. 8. Further, with Doppler phase rotation of integer multiples of 2π (for example, β(1), β(−1), and β(−2)) for Doppler frequency index f_{s_cfar} for DR=0, aliasing determiner 252 calculates Doppler components in a Doppler range (for example, ⅛Tr to ⅜Tr) corresponding to DR=1, Doppler components in a Doppler range (for example, −⅜Tr to −⅛Tr) corresponding to DR=−1, and Doppler components in a Doppler range (for example, −½Tr to −⅜Tr and ⅜Tr to ½Tr) corresponding to DR=−2.

Further, for example, in equation 25, VFTALL_{z}(f_{b_cfar}, f_{s_cfar}) indicates, in vector form, components VFT_{z}^{noc}(f_{b_cfar}, f_{s_cfar}) (where noc=1, . . . , Loc) corresponding to distance indexes f_{b_cfar} and Doppler frequency indexes f_{s_cfar} extracted by CFAR processor 210 among outputs VFT_{z}^{noc}(f_{b}, fₛ) of Loc Doppler analyzers 209a in z-th antenna system processor 201 as in following equation 33.

[39]

VFTALL_{z}(f_{b_cfar},f_{s_cfar})=[VFT_{z}¹(f_{b_cfar},f_{s_cfar}),VFT_{z}²(f_{b_cfar},f_{s_cfar}),VFT_{z}^{Loc}(f_{b_cfar},f_{s_cfar}),] (Equation 33)

For example, aliasing determiner 252 calculates each received power DeMulUnCode_{nuc}(f_{b_cfar}, f_{s_cfar}, DR) after code demultiplexing using unused orthogonal code UnCode_{nuc}, in which a phase change in Doppler components including aliasing is corrected, in the ranges DR=ceil[−Loc/2], ceil[−Loc/2]+1, . . . , 0, . . . , ceil[Loc/2]−1 in accordance with equation 25.

Then, aliasing determiner 252 detects DR of which received power DeMulUnCode_{nuc}(f_{b_cfar}, f_{s_cfar}, DR) is minimum among the ranges of DR. Hereinafter, among the ranges of DR, DR of which received power DeMulUnCode_{nuc}(f_{b_cfar}, f_{s_cfar}, DR) is minimum is represented by “DRₘᵢₙ” as indicated by following equation 34.

$${DR}_{min} = \{ arg DR \vert {min}_{DR = ceil [ - Loc / 2 ] , … , ceil [ Loc / 2 ] - 1} {DeMulUn Code}_{nuc} ( {f}_{b \_ cfar} , {f}_{s \_ cfar} , DR ) \}$$

Hereinafter, the reason why Doppler aliasing determination is possible through the above-described aliasing determination processing will be described.

A radar transmission signal component transmitted from ncm-th transmission antenna 106 (for example, Tx #ncm) and included in VFTALL_{z}(f_{b_cfar}, f_{s_cfar}) indicated by equation 33 is, for example, indicated by following equation 35 when noise components are ignored.

[41]

β(DRₜᵣᵤₑ)*⊗α(f_{s_cfar})*⊗γ_{z,ncm}Code_{ncm} (Equation 35)

Here, γ_{z,ncm} represents the complex reflection coefficient in a case where a signal that is a radar transmission signal transmitted from ncm-th transmission antenna 106 and reflected by a target is received by z-th antenna system processor 201. Further, DRₜᵣᵤₑ represents the index indicating a true Doppler aliasing range. DRₜᵣᵤₑ is an index value in the ranges of ceil[−Loc/2], ceil[−Loc/2]+1, . . . , 0, . . . , ceil[Loc/2]−1. Hereinafter, it will be indicated that determination can be made such that DRₘᵢₙ=DRₜᵣᵤₑ.

Sum PowDeMul(nuc, DR, DRₜᵣᵤₑ) of received powers after code demultiplexing using unused orthogonal code UnCode_{nuc} for radar transmission signal components transmitted from first to N_{CM}-th transmission antennas 106 is indicated by following equation 36.

$$PowDeMul ( nuc , DR , {DR}_{true} ) = {\sum }_{ncm = 1}^{{N}_{CM}} {\vert {{Un Code}_{nuc}}^{*} \cdot {\{ β ( DR ) ⊗ α ( {f}_{s \_ cfar} ) ⊗ {β ( {DR}_{true} )}^{*} ⊗ {α ( {f}_{s \_ cfar} )}^{*} ⊗ {γ}_{z , ncm} {C ode}_{ncm} \}}^{T} \vert}^{2} = {\sum }_{ncm = 1}^{{N}_{CM}} {\vert {γ}_{z , ncm} {{Un Code}_{nuc}}^{*} \cdot {\{ β ( DR ) ⊗ {β ( {DR}_{true} )}^{*} ⊗ {Code}_{ncm} \}}^{T} \vert}^{2} = {\sum }_{ncm = 1}^{{N}_{CM}} {\vert {γ}_{z , ncm} \{ β ( DR ) ⊗ {β ( {DR}_{true} )}^{*} ⊗ {{Un Code}_{nuc}}^{*} \} \cdot {\{ {Code}_{ncm} \}}^{T} \vert}^{2} \qquad ( Equation 36 )$$

Note that, PowDeMul(nuc, DR, DRₜᵣᵤₑ) indicated by equation 36 corresponds to the evaluation value of the term

[43]

|(UnCode_{nuc})*●{β(DR)⊗α(f_{s_cfar})⊗VFTALL_{z}(f_{b_cfar},f_{s_cfar}}^{T}|²

in equation 25.

In equation 36, in a case where DR=DRₜᵣᵤₑ, the correlation value between unused orthogonal code UnCode_{nuc} and orthogonal code Code_{ncm} for code multiplex transmission is zero (for example, UnCode_{nuc}*●{Code_{ncm}}^{T}=0), and thus, PowDeMul(nuc, DR, DRₜᵣᵤₑ)=0.

In a case where DR≠DRₜᵣᵤₑ in equation 36, on the other hand, PowDeMul(nuc, DR, DRₜᵣᵤₑ) depending on the correlation value between

[44]

β(DR)⊗β(DRₜᵣᵤₑ)*⊗UnCode_{nuc}*

and orthogonal code Codencm for code multiplex transmission is outputted. Here, in a case where PowDeMul(nuc, DR, DRtrue) is not zero for every UnCodenuc, the power of PowDeMul(nuc, DRₜᵣᵤₑ, DRₜᵣᵤₑ) is minimum when, for example, following equation 37 is satisfied and DR=DRₜᵣᵤₑ, and aliasing determiner 252 can detect DRₜᵣᵤₑ (=DRₘᵢₙ).

$${\sum }_{nuc = 1}^{{N}_{allcode} - {N}_{CM}} PowDeMul ( nuc , DR , {DR}_{true} ) > 0 \qquad ( Equation 37 )$$

In other words, aliasing determiner 252 can perform Doppler aliasing determination in accordance with equation 25.

For example, to satisfy equation 37, the term

[46]

β(DR)*⊗β(DRₜᵣᵤₑ)⊗UnCode_{nuc}

may not match another unused orthogonal code UnCode_{nuc2}. Here, nuc2≠nuc.

Accordingly, in a case where the number of unused orthogonal codes is one, equation 37 is satisfied. Further, in a case where the number of unused orthogonal codes is multiple, for example, code generator 151 may select codes for code multiplex transmission such that the term

[47]

β(DR)*⊗β(DRₜᵣᵤₑ)⊗UnCode_{nuc}

does not match another unused orthogonal code.

Here, in a case where a code, such as a Walsh-Hadamard code and an orthogonal M-sequence code, is used, orthogonal codes with code length Loc may include a set of codes in which the odd-numbered code elements are identical between the codes and the even-numbered code elements are code-inverted between the codes.

On the other hand, β(0)=[1, 1, . . . , 1], and β(−Loc/2)=[1, −1, 1, −1, . . . , 1, −1], and thus, the term

[48]

β(0)*⊗β(−Loc/2)⊗UnCode_{nuc}

is converted into a code in which the odd-numbered code elements of UnCode_{nuc} are identical and the even-numbered code elements of UnCode_{nuc} are code-inverted.

Accordingly, in a case where the number (N_{allcode}−N_{CM}) of unused orthogonal codes is greater than or equal to two, for example, code generator 151 may select, among orthogonal codes with code length Loc, codes for code multiplex transmission or unused orthogonal codes such that a set of codes, in which either the odd-numbered code elements are identical between the codes and even-numbered code elements are code-inverted between the codes, or the even-numbered code elements are identical between the codes and the odd-numbered code elements are code-inverted between the codes, is not included in the unused orthogonal codes.

For example, Walsh-Hadamard codes with code length Loc=4 include WH₄(1)=[1, 1, 1, 1] and WH₄(2)=[1, −1, 1, −1], and

[49]

β(0*⊗β(−Loc/2)⊗WH₄(1)=WH₄(2)

or

[50]

β(0)*⊗β(−Loc/2)⊗WH₄(2)=WH₄(1).

For this reason, for example, code generator 151 may select codes for code multiplex transmission or unused orthogonal codes such that a set of WH₄(1) and WH₄(2) is not included in a plurality of unused orthogonal codes. Further, since WH₄(3)=[1, 1, −1, −1] and WH₄(4)=[1, −1, −1, 1] are also in the same relationship, code generator 151 may select, for example, codes for code multiplex transmission or unused orthogonal codes such that a set of WH₄(3) and WH₄(4) is not included in the unused orthogonal codes.

Note that, in a case where a plurality of unused orthogonal codes UnCode_{nuc} is present, received power DeMulUnCodeAll(f_{b_cfar}, f_{s_cfar}, DR) after code demultiplexing using every unused orthogonal code may be used as in following equation 38 instead of received power DeMulUnCode_{nuc}(f_{b_cfar}, f_{s_cfar}, DR).

$$DeMulUn CodeAll ( {f}_{b \_ cfar} , {f}_{s \_ cfar} , DR ) = {\sum }_{nuc = 1}^{{N}_{allcode} - {N}_{CM}} {DeMulUn Code}_{nun} ( {f}_{b \_ cfar} , {f}_{s \_ cfar} , DR ) \qquad ( Equation 38 )$$

By determining received power after code demultiplexing using every unused orthogonal code, aliasing determiner 252 can enhance aliasing determination accuracy even in a case where the reception signal level is low.

For example, aliasing determiner 252 calculates DeMulUnCodeAll(f_{b_cfar}, f_{s_cfar}, DR) in each range of DR=ceil[−Loc/2], ceil[−Loc/2]+1, . . . , 0, . . . , ceil[Loc/2]−1 and detects DR of which received power DeMulUnCodeAll(f_{b_cfar}, f_{s_cfar}, DR) is minimum (in other words, DRₘᵢₙ). In a case where equation 38 is used, DR that provides the minimum received power in a DR range is represented by “DRₘᵢₙ” as indicated by following equation 39 hereinafter.

$${DR}_{min} = \{ arg DR \vert {min}_{DR = ceil [ - Loc / 2 ] , … , ceil [ Loc / 2 ] - 1} DeMulUn CodeAll ( {f}_{b \_ cfar} , {f}_{s \_ cfar} , DR ) \} \qquad ( Equation 39 )$$

Further, aliasing determiner 252 may perform, for example, processing of determining (in other words, measuring) the probability of aliasing determination by comparing minimum received power DeMulUnCode_{nuc}(f_{b_cfar}, f_{s_cfar}, DRₘᵢₙ) after code demultiplexing using unused orthogonal code UnCode_{nuc} with received power. In this case, aliasing determiner 252 may determine, for example, the probability of aliasing determination in accordance with following equations 40 and 41.

[53]

DeMulUnCode_{nuc}(f_{b_cfar},f_{s_cfar},DRₘᵢₙ)<Threshold_{DR}×PowerFT(f_{b_cfar},f_{s_cfar}) (Equation 40)

DeMulUnCode_{nuc}(f_{b_cfar},f_{s_cfar},DRₘᵢₙ)≥Threshold_{DR}×PowerFT(f_{b_cfar},f_{s_cfar}) (Equation 41)

For example, in a case where minimum received power DeMulUnCode_{nuc}(f_{b_cfar}, f_{s_cfar}, DRₘᵢₙ) after code demultiplexing using unused orthogonal code UnCode_{nuc} is lower than a value obtained by multiplying received power value PowerFT(f_{b_cfar}, f_{s_cfar}) of distance indexes f_{b_cfar} and Doppler frequency indexes f_{s_cfar} extracted by CFAR processor 210 by predetermined value Threshold_{DR} (for example, equation 40), aliasing determiner 252 determines that aliasing determination is sufficiently probable. In this case, radar apparatus 10a may perform, for example, subsequent processing (for example, code demultiplexing processing).

On the other hand, for example, in a case where minimum received power DeMulUnCode_{nuc}(f_{b_cfar}, f_{s_cfar}, DRₘᵢₙ) after code demultiplexing using unused orthogonal code UnCode_{nuc} is greater than or equal to the value obtained by multiplying received power value PowerFT(f_{b_cfar}, f_{s_cfar}) by Threshold_{DR} (for example, equation 41), aliasing determiner 252 determines that aliasing determination accuracy is not sufficient (for example, noise component). In this case, for example, radar apparatus 10a may not perform subsequent processing (for example, code demultiplexing processing).

Such processing makes it possible to reduce determination errors in aliasing determination in aliasing determiner 252 and to remove noise components. Note that, predetermined value Threshold_{DR} may be configured in a range of from zero to less than one, for example. As an example, in consideration of the fact that noise components are included, Threshold_{DR} may be configured in a range of approximately from 0.1 to 0.5.

Note that, in a case where a plurality of unused orthogonal codes UnCode_{nuc} is present, aliasing determiner 252 may perform processing of determining (in other words, measuring) the probability of aliasing determination by comparing DeMulUnCodeAll(f_{b_cfar}, f_{s_cfar}, DR), which is used instead of received power DeMulUnCode_{nuc}(f_{b_cfar}, f_{s_cfar}, DR), with received power. In this case, aliasing determiner 252 may determine, for example, the probability of aliasing determination by using DeMulUnCodeAll(f_{b_cfar}, f_{s_cfar}, DR) instead of DeMulUnCode_{nuc}(f_{b_cfar}, f_{s_cfar}, DR) in equations 40 and 41. By determining received power after code demultiplexing using every unused orthogonal code, aliasing determiner 252 can enhance the accuracy of the probability of aliasing determination even in a case where the reception signal level is low.

Note that, a calculation equation for received power DeMulUnCode_{nuc}(f_{b_cfar}, f_{s_cfar}, DR) after code demultiplexing using unused orthogonal code UnCode_{nuc} may be, for example, following equation 42 instead of equation 25.

$${DeMulUn Code}_{nuc} ( {f}_{b \_ cfar} , {f}_{s \_ cfar} , DR ) = {\sum }_{z = 1}^{Na} {\vert {( β ( DR ) ⊗ {Un Code}_{nuc} )}^{*} \cdot {\{ α ( {f}_{s \_ cfar} ) ⊗ {VFTALL}_{z} ( {f}_{b \_ cfar} , {f}_{s \_ cfar} ) \}}^{T} \vert}^{2} \qquad ( Equation 42 )$$

In equation 42, the term

[56]

β(DR)⊗UnCode_{nuc}

does not depend on the index of Doppler component (Doppler frequency index) fₛ, and thus, it is possible to reduce the arithmetic amount in aliasing determiner 252, for example, by pre-tabulation.

An operation example of aliasing determiner 252 has been described above.

Next, an operation example of code demultiplexer 253 will be described.

Code demultiplexer 253 performs demultiplexing processing on a code-multiplexed signal based on a result of aliasing determination in aliasing determiner 252 and codes for code multiplex transmission.

For example, code demultiplexer 253 performs code demultiplexing processing on Doppler components VFTALL_{z}(f_{b_cfar}, f_{s_cfar}) that are the outputs of Doppler analyzers 209a corresponding to distance indexes f_{b_cfar} and Doppler frequency indexes f_{s_cfar} extracted by CFAR processor 210 based on aliasing phase correction vector β(DR) using DRₘᵢₙ that is a result of aliasing determination in aliasing determiner 252 as in following equation 43.

[57]

DeMUL_{z}^{ncm}(f_{b_cfar},f_{s_cfar})=(Code_{ncm})*●{β(DRₘᵢₙ)⊗α(f_{s_cfar})⊗VFTALL_{z}(f_{b_cfar},f_{s_cfar})}^{T} (Equation 43)

Since aliasing determiner 252 can determine an index that is a true Doppler aliasing range in a Doppler range greater than or equal to −1/(2Tr) and less than 1/(2Tr) (in other words, can perform determination such that DRₘᵢₙ=DRₜᵣᵤₑ), code demultiplexer 253 can cause the correlation value between orthogonal codes used for code multiplexing to be zero in the Doppler range greater than or equal to −1/(2Tr) and less than 1/(2Tr), thereby enabling demultiplexing processing in which interference between code-multiplexed signals is suppressed.

Here, DeMul_{z}^{ncm}(f_{b_cfar}, f_{s_cfar}) is an output (for example, a code demultiplexing result) in which a code-multiplexed signal is code-demultiplexed by using orthogonal code Code_{ncm} for the outputs of distance index f_{b_cfar} and Doppler frequency index f_{s_cfar} of Doppler analyzer 209a in z-th antenna system processor 201. Note that, z=1, . . . , Na, and ncm=1, . . . , N_{CM}.

Note that, code demultiplexer 253 may use following equation 44 instead of equation 43.

[58]

DeMUL_{z}^{ncm}(f_{b_cfar},f_{s_cfar})=(β(DRₘᵢₙ)⊗Code_{ncm})*●{α(f_{s_cfar})⊗VFTALL_{z}(f_{b_cfar},f_{s_cfar})}^{T} (Equation 44)

In equation 44, the term

[59]

β(DR)⊗Code_{ncm}

(where DR=DRₘᵢₙ in equation 44) does not depend on index (for example, Doppler frequency index) fₛ of a Doppler component, and thus, it is possible to reduce the arithmetic amount in code demultiplexer 253, for example, by pre-tabulation.

Through the code demultiplexing processing as described above, radar apparatus 10a can obtain a signal separated from a signal code-multiplexed and transmitted by orthogonal code Code_{ncm} applied to ncm-th transmission antenna Tx #ncm based on a result of aliasing determination on the assumption up to a Doppler range ±1/(2×Tr) that is Loc times a Doppler range ±1/(2Loc×Tr), in which no aliasing in Doppler analyzer 209a occurs, in aliasing determiner 252.

Further, radar apparatus 10a performs, for example, Doppler phase correction including Doppler aliasing (for example, processing based on aliasing phase correction vector β(DRₘᵢₙ)) on the output of Doppler analyzer 209a for each code element during code demultiplexing processing. For this reason, mutual interference between code-multiplexed signals can be, for example, reduced to approximately a noise level. In other words, radar apparatus 10a can reduce inter-code interference and suppress an effect on deterioration of detection performance of radar apparatus 10a.

An operation example of code demultiplexer 253 has been described above.

In FIG. 7, direction estimator 211 performs target direction estimation processing based on code demultiplexing result DeMul_{z}^{ncm}(f_{b_cfar}, f_{s_cfar}) for the outputs of Doppler analyzer 209a corresponding to distance indexes f_{b_cfar} and Doppler frequency indexes f_{s_cfar} inputted from code demultiplexer 253.

For example, direction estimator 211 generates virtual reception array correlation vector h(f_{b_cfar}, f_{s_cfar}) indicated by equation 45 and performs direction estimation processing.

Virtual reception array correlation vector h(f_{b_cfar}, f_{s_cfar}) includes Nt×Na elements which are the product of number Nt of transmission antennas and number Na of reception antennas. Virtual reception array correlation vector h(f_{b_cfar}, f_{s_cfar}) is used for processing of performing direction estimation based on the phase difference between reception antennas 202 on a reflected wave signal from a target. Here, z=1, . . . , Na.

$$h ( {f}_{b \_ cfar} , {f}_{s \_ comp \_ cfar} ) = [ \begin{matrix}{{DeMUL}_{1}}^{1} ( {f}_{b \_ cfar} , {f}_{s \_ cfar} ) \\ {{DeMUL}_{2}}^{1} ( {f}_{b \_ cfar} , {f}_{s \_ cfar} ) \\ ⋮ \\ {{DeMUL}_{Na}}^{1} ( {f}_{b \_ cfar} , {f}_{s \_ cfar} ) \\ {{DeMUL}_{1}}^{2} ( {f}_{b \_ cfar} , {f}_{s \_ cfar} ) \\ {{DeMUL}_{2}}^{2} ( {f}_{b \_ cfar} , {f}_{s \_ cfar} ) \\ ⋮ \\ {{DeMUL}_{Na}}^{2} ( {f}_{b \_ cfar} , {f}_{s \_ cfar} ) \\ ⋮ \\ {{DeMUL}_{1}}^{{N}_{CM}} ( {f}_{b \_ cfar} , {f}_{s \_ cfar} ) \\ {{DeMUL}_{S}}^{{N}_{CM}} ( {f}_{b \_ cfar} , {f}_{s \_ cfar} ) \\ ⋮ \\ {{DeMUL}_{Na}}^{{N}_{CM}} ( {f}_{b \_ cfar} , {f}_{s \_ cfar} )\end{matrix} ] \qquad ( Equation 45 )$$

For example, direction estimator 211 calculates a spatial profile, with azimuth direction θ in direction estimation evaluation function value P_{H}(θ, f_{b_cfar}, f_{s_cfar}) being variable within a defined angular range. Direction estimator 211 extracts a predetermined number of local maximum peaks in the calculated spatial profile in descending order and outputs the azimuth direction of each local maximum peak as a direction-of-arrival estimation value (for example, positioning output).

Note that, there are various methods for direction estimation evaluation function value P_{H}(θ, f_{b_cfar}, f_{s_cfar}) depending on direction-of-arrival estimation algorithms. For example, an estimation method using an array antenna disclosed in NPL 2 may be used.

For example, in a case where Nt×Na virtual reception arrays are linearly disposed at equal intervals d_{H}, a beamformer method can be indicated as in following equations 46 and 47.

$${P}_{H} ( {θ}_{u} , {f}_{b \_ cfar} , {f}_{s \_ cfar} ) = {\vert {a}^{H} ( {θ}_{u} ) {D}_{cal} h ( {f}_{b \_ cfar} , {f}_{s \_ cfar} ) \vert}^{2} ; \qquad ( Equation 46 )$$

$$a ( {θ}_{u} ) = [ \begin{matrix}1 \\ exp \{ - {j 2 π d}_{H} {sinθ}_{u} / λ \\ ⋮ \\ exp \{ - j 2 π ( {N}_{t} {N}_{a} - 1 ) {d}_{H} {sinθ}_{u} / λ\end{matrix} ] . \qquad ( Equation 47 )$$

In addition, techniques such as Capon and MUSIC are also applicable in the same manner.

Here, character superscript H is a Hermitian transpose operator. Further, a(θᵤ) represents the direction vector of a virtual reception array with respect to an arrival wave in azimuth direction θᵤ. Here, direction vector a(θᵤ) is an (Nt−Na)-dimensional column vector including, as elements, complex responses of the virtual reception array in a case where a radar reflected wave arrives in azimuth direction θ. Further, the complex responses of the virtual reception array represent phase differences resulting from path differences geometrically optically calculated based on the disposition of virtual reception antennas and the directions of radar reflected waves.

Further, azimuth direction θᵤ is a vector obtained by changing θₘᵢₙ to θₘₐₓ within the azimuth range, in which the direction-of-arrival estimation is performed, at azimuth interval D_{Step}. For example, θᵤ may be configured as follows.

θᵤ=θₘᵢₙ+uD_{Step},u=0, . . . ,NU

NU=floor[(θₘₐₓ−θₘᵢₙ)/D_{Step}],

where floor(x) is a function that returns the maximum integer value that does not exceed real number x.

Further, in equation 46, D_{cal} is an (Nt×Na)-dimensional matrix including an array correction coefficient for correcting phase deviations and amplitude deviations between transmission array antennas and between reception array antennas and a coefficient for reducing the influence of inter-element coupling between antennas. In a case where the coupling between antennas in the virtual reception array can be ignored, D_{cal} becomes a diagonal matrix and includes, as diagonal components, the array correction coefficient for correcting phase deviations and amplitude deviations between transmission array antennas and between reception array antennas.

For example, direction estimator 211 may output a direction estimation result and may further output, as a positioning result, distance information, which is based on distance index f_{b_cfar}, and Doppler velocity information of a target, which is based on Doppler frequency index f_{b_cfar} of the target and determination result DRₘᵢₙ in aliasing determiner 252.

For example, the calculation of distance information of a target in direction estimator 211 may be the same as that in Embodiment 1.

Further, direction estimator 211 may calculate Doppler velocity information of a target as follows and output the calculated Doppler velocity information.

For example, direction estimator 211 may calculate, based on Doppler frequency index f_{s_cfar} and DRₘᵢₙ that is a determination result in aliasing determiner 252, Doppler frequency index f_{es_cfar} in accordance with equation 48.

[63]

f_{es_cfar}=f_{s_cfar}+DRₘᵢₙ×Ncode (Equation 48).

Doppler frequency index f_{es_cfar} corresponds to, for example, the Doppler index in a case where the FFT size of Doppler analyzer 209a is extended to Loc×Ncode. Hereinafter, f_{es_cfar} is referred to as “extended Doppler frequency index”.

Note that, the Doppler range is assumed to be up to ±1/(2×Tr), and the range of extended Doppler frequency index f_{es_cfar} corresponding to the above Doppler range is −Loc×Ncode/2≤f_{es_cfar}<Loc×Ncode/2. Accordingly, as a result of calculation of equation 48, f_{es_cfar} Loc×Ncode is f_{es_cfar} in a case where f_{es_cfar}<−Loc×Ncode/2, and further f_{es_cfar}−Loc×Ncode is f_{es_cfar} in a case where f_{es_cfar}≥Loc×Ncode/2.

Further, for example, direction estimator 211 may output Doppler velocity information v_{d} of a target, which is detected in the below-described way, by using extended Doppler frequency index f_{es_cfar} and distance index f_{b_cfar}.

For example, in radar apparatus 10a, a reception signal of a signal equivalent to a radar transmission signal for which center frequency fc of a chirp signal is changed by Δt×fstep for each average transmission period Tr can be obtained, and thus, center frequency fc of a chirp signal changes for each average transmission period Tr even in a case where the relative velocity of a target is zero. Accordingly, a reception signal in radar apparatus 10a includes phase rotation associated with a change in the center frequency of a chirp signal for each average transmission period Tr.

Center frequency fc of a chirp signal in m-th transmission period Tr with respect to target distance R_{target} changes by (m−1)Δt×fstep when the center frequency in the transmission period for the first chirp signal is used as a reference, and phase rotation amount Δη(m, R_{target}) associated therewith is indicated by equation 49 in view of reflected-wave arrival time (2R_{target}/Co) from target distance R_{target} Note that, following equation 49 represents the relative phase rotation amount in a case where the reception phase of the chirp signal in the first transmission period is used as a reference. C₀ indicates the velocity of light.

$$Δη ( m , {R}_{target} ) = 2 π ( m - 1 ) Δ t \times {f}_{step} \times ( \frac{2 {R}_{target}}{{C}_{0}} ) \qquad ( Equation 49 )$$

Accordingly, the output of each of Loc Doppler analyzers 209a of radar apparatus 10a includes phase rotation associated with a change in the center frequency of a chirp signal for each average transmission period Tr.

Accordingly, as indicated by equation 50, direction estimator 211 calculates Doppler velocity information v_{d} (f_{es_cfar}, f_{b_cfar}) based on a conversion equation in view of Δt×fstep that is the amount of a change in center frequency fc of a chirp signal for each average transmission period Tr.

$${v}_{d} ( {f}_{b \_ cfar} , {f}_{es \_ cfar} ) = \frac{{c}_{0}}{2 {f}_{0}} ( \frac{{f}_{es \_ cfar}}{Loc \times {N}_{code} \times {T}_{r}} - Δ t \times {f}_{step} \times \frac{2 R ( {f}_{b \_ cfar} )}{{T}_{r} \times {C}_{0}} ) \qquad ( Equation 50 )$$

The first term in equation 50 is a relative Doppler velocity component represented by Doppler frequency f_{es_cfar}. The second term in equation 50 is a Doppler velocity component that is generated by changing center frequency fc of a chirp signal by Δt×fstep for each average transmission period Tr. For example, as indicated by equation 50, direction estimator 211 can calculate true relative Doppler velocity v_{d} (f_{es_cfar}, f_{b_cfar}) of a target by removing the Doppler component in the second term from the first term. Here, R(f_{b_cfar}) is distance information R(f_{b_cfar}) using beat frequency index f_{b_cfar} and is calculated in accordance with equation 4.

Note that, the Doppler range of a target is assumed to be up to ±1/(2×Tr), and thus, in a case where v_{d} is v_{d}<−C₀/(4f₀Tr), direction estimator 211 may output detected Doppler velocity information v_{d} of a target in accordance with following equation 51.

$${v}_{d} ( {f}_{b \_ cfar} , {f}_{es \_ cfar} ) = \frac{{c}_{0}}{2 {f}_{0}} ( \frac{{f}_{es \_ cfar} + Loc \times {N}_{code}}{Loc \times {N}_{code} \times {T}_{r}} - Δ t \times {f}_{step} \times \frac{2 R ( {f}_{b \_ cfar} )}{{T}_{r} \times {C}_{0}} ) \qquad ( Equation 51 )$$

Further, in the same manner, the Doppler range of a target is assumed to be up to ±1/(2×Tr), and thus, in a case where v_{d} is v_{d}>C₀/(4f₀Tr), direction estimator 211 may output detected Doppler velocity information v_{d} of a target in accordance with following equation 52.

$${v}_{d} ( {f}_{b \_ cfar} , {f}_{es \_ cfar} ) = \frac{{c}_{0}}{2 {f}_{0}} ( \frac{{f}_{es \_ cfar} - Loc \times {N}_{code}}{Loc \times {N}_{code} \times {T}_{r}} - Δ t \times {f}_{step} \times \frac{2 R ( {f}_{b \_ cfar} )}{{T}_{r} \times {C}_{0}} ) \qquad ( Equation 52 )$$

As described above, in the present embodiment, in the same manner as in Embodiment 1, radar transmitter 100a transmits the same chirp signal in Ncf transmission periods, and performs the transmission by changing the transmission signal start timing by Δt for each time interval of average transmission period Tr. Further, in Ncf transmission periods following the Ncf transmission periods described above, radar transmitter 100a transmits a chirp signal for which the center frequency is changed by Δf=Δt×fstep×Nfc.

Thus, for example, radar receiver 200a can obtain, with respect to reception data to be subjected to AD sampling within a range gate, the same reception signal as in a case where the center frequency of a chirp signal is changed by Δt×fstep for each transmission period and the transmission is performed.

Accordingly, for example, in the same manner as in Embodiment 1, the present embodiment makes it possible to reduce the number of times of control for variably configuring chirp signals for transmission of chirp signals with different center frequencies and to reduce the amount of memory for storing parameters when generating a chirp signal for each transmission period. Further, for example, the section and timing for AD sampling in radar receiver 200a may be constant regardless of transmission periods of chirp signals. Thus, processing in radar receiver 200a can be simplified.

Further, for example, by reducing the number of times of control for varying chirp signals, the present embodiment makes it possible to reduce the generation of frequency errors or phase errors when varying chirp signals and to reduce the influence of deterioration on distance accuracy or Doppler accuracy.

Further, in the present embodiment, even in a case where the transmission signal start timing and center frequency of a chirp signal described above are controlled, radar apparatus 10a (for example, MIMO radar) can apply code multiplex transmission. Further, radar apparatus 10a can perform Doppler aliasing determination by using the output (in other words, a reception signal) of Doppler analyzer 209a for each code element of a code-multiplexed signal, and an unused orthogonal code. For example, radar apparatus 10a is capable of configuring a Doppler range detectable without ambiguity to ±1/(Tr) and suppressing mutual interference between code-multiplexed signals to approximately a noise level by performing Doppler phase correction including aliasing during code demultiplexing. Thus, the present embodiment makes it possible to suppress deterioration of radar detection performance and perform code multiplex transmission by a MIMO radar.

Further, in the present embodiment, in a case where frequency change width BW_{fcval} (=(the maximum chirp signal center frequency)−(the minimum chirp signal center frequency)) for the center frequency of chirp signals, which is varied each time the chirp signals are repeatedly transmitted, is greater than individual chirp frequency sweep bandwidth BW_{chirp} (for example, BW_{fcval}>BW_{chirp}), distance resolution ΔR2 is given by equation 3. Thus, for example, as BW_{fcval} is greater, the distance resolution can be enhanced without depending on individual chirp frequency sweep bandwidth BW_{chirp} (for example, even when BW_{chirp} is reduced), and thus, it is possible to shorten average transmission period Tr for chirp signals. Further, given the relationship in equation 2, for example, shortening average transmission period Tr for chirp signals attains an effect capable of increasing maximum Doppler velocity f_{dmax} to extend the Doppler detection range, and makes it possible to further extend a Doppler range detectable without ambiguity in code multiplex transmission.

Note that, in the present embodiment, the configuration value of Ncf that is a parameter to be used by radar transmission signal generator 101 may be an integer multiple of number Loc of code elements (or code length Loc of a code sequence). Since the center frequency of a chirp signal is not varied within a code transmission period thereby, frequency errors or phase errors are less likely to occur when a chirp signal is varied, and it is possible to maintain the orthogonality between code-multiplexed signals. Note that, change Δf in a center frequency may be arbitrarily configured. Further, amount Δt of a transmission delay=0 may be configured.

Further, the code multiplexing method described above may not be applied to the code multiplexing method in radar apparatus 10a. For example, of N_{allcode} orthogonal codes included in a code sequence with code length Loc, code generator 151 may configure code multiplexing number N_{CM} to be equal to number N_{allcode} of orthogonal codes. Note that, the configuration value of Ncf may be an integer multiple of number Loc of code elements (or code length Loc of a code sequence). Further, change Δf in a center frequency may be arbitrarily configured. Further, amount Δt of a transmission delay=0 may be configured. Further, for example, phase rotator 152 may perform code multiplexing by using all of N_{allcode} orthogonal codes included in a code sequence with code length Loc. In this case, aliasing determination by aliasing determiner 252 of radar apparatus 10a is not applied, and thus, the Doppler frequency range becomes ±1/(2Loc×Tr).

Here, in a case where frequency change width BW_{fcval} (=(the maximum chirp signal center frequency)−(the minimum chirp signal center frequency)) for the center frequency of chirp signals, which is varied each time the chirp signals are repeatedly transmitted, is greater than individual chirp frequency sweep bandwidth BW_{chirp} (for example, BW_{fcval}>BW_{chirp}), distance resolution ΔR2 is given by equation 3. Thus, as BW_{fcval} is greater, the distance resolution can be enhanced without depending on individual chirp frequency sweep bandwidth BW_{chirp} (for example, even in a case where BW_{chirp} is small), and it is possible to shorten average transmission period Tr for chirp signals. Accordingly, even in a case where the code multiplexing method described above is not applied, maximum Doppler velocity f_{dmax} is increased and the Doppler detection range can be extended given the relationship in equation 2.

### Embodiment 3

In Embodiments 1 and 2, a case where the radar transmitter varies the transmission signal start timing by Δt for each time interval of average transmission period Tr and outputs a chirp signal for which the center frequency is changed by Δf=Δt×fstep×Nfc for each of Ncf transmission periods has been described as an example.

In the present embodiment, for example, a case where the transmission start timing for a chirp signal and a change in the center frequency of the chirp signal are controlled based on the code length (for example, Loc) of an orthogonal code to be used in code multiplex transmission will be described.

[Configuration of Radar Apparatus]

The radar apparatus according to the present embodiment may be the same as that in Embodiment 2 (for example, radar apparatus 10a illustrated in FIG. 7).

For example, radar apparatus 10a generates a reception signal equivalent to that in a case where transmission is performed by changing the center frequency of a chirp signal by Δt×fstep for each of Loc transmission periods (Loc×Tr) (hereinafter referred to as “code transmission period”), the number of which corresponds to code length Loc of one orthogonal code to be used in code multiplex transmission.

In this case, the configuration value of Ncf that is a parameter to be used by radar transmission signal generator 101 may be configured to an integer multiple of number Loc of code elements. For example, the configuration value of Ncf may be configured to Ncf=Loc×Nroc. Here, Nroc≥2.

[Configuration of Radar Transmitter 100a]

In radar transmitter 100a of radar apparatus 10a according to the present embodiment, the operations of transmission timing controller 102 and transmission frequency controller 103 differ from those in Embodiments 1 and 2 and the operations of other components may be the same as those in Embodiment 1 or 2.

Transmission timing controller 102 may control, for example, a transmission timing for a chirp signal. Transmission timing controller 102 may output, for example, a control signal related to the transmission timing to modulated signal generator 104.

Further, transmission frequency controller 103 may control, for example, a sweep frequency of a chirp signal. Transmission frequency controller 103 may output, for example, a control signal related to the sweep frequency to modulated signal generator 104.

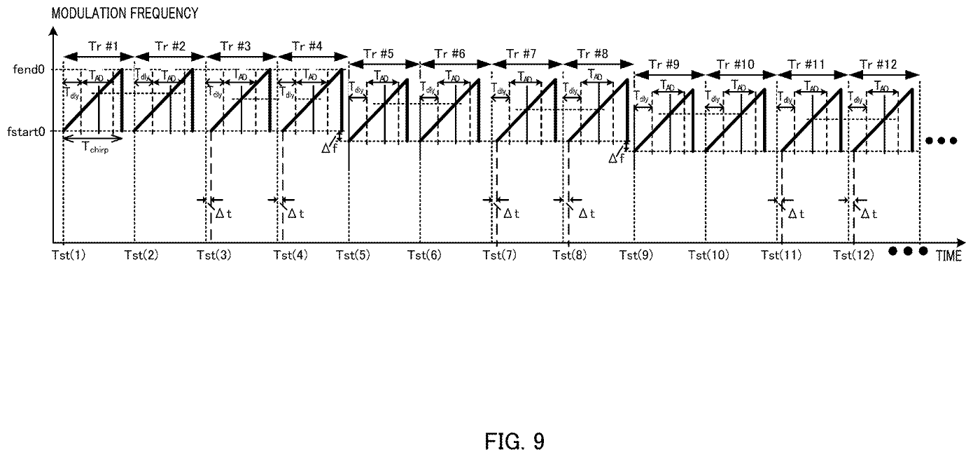

FIG. 9 illustrates examples of the radar transmission signal generated by radar transmission signal generator 101. In FIG. 9, as an example, the radar transmission signal outputted from radar transmission signal generator 101 indicates a case where the modulation frequency of a chirp signal gradually increases (up-chirp), but the present disclosure is not limited thereto. For example, the radar transmission signal outputted from radar transmission signal generator 101 may indicate a case where the modulation frequency of a chirp signal gradually decreases (down-chirp), in which case the same effect as with the up-chirp can be obtained.

Note that, although a case where Loc=2 and Nroc=2 (case of Ncf=4) will be described in FIG. 9 as an example, Loc, Nroc, and Ncf are not limited to these values.

For example, transmission timing controller 102 may perform the following operation in chirp signal transmission timing control.

For example, transmission timing controller 102 may control modulated signal generator 104 such that chirp transmission signal start timing Tst(1) in first transmission period Tr #1 is Tst(1)=T0. Further, transmission timing controller 102 may cause, for example, chirp transmission signal start timing Tst(2) in second transmission period Tr #2 to be configured to Tst(2)=T0+Tr. Thereafter, in the same manner, transmission timing controller 102 may cause chirp transmission signal start timing Tst(Loc) in Loc-th transmission period to be configured to Tst (Loc)=T0+(Loc−1)Tr (for example, Loc=2 in FIG. 9).

For example, in the code transmission period next to the first code transmission period, transmission timing controller 102 may cause chirp transmission signal start timing Tst(Loc+1) in the Loc+1-th transmission period to be configured to Tst(Loc+1)=T0+Loc×Tr+Δt. Further, for example, transmission timing controller 102 may cause chirp transmission signal start timing Tst(Loc+2) in the Loc+2-th transmission period to be configured to Tst(Loc+2)=T0+(Loc+2)×Tr+Δt. In the same manner, chirp transmission signal start timing Tst(2Loc) in the 2Loc-th transmission period may be configured to Tst(2Loc)=T0+(2Loc−1)Tr+Δt (for example, Loc=2 in FIG. 9).

Thereafter, transmission timing controller 102 causes the transmission signal start timing to be changed by Δt for each time interval of (Tr×Loc) in the same manner until the Ncf-th (Ncf=4 in FIG. 9) transmission period. For example, transmission timing controller 102 causes chirp transmission signal start timing Tst(Loc×Nroc) in the Ncf-th (=Loc×Nroc) transmission period to be configured to Tst(Loc×Nroc)=T0+(Loc×Nroc−1)×Tr+(Nroc−1)Δt.

Further, transmission timing controller 102 may cause, for example, Tst(Ncf+1)=T0+Ncf×Tr to be configured in Ncf+1-th transmission period Tr #Ncf+1. In other words, transmission timing controller 102 may cause the transmission signal start timing in the Nc+1-th transmission period to match the timing of the time interval in average transmission period Tr. For example, transmission timing controller 102 may cause the chirp transmission signal start timing in the m-th transmission period to be configured to Tst(m)=T0+(m−1)×Tr+mod(floor((m−1)/Loc), Nroc)×Δt. Here, m=1, . . . , Nc. Further, mod(x,y) is a modulus operator and is a function that outputs a remainder after x is divided by y.

As described above, in Nroc transmission periods where Nroc is an integer multiple of code length Loc, for example, transmission timing controller 102 controls modulated signal generator 104 such that the transmission period for a chirp signal until the (Nroc−1)×Loc-th chirp signal (Tr #2 in the case of FIG. 9) is configured to Tr+Δt, the transmission period for the Ncf (=Loc×Nroc)-th chirp signal (Tr #4 in the case of FIG. 9) is configured to Tr−(Ncf−1)×Δt, the transmission periods different from those described above (Tr #1 and Tr #3 in the case of FIG. 9) are configured to Tr, and the chirp signals are transmitted. Accordingly, the average transmission period of Ncf chirp signals is “Tr”. Thereafter, in the same manner, transmission timing controller 102 may cause the transmission period for the m-th chirp signal to be configured to “Tr+Δt” in a case where m is not an integer multiple of Ncf and is an integer multiple of Loc, to “Tr−(Ncf−1)×Δt” in a case where m is an integer multiple of Ncf, and to “Tr” in a case where m differs from an integer multiple of Loc.

In other words, transmission timing controller 102 causes a transmission delay for a chirp signal to be configured (for example, changed) for each of a predetermined number (for example, Ncf) of transmission periods. In the present embodiment, a change in a transmission delay for a chirp signal within Ncf transmission periods may vary for each of the transmission periods corresponding to code length Loc. In other words, a transmission delay for a chirp signal may not change within the transmission periods corresponding to code length Loc. Further, for example, a transmission delay for a chirp signal may change in a round in Ncf transmission periods.

Transmission timing controller 102 may repeat the chirp signal transmission timing control as described above Nc times, for example. Here, m=1, . . . , Nc.

Further, for example, transmission frequency controller 103 may perform the following operation in chirp signal sweep frequency control.

For example, in first transmission period Tr #1, transmission frequency controller 103 controls modulated signal generator 104 such that the chirp signal sweep start frequency, sweep end frequency within chirp sweep time T_{chirp}, and sweep center frequency fc(1) are configured to fstart(1)=fstart0, fend(1)=fend0, and fc(1)=f0=|fend0−fstart0|/2, respectively. In the same manner, for example, in second transmission period Tr #2, transmission frequency controller 103 controls modulated signal generator 104 such that the chirp signal sweep start frequency, sweep end frequency, and frequency sweep center frequency fc(2) are configured to fstart(2)=fstart0, fend(2)=fend0, and fc(2)=f0, respectively. Thereafter, transmission frequency controller 103 causes the chirp signal sweep start frequencies, sweep end frequencies, and frequency sweep center frequencies to be configured to constant values in the same manner until the Ncf-th (Ncf=4 in FIG. 9) transmission period, for example.

Further, in Ncf+1-th transmission period Tr #Ncf+1, for example, transmission frequency controller 103 causes the chirp signal sweep start frequency, sweep end frequency, and frequency sweep center frequency to be changed by Δf, respectively. For example, in the Ncf+1-th transmission period (Tr #5 in the case of FIG. 9), transmission frequency controller 103 may cause the chirp signal sweep start frequency, sweep end frequency, and frequency sweep center frequency fc(Ncf+1) to be configured to fstart(Ncf+1)=fstart0+Δf, fend(Ncf+1)=fend0+Δf, and fc(Ncf+1)=f0+Δf, respectively. Note that, the example in FIG. 9 illustrates the case of Δf<0. Thereafter, transmission frequency controller 103 causes the chirp signal sweep start frequencies, sweep end frequencies, and frequency sweep center frequencies to be configured to constant values in the same manner until the 2×Ncf-th transmission period (Tr #8 in FIG. 9), for example.

Further, for example, in the 2×Ncf+1-th transmission period (Tr #9 in FIG. 9), transmission frequency controller 103 causes the chirp signal sweep start frequency, sweep end frequency, and frequency sweep center frequency to be changed by Δf, respectively. For example, transmission frequency controller 103 causes the center frequency of the chirp signal in the 2×Ncf+1-th transmission period to be configured to fc(2×Ncf+1)=f0+2Δf. Thereafter, transmission frequency controller 103 causes the center frequencies of chirp signals to be configured to be constant (f0+2Δf) in the same manner until the 3×Ncf-th transmission period (Tr #12 in the case of FIG. 9).

Further, for example, in the 3×Ncf+1-th transmission period, transmission frequency controller 103 causes the chirp signal sweep start frequency, sweep end frequency, and frequency sweep center frequency to be changed by Δf, respectively. For example, in the 3×Ncf+1 transmission period, transmission frequency controller 103 causes the chirp signal sweep start frequency, sweep end frequency, and frequency sweep center frequency to be configured to fstart(3×Ncf+1)=fstart0+34f, fend(3×Ncf+1)=fend0+3M, and fc(3×Ncf+1)=f0+3Δf, respectively.

Thereafter, in the same manner, in the m-th transmission period, for example, transmission frequency controller 103 may cause the chirp signal sweep start frequency, sweep end frequency, and frequency sweep center frequency to be configured to fstart(m)=fstart0+floor((m−1)/Ncf)×Δf, fend(m)=fend0+floor((m−1)/Ncf)×Δf, and fc(m)=f0+floor((m−1)/Ncf×Δf, respectively.

As described above, transmission frequency controller 103 controls modulated signal generator 104 such that frequency sweep bandwidth Bs=|fend0−fstart0| is constant, sweep frequency change rate (frequency sweep time change rate) fvr=|fend0−fstart0|/Tchirp is constant, and the center frequency of a chirp signal is changed with a step of Δf for each (Ncf×Tr) period. In other words, transmission frequency controller 103 causes the center frequency of a chirp signal to be changed for each of Ncf (for example, an integer multiple of code length Loc) transmission periods.

For example, transmission frequency controller 103 may repeat the chirp signal transmission frequency control as described above Nc times. Here, m=1, . . . , Nc. Further, floor(x) is an operator for outputting the maximum integer that does not exceed real number x.

Note that, Δt and Δf may be configured, for example, based on the relationship as follows (the reason will be described later).

|Δf|=|Δt×fstep×Ncf/Loc|=|Δt×fstep×Nroc|

Here, fstep is, for example, a chirp signal sweep frequency time change rate [Hz/s].

Further, Δt may be configured to an integer multiple of AD sampling interval Ts (Δt=Ndts×Ts). This is preferable since digital time control is facilitated thereby. For example, in a case where Δt is configured to an integer multiple of AD sampling interval Ts, |Δf|=|fstep×Δt×Nroc|=|f_{A}×Ndts×Nroc| may be configured. Here, f_{A} is a chirp signal sweep frequency change rate at AD sampling interval Ts, and f_{A}=fstep×Ts.

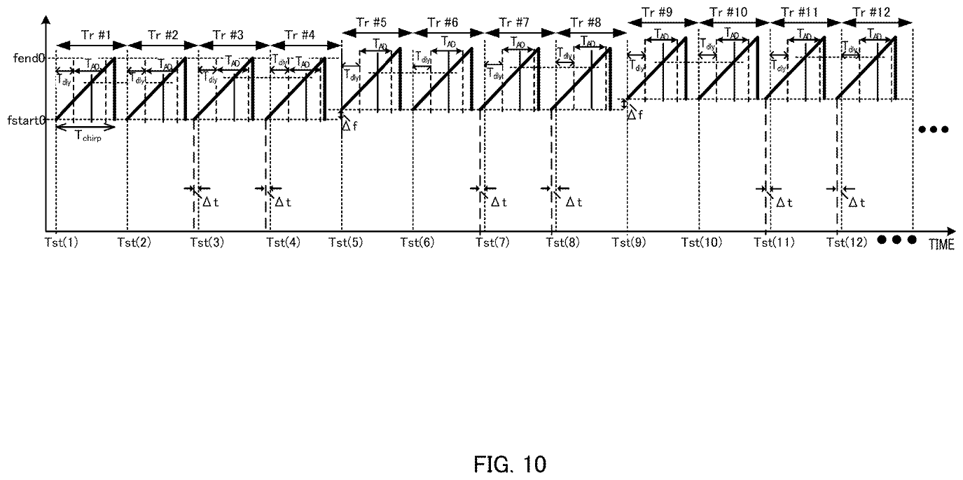

Further, for example, when the chirp signal frequency sweep is fstart0<fend0 (up-chirp), Δf<0 may be configured in a case where Δt>0 (corresponding to a case where the chirp signal transmission time is delayed) (for example, FIG. 9). Further, for example, when the chirp signal frequency sweep is fstart0<fend0 (up-chirp), Δf>0 may be configured in a case where Δt<0 (corresponding to a case where the chirp signal transmission time is accelerated) (the example illustrated in FIG. 10; Ncf=4 and Loc=2 in FIG. 10).

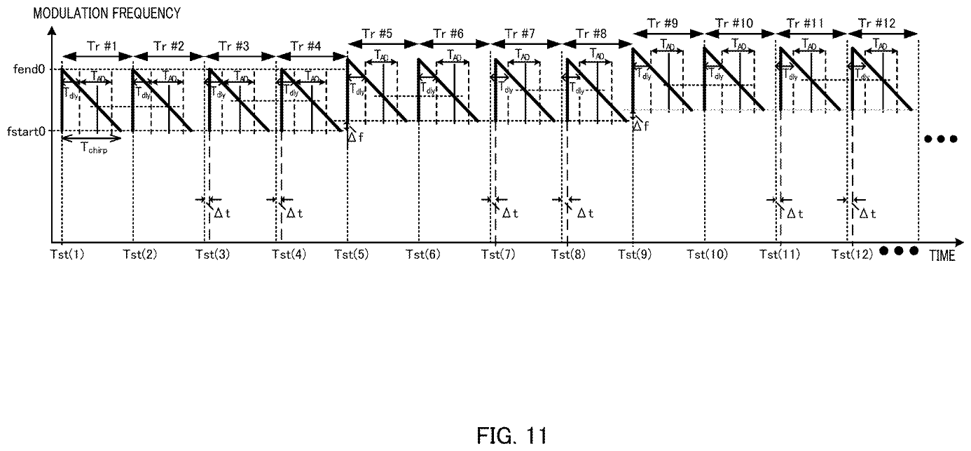

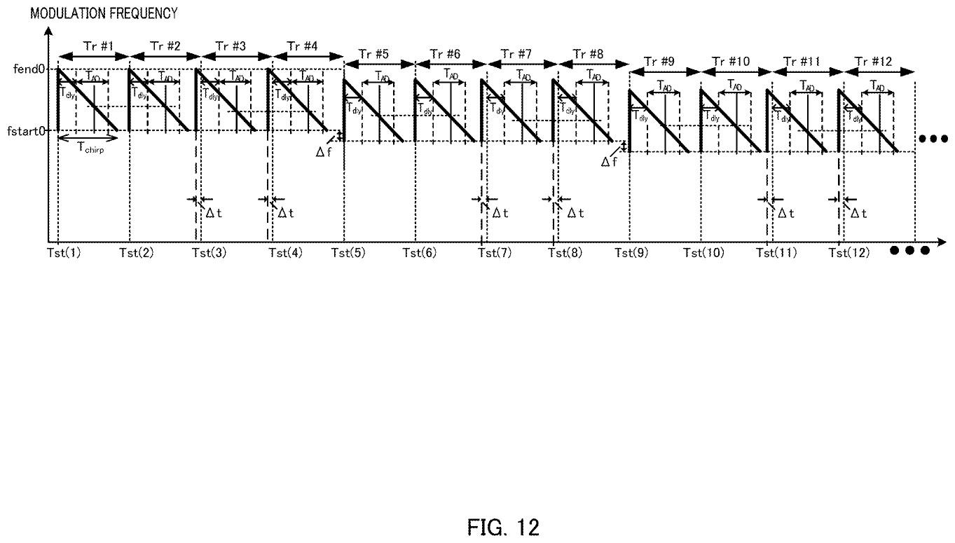

Further, for example, when the chirp signal frequency sweep is fstart0>fend0 (down-chirp), Δf>0 may be configured in a case where Δt>0 (the example illustrated in FIG. 11; Ncf=4 and Loc=2 in FIG. 11). Further, for example, when the chirp signal frequency sweep is fstart0>fend0 (down-chirp), Δf<0 may be configured in a case where Δt<0 (the example illustrated in FIG. 12; Ncf=4 and Loc=2 in FIG. 12).

As described above, change Δf in a center frequency may be configured based on amount Δt of a transmission delay.

For example, VCO 105 may output a chirp signal based on the voltage output of modulated signal generator 104. For example, VCO 105 may output a chirp signal, in which frequency sweep bandwidth Bw=|fend0−fstart0|, frequency sweep time change rate fstep, and frequency sweep center frequency f0 are configured, by varying the transmission signal start timing by Δt for each time interval of average transmission period Tr from the first to the Ncf-th transmission periods.

Further, for example, VCO 105 may output, from the Ncf+1 to the 2×Ncf-th transmission periods, chirp signals, in which frequency sweep bandwidth Bw=|fend0−fstart0|, frequency sweep time change rate fstep, and frequency sweep center frequency f0+Δf are configured, at transmission signal start timings with respect to periods for each time interval of average transmission period Tr, which are the same as in the first to the Ncf-th transmission periods, respectively.

Thereafter, in the same manner, the chirp signal sweep start frequency, sweep end frequency, and frequency sweep center frequency in the m-th transmission period may be configured to be fstart (m)=fstart0+floor((m−1)/Ncf×Δf, fend(m)=fend0+floor((m−1)/Ncf×Δf, and fc(m)=f0+floor((m−1)/Ncf)×Δf, respectively. Further, the transmission period for the m-th chirp signal may be configured to Tr+Δt in a case where m is not an integer multiple of Ncf and is an integer multiple of Loc, to Tr−(Ncf−1)×Δt in a case where m is an integer multiple of Ncf, and to Tr in a case where m is not an integer multiple of Loc.

Radar transmitter 100a may repeat the chirp signal transmission as described above Nc times. Here, m=1, . . . , Nc.

A configuration example of radar transmitter 100a has been described above.

[Configuration of Radar Receiver 200a]

With respect to radar receiver 200a of radar apparatus 10a according to the present embodiment, the operation of AD converter 207 in antenna system processor 201 is the same as that in Embodiments 1 and 2, but the transmission and reception signals are different, and thus, the different parts will be described below. The operations of other components may be the same as those in Embodiment 1 or 2.

In signal processor 206, AD converter 207 converts a signal (for example, a beat signal) outputted from each reception radio 203 into discretely sampled data. AD converter 207 may configure duration (range gate) T_{AD}, in which AD sampling is performed for each average transmission period Tr, for Nc chirp signals to be transmitted, for example.

Hereinafter, a chirp signal within a range gate in AD converter 207 will be described.

For example, the start time of the range gate in the m-th transmission period is configured to TstAD(m)=T0+(m−1)×Tr+Tdly and the end time of the range gate is configured to TendAD(m)=T0+(m−1)×Tr+Tdly+Ts×Ndata. Here, Ndata represents the number of AD samples within the range gate. Note that, in a case where respective modulation frequency time change rates fstep of Nc chirp signals to be transmitted are the same, frequency-modulated bandwidths Bw=fstep×T_{AD} within respective range gates T_{AD} may be the same. In other words, in each transmission period, a section in which AD conversion is performed (for example, T_{AD}) and a timing at which AD conversion is started (for example, after Tdly from the start timing of the transmission period) are constant in AD converter 207.

Here, for example, radar transmitter 100a outputs the same chirp signal by varying the transmission signal start timing by Δt for each time interval of (Tr×Loc) from the first to the Ncf-th transmission periods. For this reason, in data to be subjected to AD sampling within a range gate, the sweep frequency of a transmission chirp signal changes by Δt×fstep for each time interval of (Tr×Loc) in radar receiver 200a. Accordingly, within the range gate, the center frequency of a transmission chirp signal also changes by Δt×fstep for each time interval of (Tr×Loc).

For example, with respect to the center frequency of the transmission chirp signal within the range gate in the first transmission period, the center frequency of the transmission chirp signal within the range gate in the second transmission period is the same. Thereafter, the center frequency of the transmission chirp signal within the range gate in the Loc-th transmission period is the same.

Further, the center frequency of the transmission chirp signal within the range gate in the Loc+1-th transmission period, which is the code transmission period next to the first code transmission period, to the 2Loc-th transmission period changes by Δt×fstep with respect to the center frequency of the transmission chirp signal within the range gate in the first transmission period. Thereafter, with respect to the center frequency of the transmission chirp signal within the range gate in the first transmission period, the center frequency of the transmission chirp signal within the range gate changes by (Nroc−1)×Δt×fstep for each time interval of (Tr×Loc) in the same manner until the Ncf-th (=Loc×Nroc) transmission period.

Further, for example, radar transmitter 100a outputs, from the Ncf+1 to the 2×Ncf-th transmission periods, chirp signals with frequency sweep center frequency f0+Δf at transmission signal start timings with respect to periods for each time interval of average transmission period Tr, which are the same as in the first to the Ncf-th transmission periods, respectively. For this reason, with respect to the center frequency of the transmission chirp signal within the range gate in the first transmission period, the center frequency of the transmission chirp signal within the range gate in the Ncf+1-th transmission period changes by Δf in radar receiver 200a.

For example, in radar transmitter 100a, Δt and Δf may be configured by using the relationship of |Δf|=|Δt×fstep×Ncf/Loc|=|Δt×fstep×Nroc| as described above. For example, Δf=−Nroc×Δt×fstep may be configured in the case of up-chirp. Further, for example, Δf=+Nroc×Δt×fstep may be configured in the case of down-chirp.

Thereafter, for example, radar transmitter 100a outputs the Ncf+2-th to the 2×Ncf-th chirp signals by varying the transmission signal start timing by Δt for each time interval of (Tr×Loc). For this reason, in data to be subjected to AD sampling within a range gate, the sweep frequency of a transmission chirp signal changes by Δt×fstep for each time interval of (Tr×Loc) in radar receiver 200a. Accordingly, within the range gate, the center frequency of a transmission chirp signal also changes by Δt×fstep for each time interval of (Tr×Loc).

For example, with respect to the center frequency of the transmission chirp signal within the range gate in the first transmission period, the center frequency of the transmission chirp signal within the range gate in the Ncf+Loc+1-th transmission period changes by (Nroc+1)×Δt×fstep. In the same manner, with respect to the center frequency of the transmission chirp signal within the range gate in the first transmission period, the center frequency of the transmission chirp signal within the range gate in the 2Ncf+1-th transmission period changes by 2Nroc×Δt×fstep.

Thereafter, in the same manner, the center frequency of the transmission chirp signal within the range gate in the m-th transmission period changes by floor((m−1)/Loc)×Δt×fstep for each time interval of (Tr×Loc) with respect to the center frequency of the transmission chirp signal within the range gate in the first transmission period.

As described above, in radar transmitter 100a, the same chirp signal is transmitted in Ncf transmission periods, and the chirp signal is outputted by varying the transmission signal start timing by Δt for each time interval of (Tr×Loc). In other words, a transmission delay for a chirp signal changes for each time interval of (Tr×Loc) within Ncf transmission periods. Thus, for example, radar receiver 200a can obtain, as reception data to be subjected to AD sampling within a range gate, the same reception signal as in a case where the center frequency of a chirp signal is changed by Δt×fstep for each period of (Tr×Loc) and the transmission is performed.

Accordingly, for example, the present embodiment makes it possible to reduce the number of times of control for varying chirp signals and to reduce the amount of memory for storing parameters when generating a chirp signal for each transmission period in comparison with a case where chirp signals with different center frequencies are transmitted for each transmission period.

Further, for example, by reducing the number of times of control for varying chirp signals, the present embodiment makes it possible to reduce the generation of frequency errors or phase errors when varying chirp signals and to reduce the influence of deterioration on distance accuracy or Doppler accuracy.

Further, for example, the present embodiment makes it possible to obtain the same reception signal as in a case where the center frequency of a chirp signal is changed by Δt×fstep for each period of (Tr×Loc) and the transmission is performed, and therefore makes it possible to extend the frequency change width for a center frequency and to achieve a higher distance resolution.

A chirp signal within a range gate in AD converter 207 has been described above.

In radar receiver 200a according to the present embodiment, the operation of CFAR processor 210 subsequent thereto may be the same as that in Embodiment 1. Further, in radar receiver 200a, direction estimation processing using the output of code demultiplexer 253 in direction estimator 211 may also be the same as the operation in Embodiment 2.

In radar receiver 200a according to the present embodiment, for example, the operation of aliasing determiner 252, the operation of code demultiplexer 253, and conversion processing with respect to Doppler velocity information of a target in direction estimator 211 differs from those in Embodiment 2.

Hereinafter, an operation example of aliasing determiner 252, which differs from that in Embodiment 2, will be described.

For example, in radar receiver 200a, a reception signal of a signal equivalent to a radar transmission signal for which center frequency fc of a chirp signal is changed by Δt×fstep for each code transmission period (Loc×Tr) is obtained as described above. Accordingly, for example, center frequency fc of a chirp signal changes for each code transmission period (Loc×Tr) even in a case where the relative velocity of a target is zero. Accordingly, the output of each of Loc Doppler analyzers 209a of radar apparatus 10a includes phase rotation associated with a change in the center frequency of a chirp signal for each code transmission period (Loc×Tr).

For example, center frequency fc of the chirp signal in the m-th transmission period with respect to target distance R_{target} changes by floor[(m−1)/Loc]Δt×fstep when center frequency fc in the transmission period for the first chirp signal is used as a reference. Accordingly, phase rotation amount Δη(m, R_{target}) associated with the change in the center frequency is indicated by equation 53 in view of reflected-wave arrival time (2R_{target}/Co) from target distance R_{target}.

$$\begin{matrix}( Equation 53 ) & \\ Δ η ( m , {R}_{target} ) = 2 π floor ( \frac{m - 1}{Loc} ) Δ t \times {f}_{step} \times ( \frac{2 {R}_{t a r g e t}}{{C}_{0}} ) & [ 68 ]\end{matrix}$$

Note that, equation 53 indicates the relative phase rotation amount in a case where the reception phase of the chirp signal in the first transmission period is used as a reference. C₀ indicates the velocity of light.

Since code transmission periods (Loc×Tr) in which center frequencies fc of chirp signals are changed by Δt×fstep are caused to match periods for switching among Doppler analyzers 209a for each code element, each of Loc Doppler analyzers 209a performs Doppler analysis including phase rotation indicated by equation 53.

Accordingly, there is a difference that when Doppler phase rotation due to a time difference in Doppler analysis among Loc Doppler analyzers 209a is corrected, aliasing determiner 252 performs phase correction by using, in addition to Doppler phase correlation vector α(f_{s_cfar}) in equation 25, center frequency change correction vector ξ(f_{b_cfar}) indicated by equation 54. For example, aliasing determiner 252 uses, instead of α(f_{s_cfar}),

[69]

ξ(f_{s_cfar})⊗α(f_{s_cfar}).

Note that, given equation 4, R(f_{b_cfar}) is distance information R(f_{b_cfar}) using beat frequency index f_{b_cfar}.

$$\begin{matrix}( Equation 54 ) & \\ ξ ( {f}_{b \_ cfar} ) = [ 1 , exp \{ \frac{j 2 π Δ t {f}_{step} 2 R ( {f}_{b} )}{{C}_{0} L o c} \} , \\ exp \{ \frac{j 2 π Δ t {f}_{step} 2 R ( {f}_{b} ) \times 2}{{C}_{0} L o c} \} , … , exp \{ \frac{j 2 π Δ t {f}_{step} 2 R ( {f}_{b} ) \times ( Loc - 1 )}{{C}_{0} L o c} \} ] & [ 70 ]\end{matrix}$$

In equation 54, due to the change by Δt×fstep in reflected-wave arrival time (2R(f_{b_cfar})/Cₒ) from R(f_{b_cfar}), the phase rotation amount is 2πΔt×fstep×(2R(f_{b_cfar})/Cₒ) within code transmission periods (Loc×Tr), and thus, each phase rotation due to a time difference of Doppler analysis among Loc Doppler analyzers 209a is derived from being (noc−1)/Loc times for noc-th Doppler analyzer 209a when first Doppler analyzer 209a is used as a reference. Note that, noc=1, . . . , Loc.

Further, in radar receiver 200a, a reception signal of a signal equivalent to a radar transmission signal for which center frequency fc of a chirp signal is changed by Δt×fstep for each code transmission period (Loc×Tr) is obtained, and thus, the code transmission periods (Loc×Tr) match the periods for switching among Doppler analyzers 209a for each code element. Accordingly, aliasing determiner 252 can easily perform phase correction (using the center frequency change correction vector in equation 54 in addition to Doppler phase correction vector α(f_{s_cfar})) in demultiplexing processing on a code-multiplexed signal by using an unused code.

For the reason described above, aliasing determiner 252 may calculate received power DeMulUnCode_{nuc}(f_{b_cfar}, f_{s_cfar}, DR) after code demultiplexing using unused orthogonal code UnCode_{nuc} as in equation 55 instead of equation 25. Equation 55 differs from equation 25 in terms of using

[71]

ξ(f_{s_cfar})⊗α(f_{s_cfar})

instead of α(f_{s_cfar}) in equation 25. Here, nuc=1, . . . , N_{allcode}−N_{CM}. Further, DR is the index indicating a Doppler aliasing range, and takes an integer value in ranges of DR=ceil[−Loc/2], ceil[−Loc/2]+1, . . . , 0, . . . , ceil[Loc/2]−1.

$$\begin{matrix}( Equation 55 ) & \\ {DeMulUnCode}_{nuc} ( {f}_{b \_ cfar} , {f}_{s \_ cfar} , DR ) = {\sum }_{z = 1}^{Na} {\vert {( {UnCode}_{nuc} )}^{⋆} \cdot {\{ β ( DR ) ⊗ ξ ( {f}_{s \_ cfar} ) ⊗ α ( {f}_{s \_ cfar} ) ⊗ {VFTALL}_{z} ( {f}_{b \_ cfar} , {f}_{s \_ cfar} ) \}}^{T} \vert}^{2} . & [ 72 ]\end{matrix}$$

Further, aliasing determiner 252 may also use equation 56 instead of equation 42.

$$\begin{matrix}( Equation 56 ) & \\ De {MulUnCode}_{n u c} ( {f}_{b \_ cfar} , {f}_{s \_ cfar} , DR ) = {\sum }_{z = 1}^{N a} {\vert {( β ( D R ) ⊗ U n C o d {e}_{n u c} )}^{*} \cdot {\{ ξ ( {f}_{s \_ cfar} ) ⊗ α ( {f}_{s \_ cfar} ) ⊗ {VFTALL}_{z} ( {f}_{b \_ cfar} , {f}_{s \_ cfar} ) \}}^{T} \vert}^{2} & [ 73 ]\end{matrix}$$

Next, an operation example of code demultiplexer 253, which differs from that in Embodiment 2, will be described.

For the same reason as that in the description of the operation example of aliasing determiner 252 described above, code demultiplexer 253 also uses DRₘᵢₙ, which is a result of aliasing determination in aliasing determiner 252, to perform code demultiplexing processing on Doppler components VFTALL_{z}(f_{b_cfar}, f_{s_cfar}) that are the outputs of Doppler analyzers 209a corresponding to distance indexes f_{b_cfar} and Doppler frequency indexes f_{s_cfar} extracted by CFAR processor 210 in accordance with equation 57 instead of equation 43. Equation 57 differs from equation 43 in terms of using

[74]

ξ(f_{s_cfar})⊗α(f_{s_cfar})

instead of α(f_{s_cfar}) in equation 43.

[75]

DeMUL_{z}^{ncm}(f_{b_cfar},f_{s_cfar})=(Code_{ncm})*●{β(DRₘᵢₙ)⊗ξ(f_{s_cfar})⊗α(f_{s_cfar})⊗VFTALL_{z}(f_{b_cfar},f_{s_cfar})}^{T} (Equation 57)

Further, by using equation 58 instead of equation 44, code demultiplexer 253 may also use DRₘᵢₙ, which is a result of aliasing determination in aliasing determiner 252, to perform demultiplexing processing on a code-multiplexed signal on Doppler components VFTALL_{z}(f_{b_cfar}, f_{s_cfar}) that are the outputs of Doppler analyzers 209a corresponding to distance indexes f_{b_cfar} and Doppler frequency indexes f_{s_cfar} extracted by CFAR processor 210.

[76]

DeMUL_{z}^{ncm}(f_{b_cfar},f_{s_cfar})=(β(DRₘᵢₙ)⊗Code_{ncm})*●{ξ(f_{s_cfar})⊗α(f_{s_cfar})⊗VFTALL_{z}(f_{b_cfar},f_{s_cfar})}^{T} (Equation 58)

In equation 58, the term

[77]

β(DR)⊗Code_{ncm}

does not depend on index fₛ of a Doppler component, and thus, it is possible to reduce the arithmetic amount by pre-tabulation.

As described above, since a reception signal of a signal equivalent to a radar transmission signal for which center frequency fc of a chirp signal is changed by Δt×fstep for each code transmission period (Loc×Tr) is obtained, it is possible to cause code transmission periods (Loc×Tr) to match the periods for switching among Doppler analyzers 209a for each code element, and phase correction in code demultiplexing processing can be easily performed.

Next, an operation example of direction estimator 211, which is different from that in Embodiment 2, will be described.

For example, direction estimator 211 may calculate Doppler frequency index f_{es_cfar} in accordance with following equation 59 based on Doppler frequency index f_{s_cfar} and DRₘᵢₙ that is a determination result in aliasing determiner 252.

[78]

f_{es_cfar}=f_{s_cfar}+DRₘᵢₙ×Ncode (Equation 59)

Doppler frequency index f_{es_cfar} corresponds, for example, to the Doppler index in a case where the FFT size of Doppler analyzer 209a is extended to Loc×Ncode. Hereinafter, f_{es_cfar} is referred to as “extended Doppler frequency index”.

Note that, the Doppler range is assumed to be up to ±1/(2×Tr), and the range of extended Doppler frequency index f_{es_cfar} corresponding to the above Doppler range is −Loc×Ncode/2≤f_{es_cfar}<Loc×Ncode/2. Accordingly, as a result of calculation of equation 59, f_{es_cfar} Loc×Ncode is f_{es_cfar} in a case where f_{es_cfar}<−Loc×Ncode/2, and further f_{es_cfar}−Loc×Ncode is f_{es_cfar} in a case where f_{es_cfar}≥Loc×Ncode/2.

Further, in radar apparatus 10a, a reception signal of a signal equivalent to a radar transmission signal for which center frequency fc of a chirp signal is changed by Δt×fstep for each code transmission period (Loc×Tr) is obtained, and thus, center frequency fc of a chirp signal changes for each code transmission period (Loc×Tr) even in a case where the relative velocity of a target is zero. For this reason, the reception signal in radar apparatus 10a includes phase rotation associated with a change in the center frequency of a chirp signal for each code transmission period (Loc×Tr).

Center frequency fc in m-th average transmission period Tr with respect to target distance R_{target} changes by floor[(m−1)/Loc]Δt×fstep. Accordingly, phase rotation amount Δη(m, R_{target}) associated with a change in center frequencies fc is indicated by equation 60 in view of reflected-wave arrival time (2R_{target}/C₀) from target distance R_{target}.

$$\begin{matrix}( Equation 60 ) & \\ Δ η ( m , {R}_{target} ) = 2 π f l oor ( \frac{m - 1}{Loc} ) Δ t \times {f}_{step} \times ( \frac{2 {R}_{t a r g e t}}{{C}_{0}} ) & [ 79 ]\end{matrix}$$

Note that, equation 60 indicates the relative phase rotation amount in a case where the phase of the first transmission period is used as a reference. C₀ indicates the velocity of light.

Accordingly, direction estimator 211 may output detected Doppler velocity information v_{d} (f_{es_cfar}, f_{b_cfar}) of a target in accordance with equation 61 by using, for example, extended Doppler frequency index f_{es_cfar} and distance index f_{b_cfar}.

$$\begin{matrix}( Equation 61 ) & \\ {v}_{d} ( {f}_{b \_ cfar} , {f}_{es \_ cfar} ) = \frac{{C}_{o}}{2 {f}_{0}} ( \frac{{f}_{es \_ cfar}}{L o c \times N c o d e \times {T}_{r}} - floor ( \frac{m - 1}{Loc} ) Δ t \times {f}_{step} \times \frac{2 R ( {f}_{b \_ cfar} )}{L o c \times {T}_{r} \times {C}_{o}} ) & [ 80 ]\end{matrix}$$

The first term in equation 61 is a relative Doppler velocity component indicated by Doppler frequency f_{es_cfar}. Further, the second term in equation 61 is a Doppler velocity component that is generated by changing center frequency fc of a chirp signal by Δt×fstep for each code transmission period (Loc×Tr). Direction estimator 211 can calculate true relative Doppler velocity v_{d} (f_{es_cfar}, f_{b_cfar}) of a target by removing the Doppler component of the second item from the first item in equation 61. Here, given equation 4, R(f_{b_cfar}) is distance information R(f_{b_cfar}) using beat frequency index f_{b_cfar}.

As indicated in equation 61, direction estimator 211 calculates Doppler velocity information v_{d} based on a conversion equation in view of Δt×fstep that is the amount of a change in center frequency fc of a chirp signal for each code transmission period (Loc×Tr).

Note that, the Doppler range of a target is assumed to be up to ±1/(2×Tr), and thus, in a case where v_{d} is v_{d}<−C0/(4f₀Tr), direction estimator 211 may output detected Doppler velocity information v_{d} of a target in accordance with following equation 62.

$${v}_{d} ( {f}_{b \_ cfar} , {f}_{es \_ cfar} ) = \frac{{C}_{o}}{2 {f}_{0}} ( \frac{{f}_{es \_ cfar} + L o c \times N c o d e}{L o c \times N c o d e \times {T}_{r}} - floor ( \frac{m - 1}{L o c} ) Δ t \times {f}_{step} \times \frac{2 R ( {f}_{b \_ cfar} )}{L o c \times {T}_{r} \times {C}_{o}} ) \qquad [ 81 ]$$

Further, in the same manner, the Doppler range of a target is assumed to be up to ±1/(2×Tr), and thus, in a case where v_{d} is v_{d}>C₀/(4f₀Tr), direction estimator 211 may output detected Doppler velocity information v_{d} of a target in accordance with following equation 63.

$$\begin{matrix}( Equation 63 ) & \\ {v}_{d} ( {f}_{b \_ cfar} , {f}_{es \_ cfar} ) = \frac{{C}_{o}}{2 {f}_{0}} ( \frac{{f}_{es \_ cfar} + L o c \times N c o d e}{L o c \times N c o d e \times {T}_{r}} - floor ( \frac{m - 1}{L o c} ) Δ t \times {f}_{step} \times \frac{2 R ( {f}_{b \_ cfar} )}{L o c \times {T}_{r} \times {C}_{o}} ) & [ 82 ]\end{matrix}$$

As described above, in the present embodiment, radar transmitter 100a transmits the same chirp signal in Ncf (=Loc×Nroc) transmission periods, and performs the transmission by changing the transmission signal start timing by Δt for each time interval of (Tr×Loc). Further, in Ncf transmission periods following the Ncf transmission periods described above, radar transmitter 100a transmits a chirp signal for which the center frequency is changed by Δf=Δt×fstep×Nfc.

Thus, radar receiver 200a can obtain a reception signal in which center frequency fc of a chirp signal changes based on transmission periods (Loc×Tr) of one orthogonal code sequence. For example, in radar receiver 200a, a reception signal of a signal equivalent to a radar transmission signal for which center frequency fc of a chirp signal is changed by Δt×fstep for each code transmission period (Loc×Tr) is obtained. Accordingly, in the present embodiment, even in a case where the transmission signal start timing and center frequency of a chirp signal described above are controlled, radar apparatus 10a (for example, MIMO radar) can apply code multiplex transmission. Further, in the same manner as in Embodiment 2, radar apparatus 10a can perform Doppler aliasing determination by using the output (in other words, a reception signal) of Doppler analyzer 209a for each code element of a code-multiplexed signal, and an unused orthogonal code.

Further, according to the present embodiment, radar apparatus 10a is capable of, in the same manner as in Embodiment 2, configuring a Doppler range detectable without ambiguity to ±1/(Tr) and suppressing mutual interference between code-multiplexed signals to approximately a noise level by performing Doppler phase correction including aliasing during code demultiplexing. Thus, the present embodiment makes it possible to suppress deterioration of radar detection performance and perform code multiplex transmission by a MIMO radar.

Further, according to the present embodiment, in the case of a plurality of transmission periods for which center frequency fc of a chirp signal is changed by Δt×fstep, the plurality of transmission periods is caused to match code transmission periods (Loc×Tr) to thereby also match the periods for switching among Doppler analyzers 209a for each code element, and thus, demultiplexing processing on a code-multiplexed signal using an unused code in aliasing determiner 252 and phase correction in code demultiplexing processing in code demultiplexer 253 can be easily performed.

Further, in the present embodiment, a reception signal of a signal equivalent to a radar transmission signal for which center frequency fc of a chirp signal is changed by Δt×fstep for each code transmission period (Loc×Tr) is obtained in radar apparatus 10a, and thus, the change width for the center frequency of a chirp signal is Δt×fstep×Ncode and the distance resolution is 0.5C₀/(Δt×fstep×Ncode).

Thus, increasing Δt×fstep×Ncode makes it possible to enhance the distance resolution by the change width for the center frequency of a chirp signal, and thus, the chirp sweep bandwidth (for example, Bw) can be reduced in comparison with a case where the transmission is performed with a constant center frequency of chirp signals. The reduction in the chirp sweep bandwidth makes it possible to reduce, for example, a transmission period while enhancing the distance resolution, and thus, a Doppler range detectable without ambiguity can further be extended in code multiplex transmission.

Note that, in the present embodiment, a case where a reception signal of a signal equivalent to a radar transmission signal for which center frequency fc of a chirp signal is changed by Δt×fstep for each code transmission period (Loc×Tr) is obtained has been described, but a radar transmission signal for which center frequency fc of a chirp signal is changed by Δt×fstep for each (divisor of Loc×Tr) may also be used. Note that, in a case where 1 among divisors of Loc is used, center frequency fc is changed by Δt×fstep for each Tr in the same manner as in Embodiment 2.

Further, although the present embodiment can be implemented in combination with Embodiment 2, the code multiplexing method as described in Embodiment 2 may not be applied.

For example, of N_{allcode} orthogonal codes included in a code sequence with code length Loc, code generator 151 may configure code multiplexing number N_{CM} to be equal to number N_{allcode} of orthogonal codes. Further, phase rotator 152 may perform code multiplexing by using all of N_{allcode} orthogonal codes included in a code sequence with code length Loc. In this case, aliasing determination by aliasing determiner 252 of radar apparatus 10a is not applied, and thus, the Doppler frequency range becomes ±1/(2Loc×Tr). Here, in a case where frequency change width BW_{fcval} (=(the maximum chirp signal center frequency)−(the minimum chirp signal center frequency)) for the center frequency of chirp signals, which is varied each time the chirp signals are repeatedly transmitted, is greater than individual chirp frequency sweep bandwidth BW_{chirp} (for example, BW_{fcval}>BW_{chirp}), distance resolution ΔR2 is given by equation 3. Thus, as BW_{fcval} is greater, the distance resolution can be enhanced without depending on individual chirp frequency sweep bandwidth BW_{chirp} (for example, even in a case where BW_{chirp} is small), and it is possible to shorten average transmission period Tr for chirp signals. Accordingly, even in a case where the code multiplexing method described above is not applied, maximum Doppler velocity f_{dmax} is increased and the Doppler detection range can be extended given the relationship in equation 2.

Further, in the present embodiment, the configuration value of Ncf that is a parameter to be used by radar transmission signal generator 101 may be an integer multiple of number Loc of code elements (or code length Loc of a code sequence). Since the center frequency of a chirp signal is not varied within a code transmission period thereby, frequency errors or phase errors are less likely to occur when a chirp signal is varied, and it is possible to maintain the orthogonality between code-multiplexed signals. Note that, change Δf in a center frequency may be arbitrarily configured. Further, amount Δt of a transmission delay=0 may be configured.

Further, the present embodiment makes it possible to obtain the same reception signal as in a case where the center frequency of a chirp signal is changed by Δt×fstep for each of (Tr×Loc) and the transmission is performed. Accordingly, in comparison with Embodiment 2, frequency change width BW_{fcval} for the center frequency of a chirp signal is 1/Loc in a case where the same Δt×fstep is used. On the other hand, the same chirp signal for which no transmission timing is varied is transmitted within a code period, which is therefore more suitable for maintaining the orthogonality between code-multiplexed chirp signals. Further, for example, it is possible to suppress a reduction in frequency change width BW_{fcval} for the center frequency of a chirp signal with the configuration of Δt×fstep as an upper limit.

### Embodiment 4

In Embodiments 2 and 3, the MIMO radar configuration using code multiplex transmission has been described, but the present disclosure is not limited thereto. In the present embodiment, a MIMO radar configuration using time division multiplex transmission in which radar transmission signals are transmitted from a plurality of transmission antennas by time division will be described as an example.

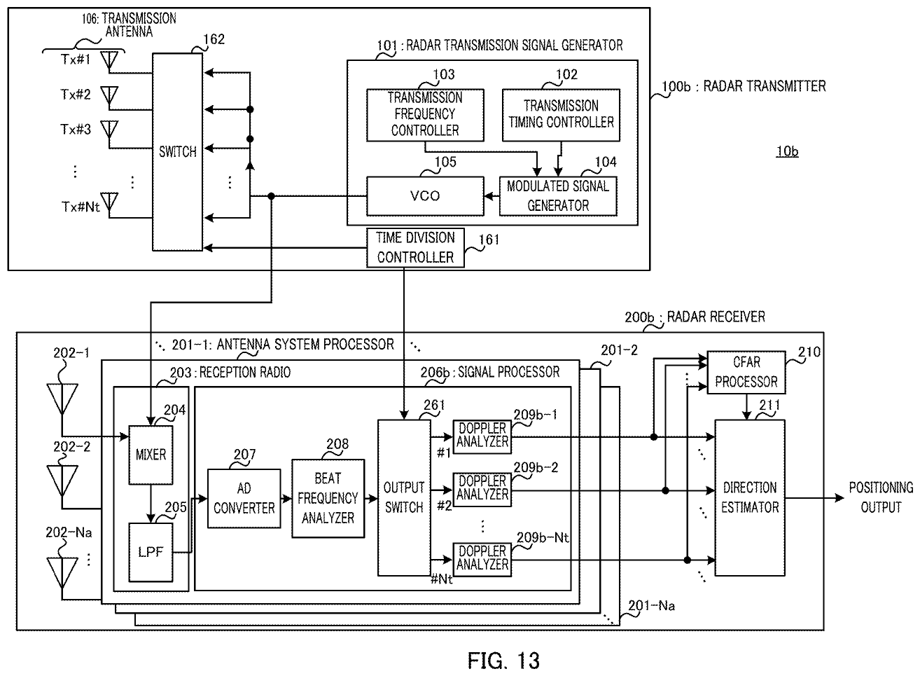

FIG. 13 is a block diagram illustrating a configuration example of radar apparatus 10b according to the present embodiment. In FIG. 13, components that perform the same operations as in Embodiments 1 and 2 will be denoted with the same reference signs, and descriptions thereof will be omitted.

[Configuration of Radar Transmitter]

Radar transmitter 100b illustrated in FIG. 13 includes, for example, time division controller 161 instead of code generator 151 illustrated in FIG. 7, and switch 162 instead of phase rotator 152 illustrated in FIG. 7.

For example, in radar transmitter 100b, the operations of other components different from time division controller 161 and switch 162 may be the same as those in Embodiment 1 or 2. For example, radar transmitter 100b may transmit the same chirp signal in Ncf transmission periods, and may perform the transmission by changing the transmission signal start timing by Δt for each time interval of average transmission period Tr. Further, in Ncf transmission periods following the Ncf transmission periods described above, radar transmitter 100b may transmit a chirp signal for which the center frequency is changed by Δf=Δt×fstep×Nfc. Thus, for example, radar receiver 200b can obtain the same reception signal as in a case where the center frequency of a chirp signal is changed by Δt×fstep for each transmission period and the transmission is performed.

Time division controller 161 outputs, for example, a control signal for switching among transmission antennas 106 (hereinafter referred to as “switching antenna number ANT_INDEX”) to switch 162 for each transmission period. Further, time division controller 161 outputs, for example, ANT_INDEX to output switch 261 of radar receiver 200b for each transmission period.

Switch 162 performs, for example, input switching to transmission antenna 106 indicated by ANT_INDEX inputted from time division controller 161 with respect to the output of radar transmission signal generator 101. Thus, the output (for example, a chirp signal) of radar transmission signal generator 101 is time-division transmitted from transmission antenna 106.

For example, time division controller 161 may output switching control signal ANT_INDEX for switching to first transmission antenna 106 in the first transmission period to switch 162. Switch 162 switches and outputs the output of radar transmission signal generator 101 to first transmission antenna 106 in the first transmission period based on the indication of ANT_INDEX, for example.

Further, for example, time division controller 161 may output switching control signal ANT_INDEX for switching to second transmission antenna 106 in the second transmission period to switch 162. Switch 162 switches and outputs the output of radar transmission signal generator 101 to second transmission antenna 106 in the second transmission period based on the indication of ANT_INDEX, for example.

Thereafter, in the same manner, time division controller 161 sequentially controls switching among transmission antennas 106, and outputs ANT_INDEX for switching to Nt-th transmission antenna 106 in the Nt-th transmission period to switch 162. Switch 162 switches and outputs the output of radar transmission signal generator 101 to Nt-th transmission antenna 106 in the Nt-th transmission period based on the indication of ANT_INDEX, for example.

Further, for example, time division controller 161 may output ANT_INDEX for switching to first transmission antenna 106 in the Nt+1-th transmission period to switch 162. Switch 162 switches and outputs the output of radar transmission signal generator 101 to first transmission antenna 106 in the Nt+1-th transmission period based on the indication of ANT_INDEX, for example.

Thereafter, time division controller 161 outputs ANT_INDEX for switching to mod(m−1, Nt)+1-th transmission antenna 106 in the m-th transmission period to switch 162. Switch 162 switches and outputs the output of radar transmission signal generator 101 to mod(m−1, N_{Tx})+1-th transmission antenna 106 in the m-th transmission period based on the indication of ANT_INDEX, for example. Here, m=1, . . . , Nc.

[Configuration of Radar Receiver 200b]

In FIG. 13, radar receiver 200b includes Na reception antennas 202 (for example, also represented by Rx #1 to Rx #Na) to form an array antenna. Further, radar receiver 200b includes Na antenna system processors 201-1 to 201-Na, CFAR processor 210, and direction estimator 211.

Each reception antenna 202 receives a reflected wave signal that is a radar transmission signal reflected by a reflection object including a target in radar measurement, and outputs, as a reception signal, the received reflected wave signal to corresponding antenna system processor 201.

Each antenna system processor 201 includes reception radio 203 and signal processor 206b.

The operation of reception radio 203 may be the same as that in Embodiment 1.

Signal processor 206b of each antenna system processor 201-z (where z=any one of 1 to Na) includes AD converter 207, beat frequency analyzer 208, output switch 261, and Doppler analyzer 209b.

The operations of AD converter 207 and beat frequency analyzer 208 may be the same as those in Embodiment 1.

Output switch 261 selectively switches and outputs the output of beat frequency analyzer 208 for each transmission period to ANT_INDEX-th Doppler analyzer 209b among Nt Doppler analyzers 209b based on ANT_INDEX outputted from time division controller 161, for example. In other words, output switch 261 selects ANT_INDEX-th Doppler analyzer 209b in m-th average transmission period Tr.

Signal processor 206b includes, for example, Nt Doppler analyzers 209b-1 to 209b-Nt. For example, data is inputted into ntx-th Doppler analyzer 209b by output switch 261 for each of Nt average transmission periods (Nt×Tr). For this reason, ntx-th Doppler analyzer 209b performs Doppler analysis for each distance index f_{b} by using data (for example, beat frequency response RFT_{z}(f_{b}, m) outputted from beat frequency analyzer 208) of Ntdm (=Nc/Ntx) transmission periods among Nc average transmission periods. Here, ntx is the index of transmission antenna 106, and ntx=1, . . . , Nt.

For example, output VFT_{z}^{ntx}(f_{b}, fₛ) of Doppler analyzer 209b in z-th signal processor 206b is indicated by following equation 64.

$$\begin{matrix}( Equation 64 ) & \\ V F {T}_{z}^{ntx} ( {f}_{b} , {f}_{s} ) = {\sum }_{s = 0}^{{N}_{t d m} - 1} R F {T}_{z} ( {f}_{b} , {N}_{t} \times s + n t x ) exp [ - \frac{j 2 π s {f}_{s}}{{N}_{t d m}} ] & [ 83 ]\end{matrix}$$

where j is an imaginary unit, and z=1 to Na.

CFAR processor 210 performs CFAR processing (in other words, adaptive threshold determination) by using the outputs of Nt Doppler analyzers 209b of each of first to Na-th signal processors 206b and extracts distance indexes f_{b_cfar} and Doppler frequency indexes f_{s_cfar} that give a peak signal.

Direction estimator 211 performs target direction estimation processing based on output VFT_{z}^{ntx}(f_{b}, fₛ) of Doppler analyzer 209b corresponding to distance indexes f_{b_cfar} and Doppler frequency indexes f_{s_cfar} inputted from CFAR processor 210.

For example, direction estimator 211 may use output VFT_{z}^{ntx}(f_{b_cfar}, f_{s_cfar}) of Doppler analyzer 209b corresponding to distance indexes f_{b_cfar} and Doppler frequency indexes f_{s_cfar} inputted from CFAR processor 210 to generate virtual reception array correlation vector h(f_{b_cfar}, f_{s_cfar}) as in following equation 65 and perform direction estimation processing in the same manner as in Embodiment 2.

Virtual reception array correlation vector h(f_{b_cfar}, f_{s_cfar}) includes Nt×Na elements which are the product of number Nt of transmission antennas and number Na of reception antennas. Virtual reception array correlation vector h(f_{b_cfar}, f_{s_cfar}) is used for processing of performing direction estimation based on the phase difference between reception antennas 202 on a reflected wave signal from a target. Here, z=1, . . . , Na.

$$\begin{matrix}( Equation 65 ) & \\ h ( {f}_{b \_ cfar} , {f}_{s \_ cfar} ) = [ \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}{α}_{1} ( {f}_{s \_ cfar} ) {VFT}_{1}^{1} ( {f}_{b \_ cfar} , {f}_{s \_ cfar} ) \\ {α}_{1} ( {f}_{s \_ cfar} ) {VFT}_{2}^{1} ( {f}_{b \_ cfar} , {f}_{s \_ cfar} )\end{matrix} \\ ⋮\end{matrix} \\ {α}_{1} ( {f}_{s \_ cfar} ) {VFT}_{Na}^{1} ( {f}_{b \_ cfar} , {f}_{s \_ cfar} )\end{matrix} \\ {α}_{2} ( {f}_{s \_ cfar} ) {VFT}_{1}^{2} ( {f}_{b \_ cfar} , {f}_{s \_ cfar} )\end{matrix} \\ {α}_{2} ( {f}_{s \_ cfar} ) {VFT}_{2}^{2} ( {f}_{b \_ cfar} , {f}_{s \_ cfar} )\end{matrix} \\ ⋮\end{matrix} \\ {α}_{2} ( {f}_{s \_ cfar} ) {VFT}_{Na}^{2} ( {f}_{b \_ cfar} , {f}_{s \_ cfar} )\end{matrix} \\ ⋮\end{matrix} \\ {α}_{{N}_{t}} ( {f}_{s \_ cfar} ) {VFT}_{1}^{{N}_{t}} ( {f}_{b \_ cfar} , {f}_{s \_ cfar} )\end{matrix} \\ {α}_{{N}_{t}} ( {f}_{s \_ cfar} ) {VFT}_{2}^{{N}_{t}} ( {f}_{b \_ cfar} , {f}_{s \_ cfar} )\end{matrix} \\ ⋮\end{matrix} \\ {α}_{{N}_{t}} ( {f}_{s \_ cfar} ) {VFT}_{Na}^{{N}_{t}} ( {f}_{b \_ cfar} , {f}_{s \_ cfar} )\end{matrix} ] & [ 84 ]\end{matrix}$$

Here, αₙₜₓ(f_{s_cfar}) is a Doppler phase correlation coefficient and is indicated as in following equation 66.

$$\begin{matrix}( Equation 66 ) & \\ {α}_{ntx} ( {f}_{s} ) = exp ( - \frac{j 2 π {f}_{s}}{{N}_{t d m}} \times \frac{ntx - 1}{{N}_{t}} ) & [ 85 ]\end{matrix}$$

Here, ntx=1, . . . , Nt. Doppler phase correlation coefficient αₙₜₓ(f_{s_cfar}) indicated by equations 65 and 66 is, for example, the coefficient of a complex value used for correcting phase rotation in a Doppler component of Doppler frequency index f_{s_cfar}, which occurs due to each time delay of Tr, 2Tr, . . . , (Nt−1)Tr in output VFT_{z}²(f_{b_cfar}, f_{s_cfar}) of second Doppler analyzer 209b to output VFT_{z}^{Nt}(f_{b_cfar}, f_{s_cfar}) of Nt-th Doppler analyzer 209b by using a Doppler analysis time of output VFT_{z}¹(f_{b_cfar}, f_{s_cfar}) of first Doppler analyzer 209b as a reference.

Further, for example, direction estimator 211 may output Doppler velocity information v_{d} of a target, which is detected in the below-described way, by using Doppler frequency index f_{s_cfar} and distance index f_{b_cfar}.

For example, in radar receiver 200b, a reception signal of a signal equivalent to a radar transmission signal for which center frequency fc of a chirp signal is changed by Δt×fstep for each average transmission period Tr can be obtained. Accordingly, for example, center frequency fc of a chirp signal changes for each average transmission period Tr even in a case where the relative velocity of a target is zero. Accordingly, a reception signal in radar apparatus 10b includes phase rotation associated with a change in the center frequency of a chirp signal for each average transmission period Tr.

For example, center frequency fc in m-th average transmission period Tr with respect to target distance R_{target} changes by (m−1)Δt×fstep when the first center frequency is used as a reference. Accordingly, phase rotation amount Δη(m, R_{target}) associated with the change in the center frequency is indicated by equation 67 in view of reflected-wave arrival time (2R_{target}/Co) from target distance R_{target}. Note that, following equation 67 indicates the relative phase rotation amount in a case where the phase in first average transmission period Tr is used as a reference. C₀ indicates the velocity of light.

$$\begin{matrix}( Equation 67 ) & \\ Δ η ( m , {R}_{target} ) = 2 π ( m - 1 ) Δ t \times {f}_{step} \times ( \frac{2 {R}_{t a r g e t}}{{C}_{0}} ) & [ 86 ]\end{matrix}$$

Accordingly, the output of each of Nt Doppler analyzers 209b of radar apparatus 10b includes phase rotation associated with a change in the center frequency of a chirp signal for each average transmission period Tr.

Accordingly, as indicated by equation 68, direction estimator 211 calculates Doppler velocity information v_{d} (f_{b_cfar}, f_{s_cfar}) based on a conversion equation in view of Δt×fstep that is the amount of a change in center frequency fc of a chirp signal for each average transmission period Tr.

The first term in equation 68 is a relative Doppler velocity component represented by Doppler frequency f_{s_cfar}. The second term in equation 68 is a Doppler velocity component that is generated by changing center frequency fc of a chirp signal by Δt×fstep for each average transmission period Tr. For example, as indicated by equation 68, direction estimator 211 can calculate true relative Doppler velocity v_{d}(f_{b_cfar}, f_{s_cfar}) of a target by removing the Doppler component in the second term from the first term. Here, R(f_{b_cfar}) is distance information R(f_{b_cfar}) using beat frequency index f_{b_cfar}, and is calculated by using equation 4.

$$\begin{matrix}( Equation 68 ) & \\ {v}_{d} ( {f}_{b \_ cfar} , {f}_{s \_ cfar} ) = \frac{{C}_{o}}{2 {f}_{0}} ( \frac{{f}_{s \_ cfar}}{L o c \times {N}_{t d m} \times {T}_{r}} - Δ t \times {f}_{step} \times \frac{2 R ( {f}_{b \_ cfar} )}{{T}_{r} \times {C}_{o}} ) & [ 87 ]\end{matrix}$$

Note that, the Doppler range of a target is assumed to be up to ±1/(2×Nt×Tr), and thus, in a case where v_{d} is v_{d}<−C0/(4f₀ Nt Tr), direction estimator 211 may output detected Doppler velocity information v_{d} of a target in accordance with following equation 69.

$$\begin{matrix}( Equation 69 ) & \\ {v}_{d} ( {f}_{b \_ cfar} , {f}_{s \_ cfar} ) = \frac{{C}_{o}}{2 {f}_{0}} ( \frac{{f}_{s \_ cfar} + {N}_{t} \times {N}_{tdm}}{{N}_{t} \times {N}_{t d m} \times {T}_{r}} - Δ t \times {f}_{step} \times \frac{2 R ( {f}_{b \_ cfar} )}{{T}_{r} \times {C}_{o}} ) & [ 88 ]\end{matrix}$$

Further, in the same manner, the Doppler range of a target is assumed to be up to ±1/(2×Nt×Tr), and thus, in a case where v_{d} is v_{d}>C₀/(4f₀ N_{Tx} Tr), direction estimator 211 may output detected Doppler velocity information v_{d} of a target in accordance with following equation 70.

$$\begin{matrix}( Equation 70 ) & \\ {v}_{d} ( {f}_{b \_ cfar} , {f}_{es \_ cfar} ) = \frac{{C}_{o}}{2 {f}_{0}} ( \frac{{f}_{s \_ cfar} + {N}_{t} \times {N}_{tdm}}{{N}_{t} \times {N}_{t d m} \times {T}_{r}} - Δ t \times {f}_{step} \times \frac{2 R ( {f}_{b \_ cfar} )}{{T}_{r} \times {C}_{o}} ) & [ 89 ]\end{matrix}$$

As described above, in the present embodiment, in the same manner as in Embodiment 1, radar transmitter 100b transmits the same chirp signal in Ncf transmission periods, and performs the transmission by changing the transmission signal start timing by Δt for each time interval of average transmission period Tr. Further, in Ncf transmission periods following the Ncf transmission periods described above, radar transmitter 100b transmits a chirp signal for which the center frequency is changed by Δf=Δt×fstep×Nfc.

Thus, for example, radar receiver 200b can obtain, with respect to reception data to be subjected to AD sampling within a range gate, the same reception signal as in a case where the center frequency of a chirp signal is changed by Δt×fstep for each transmission period and the transmission is performed.

Accordingly, for example, in the same manner as in Embodiment 1, the present embodiment makes it possible to reduce the number of times of control for variably configuring chirp signals for transmission of chirp signals with different center frequencies and to reduce the amount of memory for storing parameters when generating a chirp signal for each transmission period. Further, for example, the section and timing for AD sampling in radar receiver 200b may be constant regardless of transmission periods of chirp signals. Thus, processing in radar receiver 200b can be simplified.

Further, for example, by reducing the number of times of control for varying chirp signals, it is possible to reduce the generation of frequency errors or phase errors when varying chirp signals and to reduce the influence of deterioration on distance accuracy or Doppler accuracy.

Further, in the present embodiment, even in a case where the transmission signal start timing and center frequency of a chirp signal described above are controlled, radar apparatus 10b (for example, MIMO radar) can apply time division multiplex transmission.

Further, in the present embodiment, in a case where frequency change width BW_{fcval} (=(the maximum chirp signal center frequency)−(the minimum chirp signal center frequency)) for the center frequency of chirp signals, which is varied each time the chirp signals are repeatedly transmitted, is greater than individual chirp frequency sweep bandwidth BW_{chirp} (for example, BW_{fcval}>BW_{chirp}), distance resolution ΔR₂ is given by equation 3. Thus, for example, as BW_{fcval} is greater, the distance resolution can be enhanced without depending on individual chirp frequency sweep bandwidth BW_{chirp} (for example, even when BW_{chirp} is reduced), and thus, it is possible to shorten average transmission period Tr for chirp signals. Further, given the relationship in equation 2, for example, shortening average transmission period Tr for chirp signals attains an effect capable of increasing maximum Doppler velocity f_{dmax} to extend the Doppler detection range, and makes it possible to further extend a Doppler range detectable without ambiguity in code multiplex transmission.

Note that, in the present embodiment, the configuration value of Ncf that is a parameter to be used by radar transmission signal generator 101 may be an integer multiple of number Nt of transmission antennas 106 used for time division transmission. Since the center frequency of a chirp signal is not varied in the middle of sequential switching among number Nt of transmission antennas 106 thereby, the Ncf transmission periods match periods for switching among transmission antennas 106 in time division controller 161, and it is possible to easily control radar apparatus 10b.

An exemplary embodiment according to the present disclosure has been described above.

Note that, in the embodiments described above, a case where amount of change Δf in the frequency domain of a chirp signal is configured to |Δt×fstep×Nfc| or |Δt×fstep×Ncf/Loc| has been described as an example, but the present disclosure is not limited thereto and amount of change Δf may be any other value. Further, in the embodiments described above, a case where Δt related to a transmission delay in the time domain of a chirp signal is configured to an integer multiple of AD sampling interval Ts (Δt=Ndts×Ts) has been described as an example, but the present disclosure is not limited thereto and Δt may be any other value.

Further, the transmission antennas of the radar apparatus described above may have a sub-array configuration. For example, the radar apparatus may perform Doppler multiplex transmission in which sub-array beamforming (sub-array BF) and code multiplex transmission are used in combination. Transmission directional gain can be enhanced by using a combination of some transmission antennas as a sub-array to narrow the beam width of a transmission directional beam pattern. This narrows the detectable angular range, but increases the detectable distance range. Further, variable control of beam directions can be performed by causing a beam weight factor for generating directional beams to be variable.

Further, in a radar apparatus according to an exemplary embodiment of the present disclosure, a radar transmitter and a radar receiver may be individually disposed at physically remote places. Further, in a radar receiver according to an exemplary embodiment of the present disclosure, a direction estimator and other components may be individually disposed at physically remote places.

The radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the processors described above are implemented by the CPU executing the control program. However, the hardware configuration of the radar apparatus is not limited to that in this example. For example, the functional processors of the radar apparatus may be implemented as an integrated circuit (IC). Each functional processor may be formed as an individual chip, or some or all of them may be formed into a single chip.

Various embodiments have been described with reference to the accompanying drawings hereinabove. Obviously, the present disclosure is not limited thereto examples. Obviously, a person skilled in the art would arrive at variations and modification examples within a scope described in claims, and it is understood that these variations and modifications are within the technical scope of the present disclosure. Each constituent element of the above-mentioned embodiments may be combined optionally without departing from the spirit of the disclosure.

The expressions “processor”, “-er”, “-or”, and “-ar” used in the above-described embodiments may be replaced with other expressions such as “circuitry”, “device”, “unit”, or “module”.

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

### SUMMARY OF THE PRESENT DISCLOSURE

A radar apparatus according to an exemplary embodiment of the present disclosure includes: signal generation circuitry, which, in operation, generates a plurality of chirp signals; and a transmission antenna, which, in operation, transmits the plurality of chirp signals. The signal generation circuitry configures a transmission delay for the plurality of chirp signals for each of a predetermined number of transmission periods, where the predetermined number is greater than or equal to two, and the signal generation circuitry changes a center frequency of the plurality of chirp signals for each of the predetermined number of transmission periods.

In an exemplary embodiment of the present disclosure, the transmission delay is configured differently in each of the predetermined number of transmission periods.

In an exemplary embodiment of the present disclosure, the transmission delay changes in a round in the predetermined number of transmission periods.

In an exemplary embodiment of the present disclosure, a change in the center frequency is configured based on an amount of the transmission delay.

In an exemplary embodiment of the present disclosure, the radar apparatus further includes reception circuitry, which, in operation, performs AD conversion on a plurality of reflected wave signals that is the plurality of chirp signals reflected by an object. In each of the transmission periods, a section in which the AD conversion is performed and a timing at which the AD conversion is started are constant.

In an exemplary embodiment of the present disclosure, the predetermined number is configured based on a length of the section in which the AD conversion is performed.

In an exemplary embodiment of the present disclosure, the transmission antenna transmits the plurality of chirp signals having been subjected to code multiplexing.

In an exemplary embodiment of the present disclosure, the predetermined number is configured to an integer multiple of a code length of a code sequence to be used in the code multiplexing.

In an exemplary embodiment of the present disclosure, the transmission delay varies for each transmission period corresponding to a code length of a code sequence to be used in the code multiplexing.

In an exemplary embodiment of the present disclosure, the radar apparatus further includes reception circuitry, which, in operation, performs, in a range that is greater by a factor (of a code length of a code sequence to be used in the code multiplexing) than a Doppler analysis range with respect to a plurality of reflected wave signals that is the plurality of chirp signals reflected by an object, aliasing determination in a Doppler frequency domain of the plurality of reflected wave signals.

In an exemplary embodiment of the present disclosure, the transmission antenna transmits the plurality of chirp signals having been subjected to code multiplexing based on, among a plurality of code sequences, one or some of the plurality of code sequences; and the reception circuitry performs the aliasing determination based on, among the plurality of code sequences, another code sequence or other code sequences different from the one or some of the plurality of code sequences.

In an exemplary embodiment of the present disclosure, the transmission antenna performs time division transmission of the plurality of chirp signals.

In an exemplary embodiment of the present disclosure, the predetermined number is configured to an integer multiple of a number of a plurality of the transmission antennas to be used in the time division transmission.

The disclosure of Japanese Patent Application No. 2020-159858, filed on Sep. 24, 2020, including the specification, drawings and abstract, is incorporated herein by reference in its entirety.

### INDUSTRIAL APPLICABILITY

The present disclosure is suitable as a radar apparatus that detects a wide-angle range.

### REFERENCE SIGNS LIST

10, 10a, 10b Radar apparatus
100, 100a, 100b Radar transmitter
101 Radar transmission signal generator
102 Transmission timing controller
103 Transmission frequency controller
104 Modulated signal generator
105 VCO
106 Transmission antenna
151 Code generator
152 Phase rotator
161 Time division controller
162 Switch
200, 200a, 200b Radar receiver
201 Antenna system processor
202 Reception antenna
203 Reception radio
204 Mixer
205 LPF
206, 206a, 206b Signal processor
207 AD converter
208 Beat frequency analyzer
209, 209a, 209b Doppler analyzer
210 CFAR processor
211 Direction estimator
251, 261 Output switch
252 Aliasing determiner
253 Code demultiplexer

1. A radar apparatus, comprising:
signal generation circuitry, which, in operation, generates a plurality of chirp signals; and
a transmission antenna, which in operation, transmits the plurality of chirp signals, wherein:
the signal generation circuitry configures a transmission delay for the plurality of chirp signals for each of a predetermined number of transmission periods, the predetermined number being greater than or equal to two, and
the signal generation circuitry changes a center frequency of the plurality of chirp signals for each of the predetermined number of transmission periods.

2. The radar apparatus according to claim 1, wherein the transmission delay is configured differently in each of the predetermined number of transmission periods.

3. The radar apparatus according to claim 1, wherein the transmission delay changes in a round in the predetermined number of transmission periods.

4. The radar apparatus according to claim 1, wherein a change in the center frequency is configured based on an amount of the transmission delay.

5. The radar apparatus according to claim 1, further comprising reception circuitry, which, in operation, performs AD conversion on a plurality of reflected wave signals that is the plurality of chirp signals reflected by an object, wherein
in each of the transmission periods, a section in which the AD conversion is performed and a timing at which the AD conversion is started are constant.

6. The radar apparatus according to claim 5, wherein the predetermined number is configured based on a length of the section in which the AD conversion is performed.

7. The radar apparatus according to claim 1, wherein the transmission antenna transmits the plurality of chirp signals having been subjected to code multiplexing.

8. The radar apparatus according to claim 7, wherein the predetermined number is configured to an integer multiple of a code length of a code sequence to be used in the code multiplexing.

9. The radar apparatus according to claim 7, wherein the transmission delay varies for each transmission period corresponding to a code length of a code sequence to be used in the code multiplexing.

10. The radar apparatus according to claim 7, further comprising reception circuitry, which, in operation, performs, in a range that is greater by a factor (of a code length of a code sequence to be used in the code multiplexing) than a Doppler analysis range with respect to a plurality of reflected wave signals that is the plurality of chirp signals reflected by an object, aliasing determination in a Doppler frequency domain of the plurality of reflected wave signals.

11. The radar apparatus according to claim 10, wherein:
the transmission antenna transmits the plurality of chirp signals having been subjected to code multiplexing based on, among a plurality of code sequences, one or some of the plurality of code sequences; and
the reception circuitry performs the aliasing determination based on, among the plurality of code sequences, another code sequence or other code sequences different from the one or some of the plurality of code sequences.

12. The radar apparatus according to claim 1, wherein the transmission antenna performs time division transmission of the plurality of chirp signals.

13. The radar apparatus according to claim 12, wherein the predetermined number is configured to an integer multiple of a number of a plurality of the transmission antennas to be used in the time division transmission.
